(19) United States
(12) Patent Application Publication
(10) Pub. No.: US 2026/0332642 A1
(43) Pub. Date: Oct. 22, 2026

(54) UNAUTHORIZED COMMUNICATION DETECTION METHOD, NON-TRANSITORY COMPUTER-READABLE RECORDING MEDIUM STORING PROGRAM, AND UNAUTHORIZED COMMUNICATION DETECTION DEVICE

(71) Applicant: Panasonic Intellectual Property Management Co., Ltd., Osaka (JP)

(72) Inventors: MOE YOSHIDA, Osaka (JP); MANABU MAEDA, Osaka (JP)

(21) Appl. No.: 19/695,387

(22) Filed: Jun. 2, 2026

Related U.S. Application Data
(63) Continuation of application No. PCT/JP2024/044394, filed on Dec. 16, 2024.

(30) Foreign Application Priority Data
Dec. 19, 2023 (JP) 2023-214267
Apr. 19, 2024 (JP) 2024-068281

(51) Int. Cl. H04L 9/40

(52) U.S. Cl. CPC H04L 63/1483; H04L 63/1416; H04L 63/1425

(57) ABSTRACT

An unauthorized communication detection method is executed by one or more processors. In the unauthorized communication detection method, communication overlap determination processing for determining, if, in communication between the Internet and a server, two or more communications with a same device identifier, which uniquely identifies a device, from two or more different source Internet protocol addresses are detected in a predetermined period of time, presence or absence of one or more temporal overlaps between the two or more communications is performed. In the unauthorized communication detection method, if it is determined as a result of the communication overlap determination processing that there are one or more temporal overlaps, it is judged that at least one of the two or more communications is an unauthorized communication.

### BACKGROUND

### 1. Technical Field

The present disclosure relates to an unauthorized communication detection method, a non-transitory computer-readable recording medium storing a program, and an unauthorized communication detection device that detects an impersonation attack against a web server on the Internet.

### 2. Description of the Related Art

Japanese Unexamined Patent Application Publication No. 2007-150778 discloses, as a method capable of detecting, while minimizing false detections, unauthorized access involving spoofing of Layer 2 addresses such as media access control (MAC) addresses, a method for detecting unauthorized access by detecting combinations of an Internet protocol (IP) address and a MAC address of packets flowing through a network, counting the number of times that different MAC addresses have been combined with the same IP address, and comparing the counted number of times with a predetermined threshold.

### SUMMARY

One non-limiting and exemplary embodiment provides an unauthorized communication detection method and the like capable of detecting, while minimizing false detections, unauthorized access involving impersonation of device identifiers (IDs).

In one general aspect, the techniques disclosed here feature an unauthorized communication detection method performed by one or more processors, the unauthorized communication detection method including detecting, in communication between the Internet and a server, two or more communications with a same device identifier from two or more different source Internet protocol addresses in a predetermined period of time, the device identifier uniquely identifying a device, determining presence or absence of one or more temporal overlaps between the two or more communications, and judging, if determining that there are one or more temporal overlaps, that at least one of the two or more communications is an unauthorized communication.

According to the present disclosure, unauthorized access involving impersonation of device IDs can be detected while minimizing false detections.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram illustrating an example of access in anonymous communication and non-anonymous communication;

FIG. 1B is a diagram illustrating another example of the access in anonymous communication and non-anonymous communication;

FIG. 2 is a diagram illustrating overall configuration of an unauthorized communication detection system according to a first embodiment;

FIG. 3 is a diagram illustrating configuration of an unauthorized communication detection device according to the first embodiment;

FIG. 4 is a diagram illustrating an example of a communication log according to the first embodiment;

FIG. 5 is a diagram illustrating an example of a block list according to the first embodiment;

FIG. 6 is a diagram illustrating an example of an impersonation gray list according to the first embodiment;

FIG. 7 is a diagram illustrating an example of an access history according to the first embodiment;

FIG. 8 is a diagram illustrating another example of the access history according to the first embodiment;

FIG. 9 is a diagram illustrating an example of operation of the unauthorized communication detection system according to the first embodiment;

FIG. 10 is a diagram illustrating an example of communication log collection processing according to the first embodiment;

FIG. 11 is a diagram illustrating an example of an impersonation gray list creation processing according to the first embodiment;

FIG. 12 is a diagram illustrating an example of unauthorized communication determination processing according to the first embodiment;

FIG. 13 is a diagram illustrating an example of communication overlap determination processing according to the first embodiment;

FIG. 14 is a diagram illustrating an example (first operation) of impersonation determination processing according to the first embodiment;

FIG. 15 is a diagram illustrating an example of access history extraction processing according to the first embodiment;

FIG. 16 is a diagram illustrating communication in gray list No. 1 according to the first embodiment;

FIG. 17 is a diagram illustrating communication in gray list No. 2 according to the first embodiment;

FIG. 18 is a diagram illustrating communication in gray list No. 3 according to the first embodiment;

FIG. 19 is a diagram illustrating communication in gray list No. 4 according to the first embodiment;

FIG. 20 is a diagram illustrating communication in gray list No. 5 according to the first embodiment;

FIG. 21 is a diagram illustrating communication in gray list No. 6 according to the first embodiment;

FIG. 22 is a diagram illustrating an impersonation gray list in a second operation according to the first embodiment;

FIG. 23 is a diagram illustrating another example (second operation) of the impersonation determination processing according to the first embodiment;

FIG. 24 is a diagram illustrating an impersonation gray list in a third operation according to the first embodiment;

FIG. 25 is a diagram illustrating another example (third operation) of the impersonation determination processing according to the first embodiment;

FIG. 26 is a diagram illustrating an example of communication log collection processing in a fourth operation according to the first embodiment;

FIG. 27 is a diagram illustrating an impersonation gray list in the fourth operation according to the first embodiment;

FIG. 28 is a diagram illustrating another example (fourth operation) of the impersonation determination processing according to the first embodiment;

FIG. 29 is a diagram illustrating overall configuration of an unauthorized communication detection system according to a second embodiment;

FIG. 30 is a diagram illustrating configuration of an unauthorized communication detection device according to the second embodiment;

FIG. 31 is a diagram illustrating an example of a communication log according to the second embodiment;

FIG. 32 is a diagram illustrating a first example of an impersonation gray list according to the second embodiment;

FIG. 33 is a diagram illustrating a first example of a house identification list according to the second embodiment;

FIG. 34 is a diagram illustrating an example of operation of the unauthorized communication detection system according to the second embodiment;

FIG. 35 is a diagram illustrating an example of operation of house identification list creation processing according to the second embodiment;

FIG. 36 is a diagram illustrating an example of unauthorized communication determination processing according to the second embodiment;

FIG. 37 is a diagram illustrating an example of impersonation determination processing according to the second embodiment;

FIG. 38 is a diagram illustrating a second example of the impersonation gray list according to the second embodiment;

FIG. 39 is a diagram illustrating a second example of the house identification list according to the second embodiment;

FIG. 40 is a diagram illustrating a third example of the impersonation gray list according to the second embodiment;

FIG. 41 is a diagram illustrating a third example of the house identification list according to the second embodiment;

FIG. 42 is a diagram illustrating a fourth example of the impersonation gray list according to the second embodiment;

FIG. 43 is a diagram illustrating a fourth example of the house identification list according to the second embodiment;

FIG. 44 is a diagram illustrating a fifth example of the impersonation gray list according to the second embodiment;

FIG. 45 is a diagram illustrating a fifth example of the house identification list according to the second embodiment;

FIG. 46 is a diagram illustrating an example of a device type list according to the first embodiment;

FIG. 47 is a diagram illustrating an example of a device type list in the third operation according to the first embodiment;

FIG. 48 is a diagram illustrating an example of a device type list in the fourth operation according to the first embodiment;

FIG. 49 is a diagram illustrating configuration of an unauthorized communication detection device according to a second modification;

FIG. 50 is a diagram illustrating an example of communication log collection processing according to the second modification;

FIG. 51 is a diagram illustrating an example of unauthorized communication determination processing according to the second modification;

FIG. 52 is a diagram illustrating an example of impersonation determination processing according to a third modification;

FIG. 53 is a diagram illustrating overall configuration of an unauthorized communication detection system according to a fifth modification;

FIG. 54 is a diagram illustrating overall configuration of an unauthorized communication detection system according to a sixth modification;

FIG. 55 is a diagram illustrating overall configuration of an unauthorized communication detection system according to a seventh modification;

FIG. 56 is a diagram illustrating configuration of an unauthorized communication detection device according to a ninth modification;

FIG. 57 is a diagram illustrating an example of impersonation determination processing according to the ninth modification;

FIG. 58 is a diagram illustrating an example of notification at a time when impersonation is detected with a temporal overlap between two or more communications;

FIG. 59 is a diagram illustrating an example of notification at a time when impersonation is detected with no temporal overlap between two or more communications; and

FIG. 60 is a diagram illustrating an example of notification about a block list.

### DETAILED DESCRIPTIONS

### Underlying Knowledge Forming Basis of Present Disclosure

A point of focus of the inventor of the present application will be described hereinafter.

In recent years, with the advancement of Internet of things (IoT) adoption in home appliances, not only personal computers (PC) and television (TV) devices but also home appliances such as air conditioners, refrigerators, and washing machines have come to be connected to the Internet via routers or the like. As a result, it has become possible to remotely control such home appliances via a home appliance server and to enable cooperation among home appliances, thereby making everyday life more convenient.

On the other hand, there is an increasing risk of cyberattacks in which an attacker impersonates a legitimate home appliance by impersonating a device ID used by a home appliance server to uniquely identify a home appliance, thereby performing unauthorized access to the home appliance server, carrying out unauthorized operations, or stealing information. Accordingly, it is necessary for the home appliance server to take measures to defend against such cyberattacks, such as blocking unauthorized access involving impersonation of a device ID.

As a method for this purpose, generally, a combination of a device ID and a source IP address is registered in a database, and when access is made using a combination of a device ID and an IP address that differs from the registered combination, the access is detected as impersonation.

However, when an Internet service provider (ISP), which has a role of assigning IP addresses on the Internet, employs a dynamic IP address assignment scheme, an IP address assigned by the ISP periodically changes or changes at timings of a restart of a home router and the like.

That is, even when access is made from different IP addresses using the same device ID, if the IP addresses are assigned by the same ISP, there is a high likelihood that the access originates from the same user. Therefore, false detections in which such access is recognized as impersonation, despite not being unauthorized access, tend to occur frequently.

As described above, Japanese Unexamined Patent Application Publication No. 2007-150778 discloses, as a method capable of detecting, while minimizing false detections, unauthorized access involving spoofing of Layer 2 addresses such as MAC addresses, a method for detecting unauthorized access by detecting combinations of an IP address and a MAC address of packets flowing through a network, counting the number of times that different MAC addresses have been combined with the same IP address, and comparing the counted number of times with a predetermined threshold.

When the method disclosed in Japanese Unexamined Patent Application Publication No. 2007-150778 is applied to a home appliance server on the Internet, whether impersonation is involved is judged by comparing the number of times that different IP addresses have been combined with the same device ID with a predetermined threshold.

In this case, false detections can be suppressed by not counting different IP addresses if the IP addresses are within an address range of the same ISP, and setting a frequency at which the ISP reassigns an IP address as a threshold.

However, users who use home appliances exist in countries all over the world, and it is extremely difficult to set, for each device ID, a threshold based on operational practices of ISPs in different countries and regions.

In addition, in recent years, TV devices have been equipped with video distribution service functions, and the number of users who use anonymous communication services for the purpose of circumventing country- or region-based viewing restrictions in order to view videos distributed in other countries has been increasing.

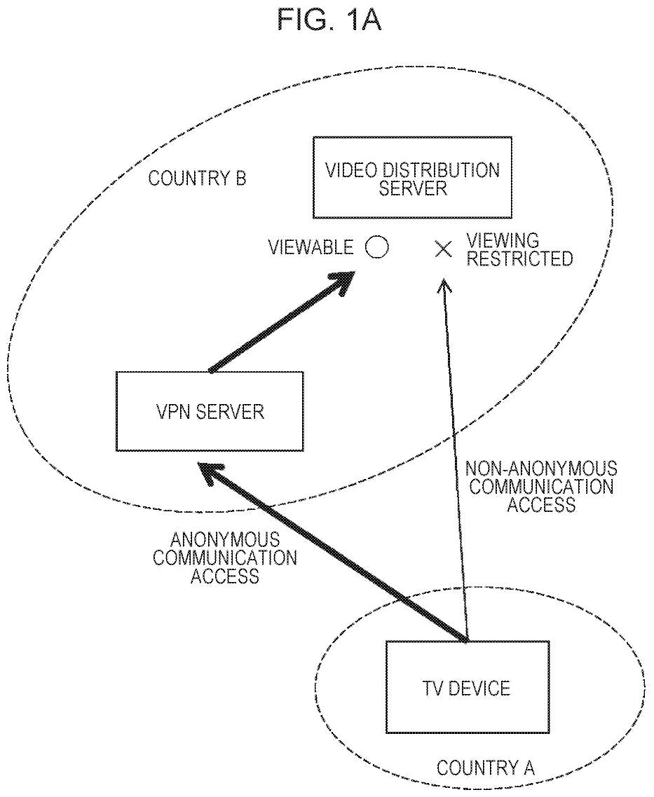

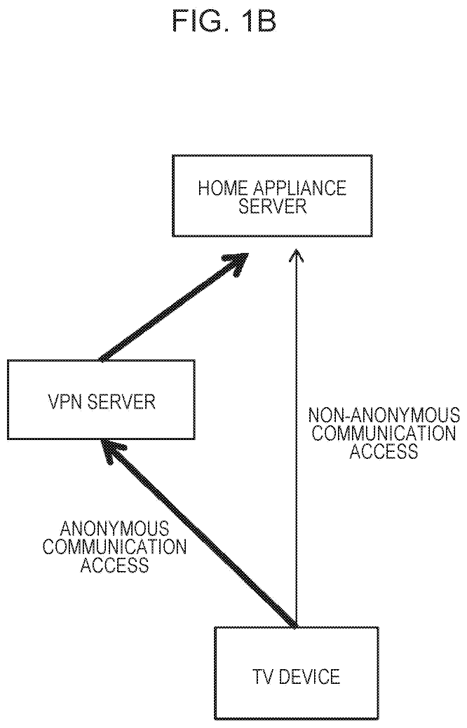

When a video distribution server is accessed from a TV device, the video distribution server identifies a country of origin based on a source IP address. For example, by using a service such as “Whois”, which allows any Internet user to refer to information regarding registrants of IP addresses and domain names, it is possible to easily identify a country name from an IP address. As illustrated in FIG. 1A, when a TV device directly accesses a video distribution server from Country A (i.e., in the case of non-anonymous communication), the video distribution server imposes viewing restrictions because the access is not from Country B, which is a distribution target country.

In this case, when the TV device is connected to a virtual private network (VPN) server installed in Country B, which is the distribution target country, and accesses the video distribution server via the VPN server (i.e., in the case of anonymous communication), the video distribution server can be caused to recognize the access as originating from Country B. As a result, the user can view a video while actually being located outside the distribution target country.

In such an environment, as illustrated in FIG. 1B, the TV device normally accesses the home appliance server using an IP address assigned by an ISP contracted for use at home, and when a VPN connection is established for the purpose of video viewing, the TV device accesses the home appliance server using an IP address of the VPN server.

From the perspective of the home appliance server, access appears to be made from different IP addresses using the same device ID, and thus one of the communications might be erroneously detected as unauthorized access impersonating the device ID of the TV device.

VPN servers are installed in countries all over the world, and users can freely select countries for anonymous communication and connect to or disconnect from VPN servers at arbitrary timings. Accordingly, a frequency at which an IP address changes for the same device ID is irregular.

That is, it is extremely difficult to set an appropriate threshold for each device ID, and the method of Japanese Unexamined Patent Application Publication No. 2007-150778 is unable to suppress false detections of impersonation in such cases. Normally, communications determined to involve impersonation pose a high security risk, and measures such as blocking the communications for a certain period are often taken. Therefore, false detections of impersonation result in blocking normal communications of legitimate home appliances, thereby causing significant inconvenience to users.

In addition, from the viewpoint of security monitoring operations, if false detection alerts occur frequently, there is a risk that alerts with truly high risk might be overlooked. Therefore, it is desirable to suppress false detections as much as possible.

An object of the present disclosure is not to determine impersonation merely by detecting a change in an IP address, but to increase detection accuracy while minimizing false detections of impersonation even in cases where an IP address is periodically changed by an ISP or irregularly changed due to VPN settings made by a user, by collectively taking into consideration information regarding an overlap between communications and whether the IP address corresponds to anonymous communication such as VPN communication.

Configuration of an unauthorized communication detection systems according to each of embodiments of the present disclosure, configuration of an unauthorized communication detection device, which is a component of the system, and a flow of unauthorized communication detection processing will be described hereinafter with reference to the drawings. Note that the embodiments described below are preferred specific examples of the present disclosure. That is, numerical values, shapes, materials, components, arrangement and connection modes of the components, steps, and order of the steps mentioned in the embodiments described below are merely examples and are not intended to limit the present disclosure. The present disclosure is identified on the basis of the description of the claims. Accordingly, among the components in the embodiments described below, components not described in the independent claims, which represent highest-level concepts of the present disclosure, are not necessarily required to achieve the object of the present disclosure, but are described as components that form more preferable embodiments.

### First Embodiment

In an embodiment of the present disclosure, a configuration where an unauthorized communication detection device that relays communication between the Internet and a home appliance server judges whether each of a plurality of different IP communications for accessing the home appliance server using a device ID of a TV device is unauthorized access involving impersonation.

### 1. Details of First Embodiment

An unauthorized communication detection system 1 in the present disclosure will be described with reference to the drawings as a first embodiment of the present disclosure. In the present embodiment, a case where the TV device is connected to the Internet and the TV device is directly connected to the home appliance server and a case where the TV device is connected to the home appliance server via a VPN server will be described.

### 1.1 Overall Configuration of Unauthorized Communication Detection System 1

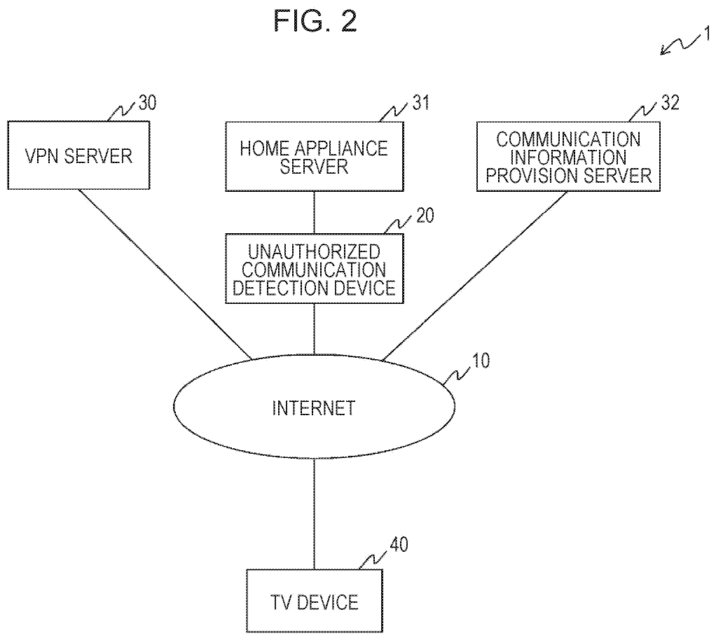

FIG. 2 is a diagram illustrating network configuration of the unauthorized communication detection system 1 in the present disclosure. The unauthorized communication detection system 1 includes the Internet 10, an unauthorized communication detection device 20, a VPN server 30, a home appliance server 31, a communication information provision server 32, and a TV device 40.

The Internet 10 is a commonly used Internet, and the VPN server 30 is a common VPN server connected to the Internet 10. The home appliance server 31 is a server that can be accessed via the Internet 10, and manages home appliances that access the home appliance server 31 via the Internet 10 and coordinates home appliances with each other.

The communication information provision server 32 returns, in response to a query for an IP address, various types of information associated with the IP address.

The various types of information includes, for example, a name of a network group (autonomous system number (ASN)), a name of a provider (ISP) that manages the IP address, and positional information (e.g., a country name, a city name, and latitude and longitude) identified from the IP address. The communication information provision server 32 may also return information indicating whether communication from the IP address is anonymous communication via a VPN server, a proxy server, the onion router (Tor), or the like. These pieces of information will be collectively referred to as “communication information” hereinafter.

The TV device 40 has a network function and is connected to the VPN server 30 and the home appliance server 31 via the Internet 10. The TV device 40 holds a device ID “TV1” in a storage thereof and communicates with the home appliance server 31 while including the device ID thereof in communication data.

The unauthorized communication detection device 20 is connected to a communication link (e.g., Ethernet (registered trademark)) connecting the Internet 10 and the home appliance server 31. In other words, the unauthorized communication detection device 20 has a role of mediating communication between home appliances on the Internet 10 and the home appliance server 31.

Specifically, the unauthorized communication detection device 20 receives, from the Internet 10, all communication packets addressed to the home appliance server 31 and transfers the communication packets to the home appliance server 31, and receives communication packets from the home appliance server 31 and transfers the communication packets to the Internet 10. In the course of mediating communication, the unauthorized communication detection device 20 monitors whether there is an unauthorized communication from the Internet 10, and blocks the unauthorized communication as necessary.

Although the TV device 40 is included in the unauthorized communication detection system 1 as a home appliance that accesses the home appliance server 31 in the present embodiment, the home appliance that accesses the home appliance server 31 need not be a TV device, and may be another home appliance, instead. Alternatively, a plurality of home appliances may access the home appliance server 31.

Although the unauthorized communication detection device 20 is connected between the Internet 10 and the home appliance server 31, how the unauthorized communication detection device 20 is connected is not limited to this. The unauthorized communication detection device 20 may be incorporated into the home appliance server 31, or may be connected to the same network as the home appliance server 31 and monitor unauthorized communication by obtaining a communication log from the home appliance server 31, instead.

### 1.2 Configuration of Unauthorized Communication Detection Device 20

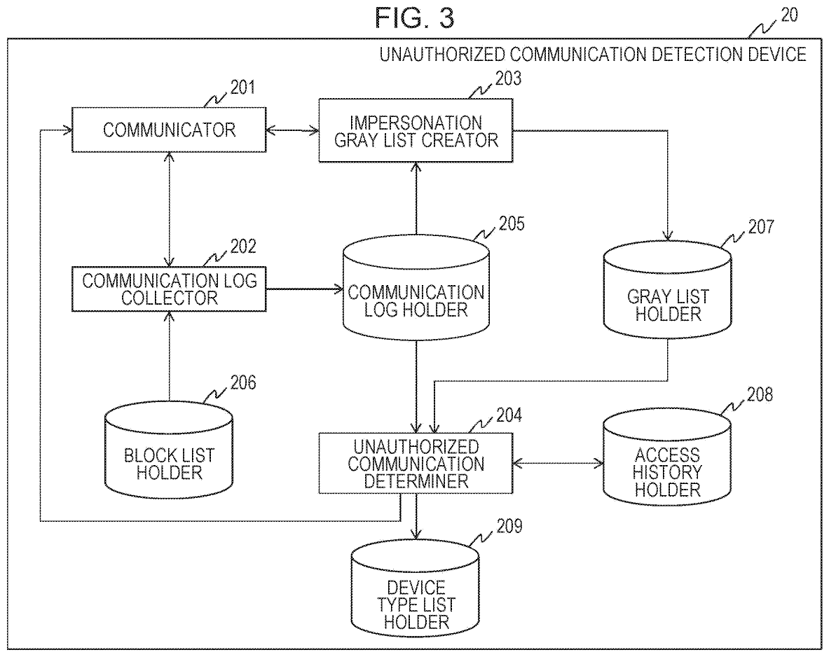

FIG. 3 is a block diagram illustrating configuration of the unauthorized communication detection device 20. The unauthorized communication detection device 20 includes a communicator 201, a communication log collector 202, an impersonation gray list creator 203, an unauthorized communication determiner 204, a communication log holder 205, a block list holder 206, a gray list holder 207, and an access history holder 208.

The unauthorized communication detection device 20 can be achieved by executing a program using a computer including a processor (central processing unit (CPU)) and a memory.

The communicator 201 is an aggregation of common communication interface devices and communicates with home appliances belonging to the Internet 10 and the home appliance server 31. If an address scheme of the Internet 10 is different from that of the network of the home appliance server 31, different communication interface devices are assigned to these address schemes. A communication standard of the communication performed by the communicator 201 is wired communication represented by Institute of Electrical and Electronics Engineers (IEEE) 802.3 (Ethernet), for example, but is not limited to this. Another wired communication such as power line communication (PLC) or wireless local area network (LAN) communication such as an IEEE 802.11 series (IEEE 802.11a, b, g, n, ac, ax, etc.) may be employed, instead.

The communication log collector 202 receives, from the Internet 10 via the communicator 201, all communication packets addressed to the home appliance server 31 and transfers the communication packets to the home appliance server 31 and receives communication packets from the home appliance server 31 and transfers the communication packets to the Internet 10. Before the transfer, however, the communication log collector 202 checks a block list saved in the block list holder 206 and, if a combination of a source IP address and a destination address of a communication packet is registered in the block list, does not transfer the communication packet. The communication log collector 202 also generates a communication log from all the received packets and saves the communication log to the communication log holder 205.

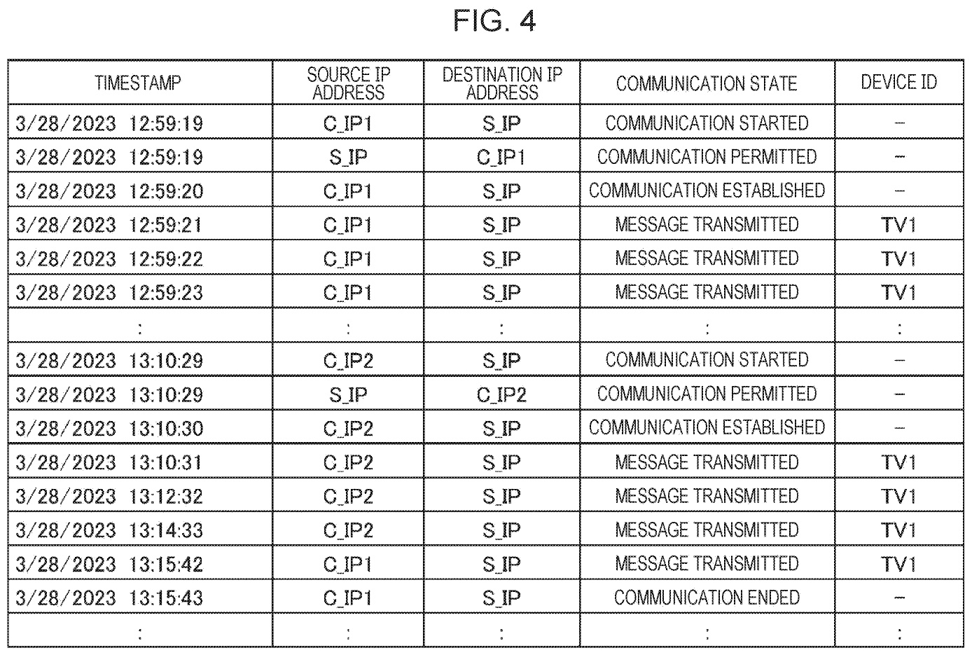

The communication log holder 205 holds all communication packets relayed by the communicator 201 as a communication log. FIG. 4 is a diagram illustrating an example of the communication log. The communication log in FIG. 4 stores timestamps of the reception of the communication packets, source IP addresses of the communication packets, destination IP addresses of the communication packets, communication states, and device IDs of source home appliances.

The communication state is information indicating an establishment condition of communication. The communication state may be, for example, a packet type “SYN”, “SYN/ACK”, “ACK”, or the like of transmission control protocol (TCP), or a “SYN” packet, a “SYN/ACK” packet, an “ACK” packet, a “PSH” packet, and a “FIN” packet may be expressed as “communication started”, “communication permitted”, “communication established”, “message transmitted”, and “communication ended”, respectively, and stored.

Alternatively, the communication state may store, for example, a communication state in a layer other than a TCP layer, such as a communication state between a server and a client used in communication data of an application layer.

The communication log in FIG. 4 is an example, and may include information regarding a TCP/IP header, such as an MAC address and a port number, data of the application layer, and other information. The communication state may be a flag, instead of a character string.

The device ID is an ID for uniquely identifying a source home appliance, and is stored as data of the application layer of a packet from a home appliance to the home appliance server 31. Although the device ID is a character string in FIG. 4, the device ID may be stored as binary data, instead.

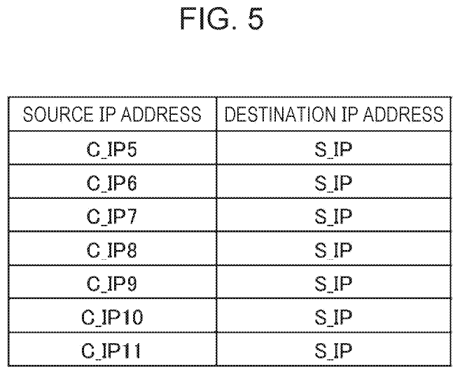

The block list holder 206 holds a block list for blocking unauthorized access from the Internet 10. FIG. 5 is a diagram illustrating an example of the block list. The block list in FIG. 5 stores combinations of a source IP address and a destination IP address to be blocked.

The block list of FIG. 5 is an example, and a block list used may include only source IP addresses, only IP addresses of home appliances, only device IDs, or information of another format.

The impersonation gray list creator 203 reads a communication log for a certain period of time from the communication log holder 205 and checks whether the read communication log includes a plurality of communications to a single device ID from different source IP addresses.

Depending on how the unauthorized communication detection device 20 is implemented, the certain period of time may be a period that is considered to be short for an IP address of a home appliance to change naturally, such as one hour or one day, or may be set simply on the basis of a capacity limitation of the memory for storing a read log.

If the read log includes a plurality of communications to a single device ID from different source IP addresses, the impersonation gray list creator 203 judges that there is a possibility that the device ID is impersonated, and queries the communication information provision server 32 via the communicator 201 for each source IP address to obtain communication information. The impersonation gray list creator 203 then compiles the device ID and the communication information regarding the communications from the plurality of source IP addresses into a list and saves the list to the gray list holder 207 as an impersonation gray list.

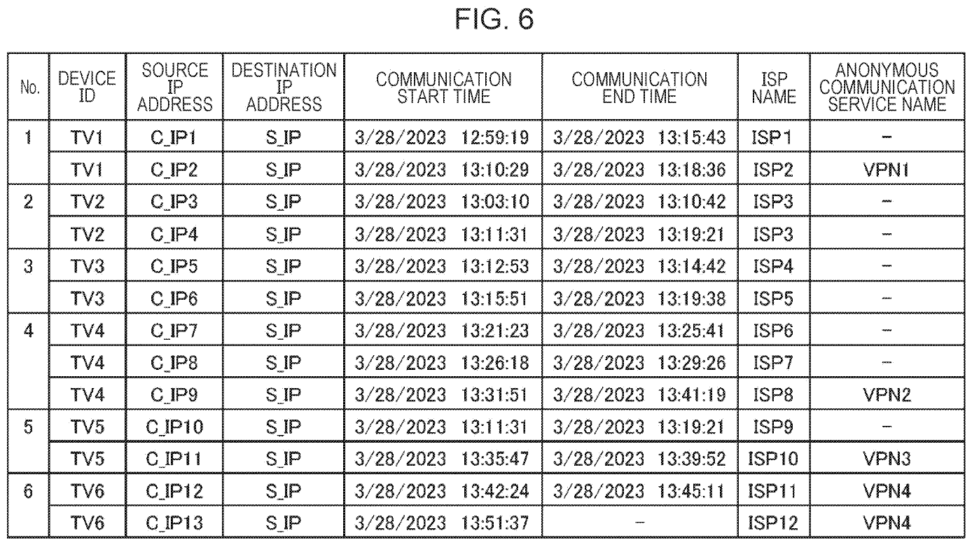

The gray list holder 207 holds an impersonation gray list obtained by compiling devices ID and communication information regarding communications from a plurality of source IP addresses into a list. FIG. 6 is a diagram illustrating an example of the impersonation gray list.

The impersonation gray list of FIG. 6 stores device IDs, a plurality of different source IP addresses from which access has been made using the device IDs in a certain period of time, communication start times and communication end times from the IP addresses, names of ISPs that manage the IP addresses, and anonymous communication service names if communication from the IP addresses is anonymous or a character string “-” if the communication is not anonymous. If a communication does not start or end in the certain period of time, the character string “-” is stored as the communication start time or the communication end time instead of a time.

The impersonation gray list of FIG. 6 is an example, and may be described in another format, instead. For example, although the character string “-” is stored if a communication is not an anonymous communication, another character string such as “none” or “null” may be stored.

The unauthorized communication determiner 204 reads the impersonation gray list from the gray list holder 207 and checks whether there is an overlap between a plurality of communications to a single device ID from different source IP addresses. Specifically, the unauthorized communication determiner 204 defines a period from a communication start time to a communication end time as an access period and, if there is an overlap between access periods, determines unauthorized access.

Even when there is no overlap between access periods, a possibility of unauthorized access involving impersonation is extremely high if there is access from different IP addresses using the same device ID in a short period of time. The unauthorized communication determiner 204, therefore, judges whether the access is unauthorized access involving impersonation also on the basis of information such as ISP names and names of anonymous communication services and an access history.

The access history is created by extracting, from the communication log held by the communication log holder 205, only entries with a particular device ID and the communication state of “message transmitted” and adding communication information regarding source IP addresses to the entries.

The communication state used as a condition for extracting the access history may be a state other than “message transmitted”, insofar as at least one of a plurality of entries generated as a result of one access event can be extracted. The created access history is saved to the access history holder 208. A device type list holder 209 is referred to as necessary, and device IDs and device types are associated with each other.

Although device types are obtained from device ID formats in the present embodiment, how to obtain device types is not limited to this. For example, in a case where a home appliance transmits a device type to a home appliance server during communication of data between the home appliance server and the home appliance at or after a start of communication, the information may be obtained from a communication packet. In a case where a home appliance server is provided for each device type, a device type of a home appliance may be determined on the basis of an IP address of a home appliance server with which the home appliance communicates.

By taking into consideration presence or absence of an overlap between communications, communication information, and an access history, accuracy of detecting unauthorized access involving impersonation of a device ID can be increased even when an ISP regularly changes an IP address or a user makes VPN settings in such a way as to change an IP address at irregular intervals.

If it is judged that the access is unauthorized access involving impersonation, a source IP address of the access is recorded in the block list held by the block list holder 206.

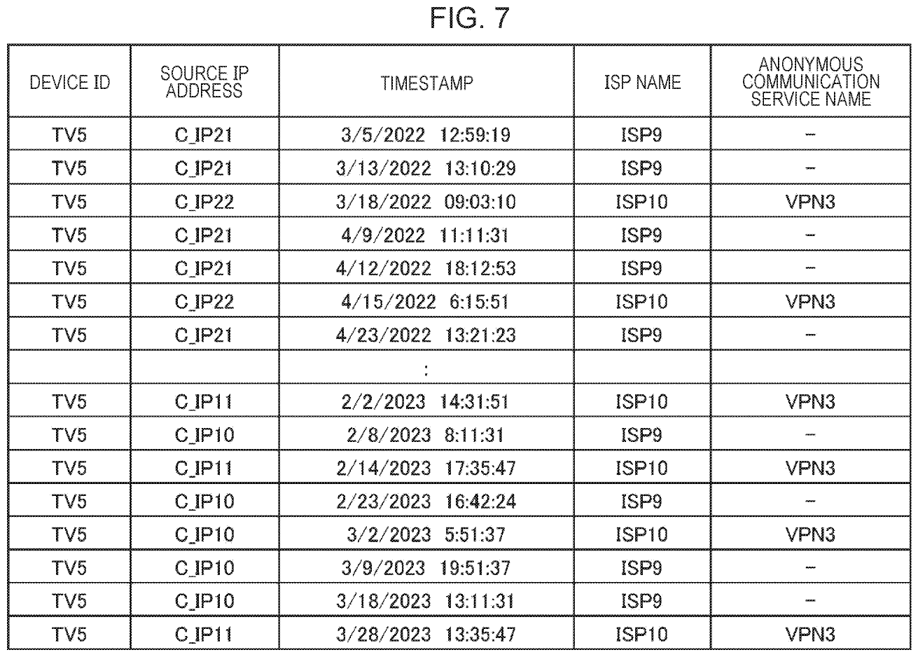

The access history holder 208 holds an access history obtained by adding communication information to message transmission entries with a particular device ID included in a communication log. FIG. 7 is a diagram illustrating an example of the access history.

The access history of FIG. 7 stores device IDs, source IP addresses, communication establishment times, names of ISPs that manage the IP addresses, and anonymous communication service names if communication from the IP addresses is anonymous or the character string “-” if the communication is not anonymous. The access history of FIG. 7 is an example, and may be described in another format, instead. For example, although the character string “-” is stored if a communication is not an anonymous communication, another character string such as “none” or “null” may be stored.

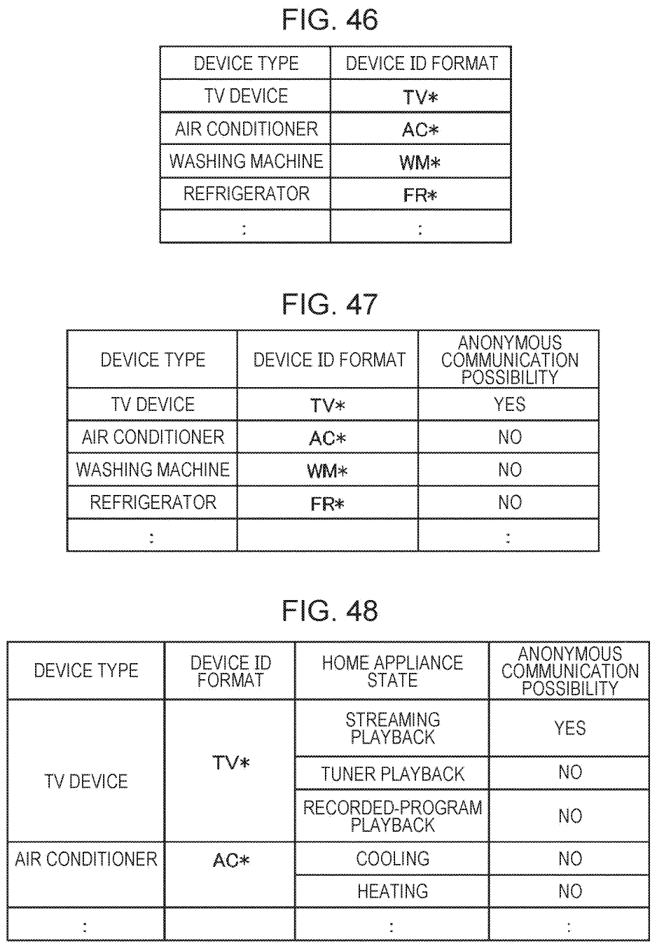

The device type list holder 209 holds a device type list in which device types and device ID formats are associated with each other. A device type list of FIG. 46 stores combinations of a device type and a device ID format.

The device type list of FIG. 46 is an example, and may be described in another format. Although each device ID format is a character string of two alphabets indicating a home appliance and a wild card, the device ID formats are not limited to this. Each device ID format may include only numbers, or may be stored as binary data.

Operation of the unauthorized communication detection device 20 and the unauthorized communication detection system 1 configured as above will be described hereinafter. A first operation, which is a basic processing operation according to the present embodiment, and second to fourth operations for further increasing detection accuracy in the first operation by adding types of information used in the first operation will be described hereinafter one by one.

### 1.3 First Operation of Unauthorized Communication Detection System 1

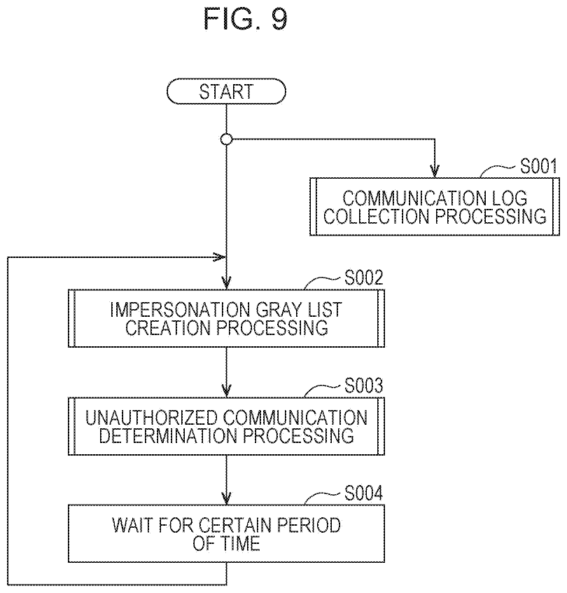

FIG. 9 is a flowchart illustrating the first operation of the unauthorized communication detection system 1 according to the present embodiment. The operation of the unauthorized communication detection system 1 includes three types of processing, namely communication log collection processing, impersonation gray list creation processing, and unauthorized communication determination processing.

First, the communication log collection processing starts as the unauthorized communication detection device 20 is activated (step S001). This processing is performed asynchronously from subsequent processing, and continues until the unauthorized communication detection device 20 is stopped (shut down).

Next, the unauthorized communication detection device 20 performs the impersonation gray list creation processing (step S002), and then performs the unauthorized communication determination processing (step S003). The unauthorized communication detection device 20 waits for a certain period of time (step S004), and returns to step S002. That is, the processing in steps S002 and S003 is repeated at certain time intervals until the unauthorized communication detection device 20 is stopped (shut down).

Each type of processing will be described hereinafter with reference to the drawings.

### 1.3.1 Operation During Communication Log Collection Processing

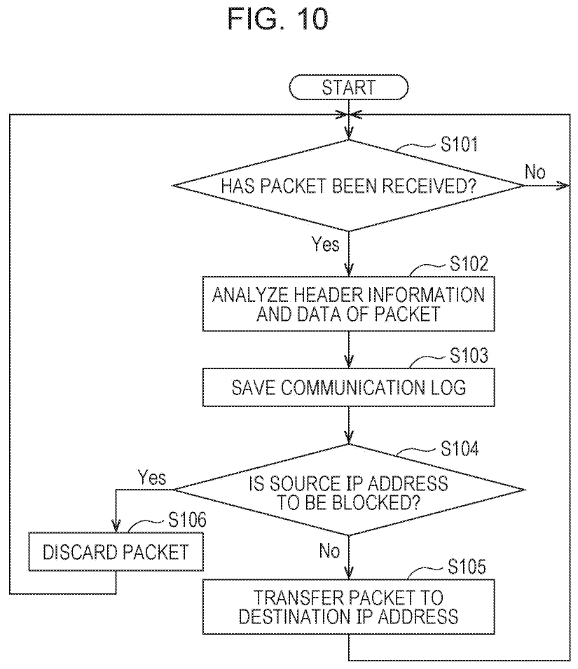

FIG. 10 is a flowchart illustrating an example of the communication log collection processing performed by the unauthorized communication detection system 1.

In step S101, the communication log collector 202 waits for reception of a communication packet from a home appliance belonging to the Internet 10 or the home appliance server 31 via the communicator 201. If receiving a communication packet (YES in S101), the communication log collector 202 analyzes, in step S102, header information and data of the packet and extracts a timestamp of the reception of the packet, a source IP address of the packet, a destination IP address of the packet, a communication state, and a device ID held in the source home appliance. Thereafter, in step S103, the communication log collector 202 saves these pieces of information to the communication log holder 205 as a communication log.

Next, in step S104, the communication log collector 202 checks whether the block list held by the block list holder 206 includes a combination of the source IP address and a destination IP address included in the header information.

If the block list does not include the combination (NO in step S104), the communication log collector 202 transfers, in step S105, the packet to the destination IP address of the header via the communicator 201, and returns to the packet reception wait state (returns to step S101).

If the block list includes the combination (YES in S104), the communication log collector 202 discards, in step S106, the packet without transferring the packet to the destination IP address, and returns to the packet reception wait state (returns to step S101).

### 1.3.2 Operation During Impersonation Gray List Creation Processing

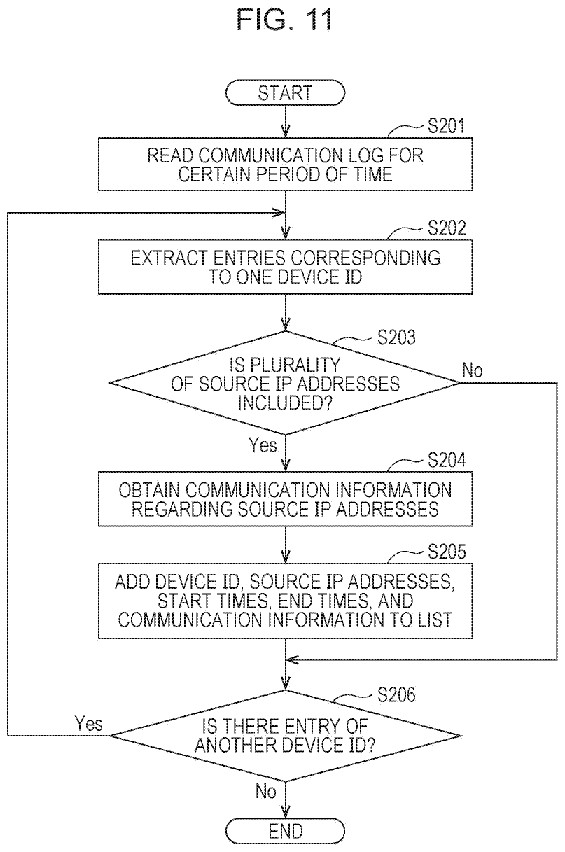

FIG. 11 is a flowchart illustrating an example of the impersonation gray list creation processing performed by the unauthorized communication detection system 1.

In step S201, the impersonation gray list creator 203 reads a communication log for a certain period of time from the communication log holder 205 at certain time intervals. In step S202, the impersonation gray list creator 203 extracts entries of the communication log corresponding to one device ID, and checks, in step S203, whether the extracted entries include a plurality of source IP addresses.

If the extracted entries do not include a plurality of source IP addresses (NO in S203), the impersonation gray list creator 203 determines that there is no possibility that the communication with the device ID involves impersonation, and proceeds to step S206.

If the extracted entries include a plurality of source IP addresses (YES in S203), the impersonation gray list creator 203 determines that there is a possibility that the communication with the device ID involves impersonation, and queries, in step S204, the communication information provision server 32 for the source IP addresses to obtain communication information.

In step S205, the impersonation gray list creator 203 adds, to the impersonation gray list held by the gray list holder 207, the device ID, the plurality of source IP addresses, start times and end times of communication from the source IP addresses, and communication information regarding the source IP addresses as one record. The record is added in order of the communication start time.

With respect to the communication start time and the communication end time, if a communication has not started or ended in the certain period of time, there is no entry of the communication log storing the information, and the character string “-” is stored instead of a time.

As the communication information, names of ISPs to which the source IP addresses belong and anonymous communication service names if communication from the IP addresses is anonymous or the character string “-” if the communication is not anonymous.

In step S206, the impersonation gray list creator 203 checks whether the communication log for the certain period of time extracted in step S201 includes an entry of another device ID and, if the communication log includes an entry of another device ID (YES in S206), returns to step S202. If the communication log does not include an entry of another device ID (NO in S206), the impersonation gray list creator 203 ends the processing.

### 1.3.3 Operation During Unauthorized Communication Determination Processing

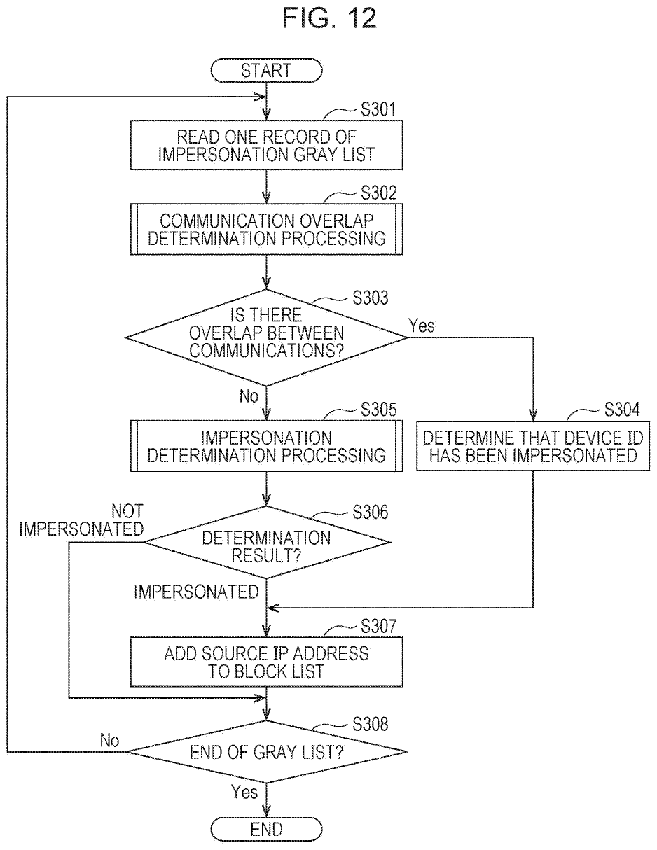

FIG. 12 is a flowchart illustrating an example of the unauthorized communication determination processing performed by the unauthorized communication detection system 1.

In step S301, the unauthorized communication determiner 204 reads a record of the impersonation gray list from the gray list holder 207.

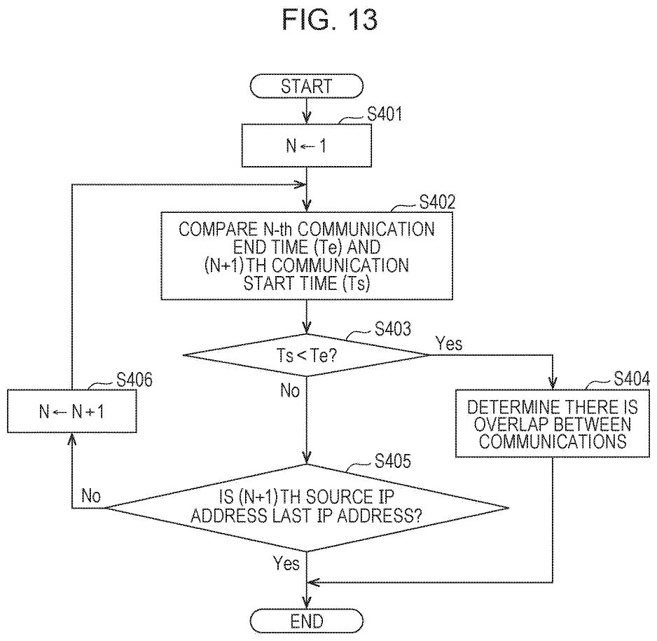

In step S302, the unauthorized communication determiner 204 performs communication overlap determination processing for checking whether there is an overlap between a plurality of communications included in the read record. Details of this processing will be described later with reference to FIG. 13.

If there is an overlap between the plurality of communications (YES in S303), the unauthorized communication determiner 204 judges that there has been unauthorized access involving impersonation (step S304), and proceeds to step S307. The unauthorized communication determiner 204 adds combinations of a source IP address and a destination IP address of the communications to the block list stored in the block list holder 206.

Thereafter, in step S308, the unauthorized communication determiner 204 checks whether the impersonation gray list has been read to an end and, if not (NO in S308), returns to step S301. If the impersonation gray list has been read to the end (YES in S308), the unauthorized communication determiner 204 ends the processing.

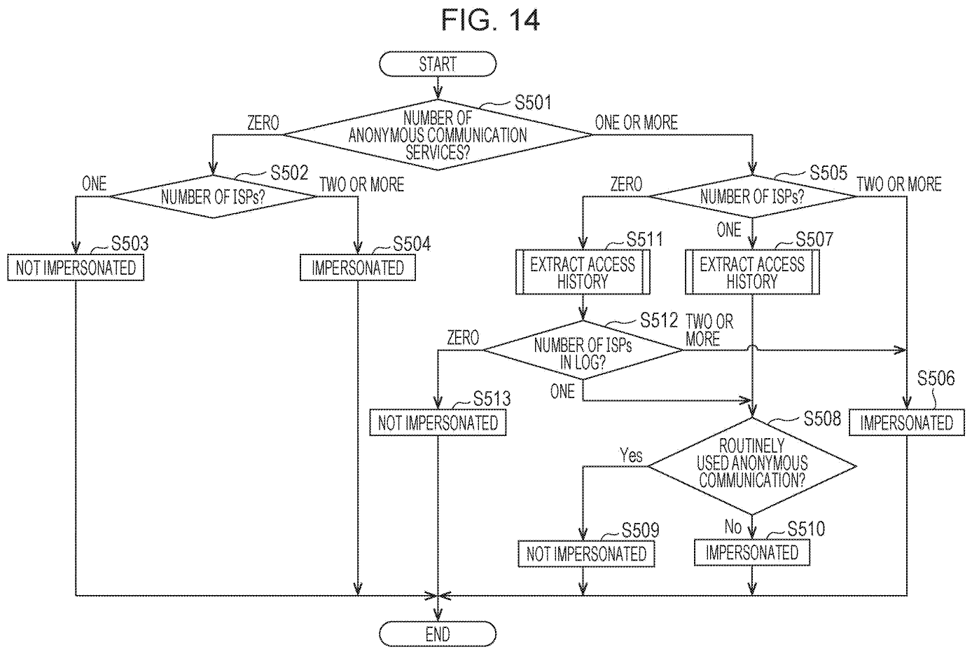

If there is no overlap between the plurality of communications (NO in S303), the unauthorized communication determiner 204 performs impersonation determination processing in step S305. Details of this processing will be described later with reference to FIG. 14.

Next, in step S306, the unauthorized communication determiner 204 checks an impersonation determination result obtained in step S305 described above and, if no impersonation is involved, proceeds to step S308. The unauthorized communication determiner 204 checks whether the impersonation gray list has been read to the end.

If the impersonation gray list has not been read to the end (NO in S308), the unauthorized communication determiner 204 returns to step S301. If the impersonation gray list has been read to the end (YES in S308), the unauthorized communication determiner 204 ends the processing.

If the impersonation determination result indicates impersonation in step S306, the unauthorized communication determiner 204 proceeds to step S307, and adds the combinations of a source IP address and a destination IP address of the communications to the block list stored in the block list holder 206.

Thereafter, in step S308, the unauthorized communication determiner 204 checks whether the impersonation gray list has been read to the end and, if not (NO in S308), returns to step S301. If the impersonation gray list has been read to the end (YES in S308), the unauthorized communication determiner 204 ends the processing.

As described above, since an ISP changes an IP address, it is possible that an IP address once blocked as an access source of impersonation is assigned to a legitimate home appliance. In this case, it is difficult for the legitimate home appliance to communicate with the home appliance server 31 normally. In order to avoid such a condition, a period of blocking may be set, and after the period ends, the blocking may be released.

Details of the communication overlap determination processing in step S302 will be described with reference to FIG. 13. Specifically, the unauthorized communication determiner 204 compares the communications from the plurality of source IP addresses included in the record read in step S301 two by two from the top, and checks whether there is an overlap. The record stores source IP addresses and communication information in order of the communication start time.

In step S401, the unauthorized communication determiner 204 assigns an initial value of 1 to a counter N. In step S402, the unauthorized communication determiner 204 compares a communication end time (Te) of an N-th source IP address and a communication start time (Ts) of an (N+1)th source IP address.

If the communication start time (Ts) of the (N+1)th source IP address is smaller than the communication end time (Te) of the N-th source IP address (YES in S403), the unauthorized communication determiner 204 determines that there is an overlap between the communications (step S404), and ends the processing.

If the communication start time (Ts) of the (N+1)th source IP address is larger than or equal to the communication end time (Te) of the N-th source IP address (NO in S403), the unauthorized communication determiner 204 checks, in step S405, whether the (N+1)th source IP address is an end of the record. If the (N+1)th source IP address is not the end of the record (NO in S405), the unauthorized communication determiner 204 assigns N+1 to the counter N to compare next two communications (step S406), and returns to step S402.

If the (N+1)th source IP address is the end of the record (YES in S405), the unauthorized communication determiner 204 ends the processing.

Next, details of the impersonation determination processing in step S305 will be described.

In step S501 of FIG. 14, the unauthorized communication determiner 204 counts the number of anonymous communication services included in the read record. Specifically, the unauthorized communication determiner 204 counts the number of types of anonymous communication service names stored in an “anonymous communication service name” column of the record. The same anonymous communication service name is counted as one.

If the number of anonymous communication services is zero, the unauthorized communication determiner 204 proceeds to step S502, and counts the number of ISPs of non-anonymous communication included in the read record. Specifically, the unauthorized communication determiner 204 counts the number of types of ISP names stored in an “ISP name” column of the record. The same ISP name is counted as one.

If the number of ISPs is one, the unauthorized communication determiner 204 proceeds to step S503. The unauthorized communication determiner 204 judges that impersonation is not involved, and ends the processing. If the number of ISPs is two or more, the unauthorized communication determiner 204 proceeds to step S504. The unauthorized communication determiner 204 judges that impersonation is involved, and ends the processing.

Even when the number of ISPs is two or more, if source IP addresses correspond to ISPs that are mobile virtual network operators (MVNOs), the communication information provision server 32 might return ISP names of mobile network operators (MNOs) depending on timing of the inquiry. Even when the number of ISPs is two or more, therefore, a more detailed judgment, such as a judgment that impersonation is not involved in the case of a combination of an MNO and an MVNO, may be made.

If the number of anonymous communication services is one or more in step S501, the unauthorized communication determiner 204 proceeds to step S505, and counts the number of ISPs of non-anonymous communication included in the read record. Specifically, the unauthorized communication determiner 204 counts the number of types of ISP names stored in the “ISP name” column of the record. The same ISP name is counted as one.

If the number of ISPs is two or more, the unauthorized communication determiner 204 proceeds to step S506. The unauthorized communication determiner 204 judges that impersonation is involved, and ends the processing.

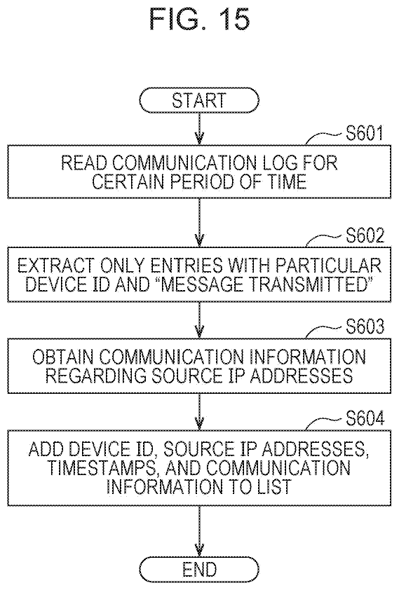

If the number of ISPs is one in step S505, the unauthorized communication determiner 204 proceeds to step S507. The unauthorized communication determiner 204 extracts an access history of the device ID and saves the access history to the access history holder 208. Specifically, details will be described later with reference to FIG. 15.

In step S508, the unauthorized communication determiner 204 checks whether the anonymous communication service included in the record read from the impersonation gray list frequently appears in the access history extracted in step S507, that is, whether the anonymous communication service is routinely used from the device ID.

For example, if access intervals are short, such as once in several days, and access has been made over a relatively long period of time such as at least several weeks, the unauthorized communication determiner 204 determines that the anonymous communication service is routinely used, and proceeds to step S509. The unauthorized communication determiner 204 judges that impersonation is not involved, and ends the processing. The frequency with which routine access is determined is an example, and another frequency may be used, instead.

If the anonymous communication service is not routinely used, the unauthorized communication determiner 204 proceeds to step S510. The unauthorized communication determiner 204 judges that impersonation is involved, and ends the processing.

In step S505, if the number of ISPs is zero, the unauthorized communication determiner 204 proceeds to step S511. The unauthorized communication determiner 204 extracts the access history of the device ID and saves the access history to the access history holder 208. Specifically, details will be described later with reference to FIG. 15.

In step S512, the unauthorized communication determiner 204 refers to the access history and counts the number of ISPs of non-anonymous communication. Specifically, the unauthorized communication determiner 204 counts the number of types of ISP names stored in the “ISP name” column of the record.

If the number of ISPs is zero, that is, if there is no history of non-anonymous communication, the unauthorized communication determiner 204 proceeds to step S513. The unauthorized communication determiner 204 judges that impersonation is not involved since the device ID routinely uses the anonymous communication service, and ends the processing.

If the number of ISPs of the communication log is two or more, the unauthorized communication determiner 204 proceeds to step S506. The unauthorized communication determiner 204 judges that impersonation is involved, and ends the processing.

If the number of ISPs in the access history is one, the unauthorized communication determiner 204 proceeds to step S508. The unauthorized communication determiner 204 checks whether the anonymous communication service included in the read record is an anonymous communication service routinely used from the device ID.

If the anonymous communication service included in the read record is an anonymous communication service routinely used from the device ID, the unauthorized communication determiner 204 proceeds to step S509. The unauthorized communication determiner 204 judges that impersonation is not involved, and ends the processing. If the anonymous communication service included in the read record is not an anonymous communication service routinely used from the device ID, the unauthorized communication determiner 204 proceeds to step S510. The unauthorized communication determiner 204 judges that impersonation is involved, and ends the processing.

Next, details of the access history extraction processing performed in steps S507 and S511 will be described with reference to FIG. 15.

In step S601, the unauthorized communication determiner 204 reads a communication log for a certain period of time from the communication log holder 205.

In step S602, the unauthorized communication determiner 204 extracts only entries of the communication log with the device ID and the communication state of “message transmitted”.

In step S603, the unauthorized communication determiner 204 queries the communication information provision server 32 for all source IP addresses included in the extracted entries to obtain communication information.

In step S604, the unauthorized communication determiner 204 saves, as one record, the device ID, the source IP addresses, timestamps, and communication information regarding the source IP addresses, to the access history holder 208 as an access history, and ends the processing. The unauthorized communication determiner 204 saves the records in order of the timestamp. As the communication information, ISP names to which the source IP addresses belong and anonymous communication service names if communication from the IP addresses is anonymous or a character string “-” if the communication is not anonymous.

### 1.3.4 Specific Example of Unauthorized Communication Determination Processing

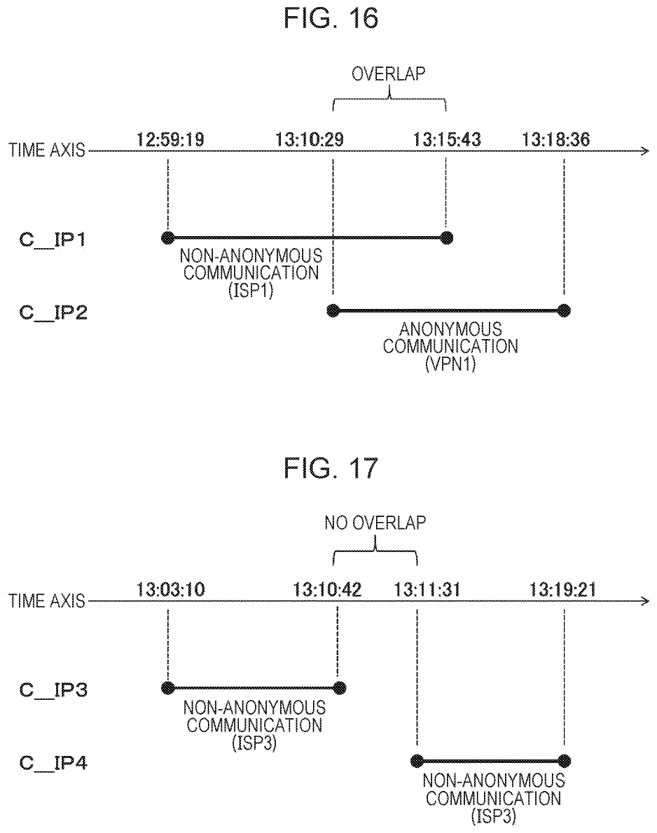

FIGS. 16 to 21 are diagrams visualizing communications of records No. 1 to No. 6 of the impersonation gray list of FIG. 6.

The processing performed by the unauthorized communication determiner 204 for each of records No. 1 to No. 6 of the impersonation gray list of FIG. 6 will be specifically described hereinafter with reference to FIGS. 12 to 21.

After reading record No. 1 in step S301 of the unauthorized communication determination processing of FIG. 12, the unauthorized communication determiner 204 makes a communication overlap determination (S302). Specifically, referring to FIG. 13, first, in step S401, the unauthorized communication determiner 204 assigns an initial value of 1 to the counter N and compares a communication end time of a first source IP address C_IP1 and a communication start time of a second source IP address C_IP2 of record No. 1 (S402).

As illustrated in FIG. 16, since the communication start time “13:10:29” of C_IP2 is earlier than the communication end time “13:15:43” of C_IP1 (YES in S403), the unauthorized communication determiner 204 determines that there is an overlap between the communications in a period of “13:10:29” to “13:15:43” (S404), and ends the processing.

Returning to FIG. 12, the unauthorized communication determiner 204 checks the communication overlap determination result in step S303. Since there is an overlap between the communications (YES in S303), the unauthorized communication determiner 204 judges that a device ID “TV1” of record No. 1 is impersonated (S304), and adds a combination (C_IP/S_IP) of the source IP address C_IP1 and a destination IP address S_IP and C_IP2/S_IP to the block list (S307). Since record No. 1 is not a last record of the impersonation gray list (NO in S308), the unauthorized communication determiner 204 returns to step S301.

After reading record No. 2 in step S301, the unauthorized communication determiner 204 makes the communication overlap determination (S302). Specifically, referring to FIG. 13, first, in step S401, the unauthorized communication determiner 204 assigns an initial value of 1 to the counter N and compares a communication end time of a first source IP address C_IP3 and a communication start time of a second source IP address C_IP4 of record No. 2 (S402).

As illustrated in FIG. 17, since the communication start time “13:11:31” of C_IP4 is later than the communication end time “13:10:42” of C_IP3 (NO in S403), the unauthorized communication determiner 204 determines that there is no overlap between the communications (S404). Since C_IP4 is a last source IP address of record No. 2 (YES in S405), the unauthorized communication determiner 204 ends the processing.

Returning to FIG. 12, the unauthorized communication determiner 204 checks the communication overlap determination result in step S303, and since there is no overlap between the communications (NO in S303), and proceeds to the impersonation determination processing (S305).

In step S501 of FIG. 14, the unauthorized communication determiner 204 counts the number of anonymous communication services included in record No. 2. Since both C_IP3 and C_IP4 store “-” as the anonymous communication service name, the number of anonymous communication services included in record No. 2 is zero. The unauthorized communication determiner 204 proceeds to step S502, and checks the number of ISPs included in record No. 2. Since C_IP3 and C_IP4 both store ISP3, the number of ISPs is one. This condition is, for example, considered to be a case where TV2 that has been performing communication using C_IP3 assigned by ISP3 is performing communication after the IP address has changed to C_IP4 due to a restart of the home appliance or a house router or for some reason on an ISP side. The unauthorized communication determiner 204, therefore, judges that impersonation is not involved (step S503), and ends the processing.

Since the determination result in step S306 of FIG. 12 does not indicate impersonation, the unauthorized communication determiner 204 checks whether record No. 2 is the last record of the impersonation gray list (S308). Since record No. 2 is not the last record (NO in S308), and the unauthorized communication determiner 204 returns to step S301.

After reading record No. 3 in step S301, the unauthorized communication determiner 204 makes the communication overlap determination (S302). Specifically, referring to FIG. 13, first, in step S401, the unauthorized communication determiner 204 assigns an initial value of 1 to the counter N and compares a communication end time of a first source IP address C_IP5 and a communication start time of a second source IP address C_IP6 of record No. 3 (S402).

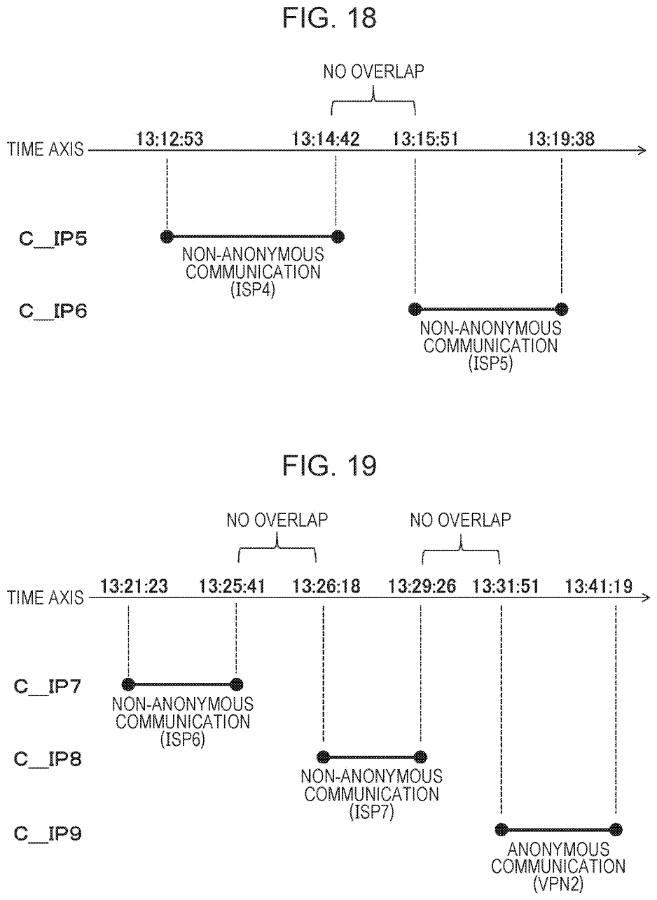

As illustrated in FIG. 18, since the communication start time “13:15:51” of C_IP6 is later than the communication end time “13:14:42” of C_IP5 (NO in S403), the unauthorized communication determiner 204 determines that there is no overlap between the communications (S404). Since C_IP6 is a last source IP address of record No. 3 (YES in S405), the unauthorized communication determiner 204 ends the processing.

Returning to FIG. 12, the unauthorized communication determiner 204 checks the communication overlap determination result in step S303. Since there is no overlap between the communications (NO in S303), the unauthorized communication determiner 204 proceeds to the impersonation determination processing (S305).

In step S501 of FIG. 14, the unauthorized communication determiner 204 counts the number of anonymous communication services included in record No. 3. Since both C_IP5 and C_IP6 store “-” as the anonymous communication service name, the number of anonymous communication services included in record No. 3 is zero. The unauthorized communication determiner 204 proceeds to step S502, and checks the number of ISPs included in record No. 3. Since C_IP5 stores ISP4 and C_IP6 stores ISP5, the number of ISPs is two. Since only one ISP is normally contracted in a typical household, when the number of ISPs is two or more, even if one of the ISPs corresponds to access from a legitimate home appliance, the others are highly likely to be communications involving impersonation of TV3. The unauthorized communication determiner 204, therefore, judges that impersonation is involved (step S504), and ends the processing.

Since the determination result in S306 of FIG. 12 indicates impersonation, the unauthorized communication determiner 204 adds C_IP5/S_IP and C_IP6/S_IP, which are combinations of a source IP address and a destination IP address, to the block list (S307). The unauthorized communication determiner 204 then checks whether record No. 3 is the last record of the impersonation gray list (S308), and since record No. 3 is not the last record (NO in S308), returns to step S301.

After reading record No. 4 in step S301, the unauthorized communication determiner 204 makes the communication overlap determination (S302). Since record No. 4 includes three source IP addresses, the unauthorized communication determiner 204 makes the communication overlap determination twice. Specifically, referring to FIG. 13, first, in step S401, the unauthorized communication determiner 204 assigns an initial value of 1 to the counter N, and compares a communication end time of a first source IP address C_IP7 and a communication start time of a second source IP address C_IP8 of record No. 4 (S402).

As illustrated in FIG. 19, since the communication start time “13:26:18” of C_IP8 is later than the communication end time “13:25:41” of C_IP7 (NO in S403), the unauthorized communication determiner 204 determines there is no overlap between the communications (S404). Since C_IP8 is not a last source IP address of No. 4 (NO in S405), the unauthorized communication determiner 204 assigns N+1 to N (S406), and returns to step S402.

The unauthorized communication determiner 204 compares a communication end time of the second source IP address C_IP8 and a communication start time of a third source IP address C_IP9 of record No. 4 (S402).

As illustrated in FIG. 19, since the communication start time of “13:31:51” of C_IP9 is later than the communication end time “13:29:26” of C_IP8 (NO in S403), the unauthorized communication determiner 204 determines there is no overlap between the communications (S404). Since C_IP9 is the last source IP address of record No. 4 (YES in S405), the unauthorized communication determiner 204 ends the processing.

Returning to FIG. 12, the unauthorized communication determiner 204 checks the communication overlap result in step S303. Since there is no overlap between the communications (NO in S303), the unauthorized communication determiner 204 proceeds to the impersonation determination processing (S305).

In step S501 of FIG. 14, the unauthorized communication determiner 204 counts the number of anonymous communication services included in record No. 4. Both C_IP7 and C_IP8 store “-” as the anonymous communication service name, and C_IP9 stores “VPN2”. That is, since the number of anonymous communication services included in record No. 4 is one, the unauthorized communication determiner 204 proceeds to step S505, and checks the number of ISPs of non-anonymous communication included in record No. 4. Since C_IP9 is anonymous communication, ISP6 of C_IP7 and ISP7 of C_IP8 are counted, and the number of ISPs is two. Since only one ISP is normally contracted in a typical household, when the number of ISPs is two or more, even if one of the ISPs corresponds to access from a legitimate home appliance, the others are highly likely to be communications involving impersonation of TV4. The unauthorized communication determiner 204, therefore, judges that impersonation is involved (step S506), and ends the processing.

Since the determination result in step S306 of FIG. 12 indicates impersonation, the unauthorized communication determiner 204 adds C_IP7/S_IP, C_IP8/S_IP, and C_IP9/S_IP, which are combinations of a source IP address and a destination IP address, to the block list (S307).

The unauthorized communication determiner 204 then checks whether record No. 4 is the last record of the impersonation gray list (S308). Since record No. 4 is not the last record (NO in S308), the unauthorized communication determiner 204 returns to step S301.

After reading record No. 5 in step S301, the unauthorized communication determiner 204 makes the communication overlap determination (S302). Specifically, referring to FIG. 13, first, in step S401, the unauthorized communication determiner 204 assigns an initial value of 1 to the counter N, and compares a communication end time of a first source IP address C_IP10 and a communication start time of a second source IP address C_IP11 of record No. 5 (S402).

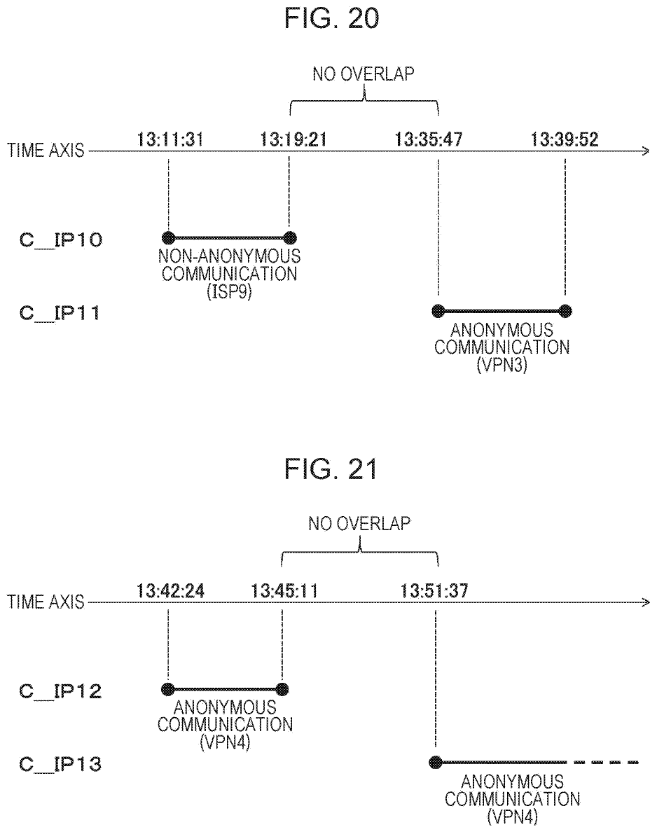

As illustrated in FIG. 20, since the communication start time “13:35:47” of C_IP11 is later than the communication end time “13:19:21” of C_IP10 (NO in S403), the unauthorized communication determiner 204 determines that there is no overlap between the communications (S404). Since C_IP11 is a last source IP address of record No. 5 (YES in S405), the unauthorized communication determiner 204 ends the processing.

Returning to FIG. 12, the unauthorized communication determiner 204 checks the communication overlap determination result in step S303, and since there is no overlap between the communications (NO in S303), and proceeds to the impersonation determination processing (S305).

In step S501 of FIG. 14, the unauthorized communication determiner 204 counts the number of anonymous communication services included in record No. 5. C_IP10 stores “-” as the anonymous communication service name, and C_IP11 stores “VPN3”. That is, since the number of anonymous communication services included in record No. 5 is one, the unauthorized communication determiner 204 proceeds to step S505, and checks the number of ISPs of non-anonymous communication included in record No. 5. Since C_IP11 is anonymous communication, ISP9 of C_IP10 is counted, and the number of ISPs is one. In the case of such a combination of one anonymous communication and one non-anonymous communication, it is possible that a legitimate home appliance (TV5) usually accesses the home appliance server 31 using an IP address assigned by ISP9 but is connected to VPN3 when viewing videos. The unauthorized communication determiner 204, therefore, proceeds to step S507, and extracts an access history of TV5.

FIG. 7 illustrates an example of a result of extraction of an access history of TV5 in past one year after performing the procedure of steps S601 to S604 of FIG. 15 described above. The unauthorized communication determiner 204 checks, on the basis of the access history, whether VPN3 is a routinely used anonymous communication service (step S508).

Since the access history of FIG. 7 indicates that ISP9 and an IP address of VPN3 have been continuously used for one year, the unauthorized communication determiner 204 determines that VPN3 is a routinely used anonymous communication service (YES in S508). In step S509, the unauthorized communication determiner 204 judges that impersonation is not involved, and ends the processing.

If the anonymous communication service included in the access history of FIG. 7 is other than VPN3, namely VPN5, for example, the unauthorized communication determiner 204 determines that although the routinely used anonymous communication service is VPN5, the current one-time access from VPN3 is likely to involve impersonation.

After completing the impersonation determination processing, the unauthorized communication determiner 204 checks, in step S306 of FIG. 12, whether record No. 5 is the last record of the impersonation gray list (S308) since the determination result does not indicate impersonation. Since record No. 5 is not the last record (NO in S308), the unauthorized communication determiner 204 returns to step S301.

After reading record No. 6 in step S301, the unauthorized communication determiner 204 makes the communication overlap determination (S302). Specifically, referring to FIG. 13, first, in step S401, the unauthorized communication determiner 204 assigns an initial value of 1 to the counter N, and compares a communication end time of a first source IP address C_IP12 and a communication start time of a second source IP address C_IP13 of record No. 6 (S402).

As illustrated in FIG. 21, since the communication start time “13:51:37” of C_IP13 is later than the communication end time “13:45:11” of C_IP12 (NO in S403), the unauthorized communication determiner 204 determines that there is no overlap between the communications (S404). Since C_IP13 is the last source IP address of record No. 6 (YES in S405), the unauthorized communication determiner 204 ends the processing.

Returning to FIG. 12, the unauthorized communication determiner 204 checks the communication overlap determination result in step S303 and, since there is no overlap between the communications (NO in S303), proceeds to the impersonation determination processing (S305).

In step S501 of FIG. 14, the unauthorized communication determiner 204 counts the number of anonymous communication services included in record No. 6. Both C_IP12 and C_IP13 store “VPN4” as the anonymous communication service name. That is, since the number of anonymous communication services included in record No. 6 is one, the unauthorized communication determiner 204 proceeds to step S505, and checks the number of ISPs of non-anonymous communication included in record No. 6. As described above, since both C_IP12 and C_IP13 are anonymous communication, the number of ISPs of non-anonymous communication is zero.

Such a condition where there is only one anonymous communication is, as with record No. 5, likely to be a case (case 1) where a legitimate home appliance (TV6) usually accesses the home appliance server 31 using an IP address assigned by a contracted ISP but the IP address has changed for some reason since the legitimate home appliance is connected to VPN4 when viewing videos or a case (case 2) where a legitimate home appliance (TV5) routinely uses VPN4 mainly and the IP address has changed. In order to determine which case applies, the unauthorized communication determiner 204 first proceeds to step S507, and extracts an access history of TV6.

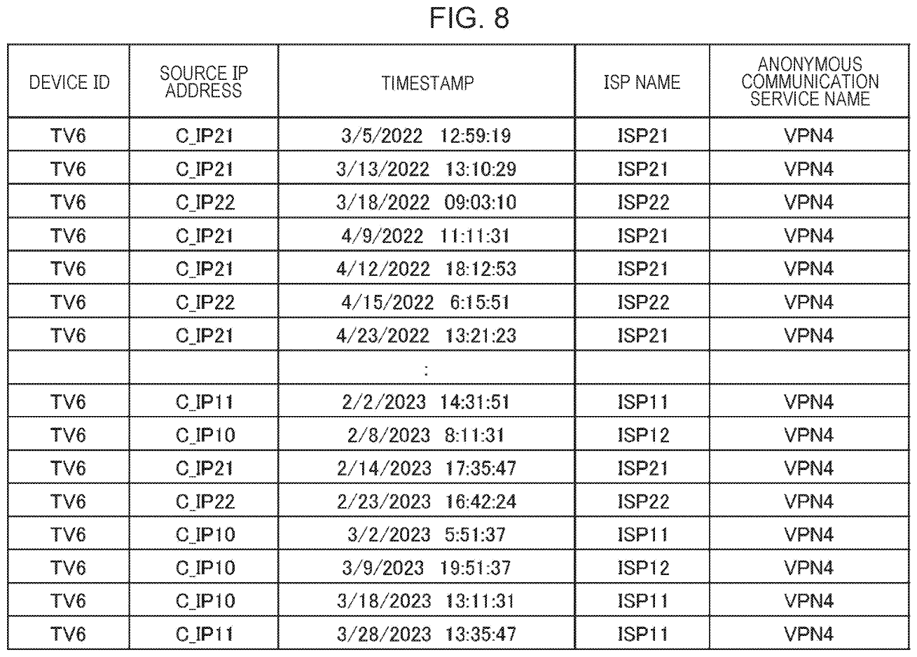

FIG. 8 illustrates an example of a result of extraction of an access history of TV6 in past one year after performing the procedure of steps S601 to S604 in FIG. 15 described above. The unauthorized communication determiner 204 checks the number of past non-anonymous communication services from the access history and determines which of case 1 and case 2 applies (step S512).

Since the access history of FIG. 8 indicates that only VPN4 has been continuously used for one year, the above-described case 2 applies. That is, the unauthorized communication determiner 204 judges that impersonation is not involved (step S513), and ends the processing.

If the anonymous communication service included in the access history of FIG. 8 is other than VPN4, namely VPN5, for example, the unauthorized communication determiner 204 determines that although the routinely used anonymous communication service is VPN5, the current one-time access from VPN4 is likely to involve impersonation.

After completing the impersonation determination processing, the unauthorized communication determiner 204 checks, in step S306 of FIG. 12, whether record No. 6 is the last record of the impersonation gray list (S308) since the determination result does not indicate impersonation. Since record No. 6 is the last record (YES in S308), the unauthorized communication determiner 204 ends the unauthorized communication determination processing.

### 1.4 Second Operation of Unauthorized Communication Detection System 1

In the first operation, which is the basic processing operation according to the present embodiment, when access is made from different IP addresses using the same device ID in a certain period of time, whether each of the plurality of communications is anonymous communication or non-anonymous communication is identified, and whether impersonation is involved is judged in consideration of the number and combinations of anonymous communications and non-anonymous communications. In a second operation, accuracy of the impersonation determination when the number of ISPs is one as in steps S503, S509, and S510 in the impersonation determination processing of FIG. 14 can be increased by adding country names and city names associated with IP addresses as judgment conditions.

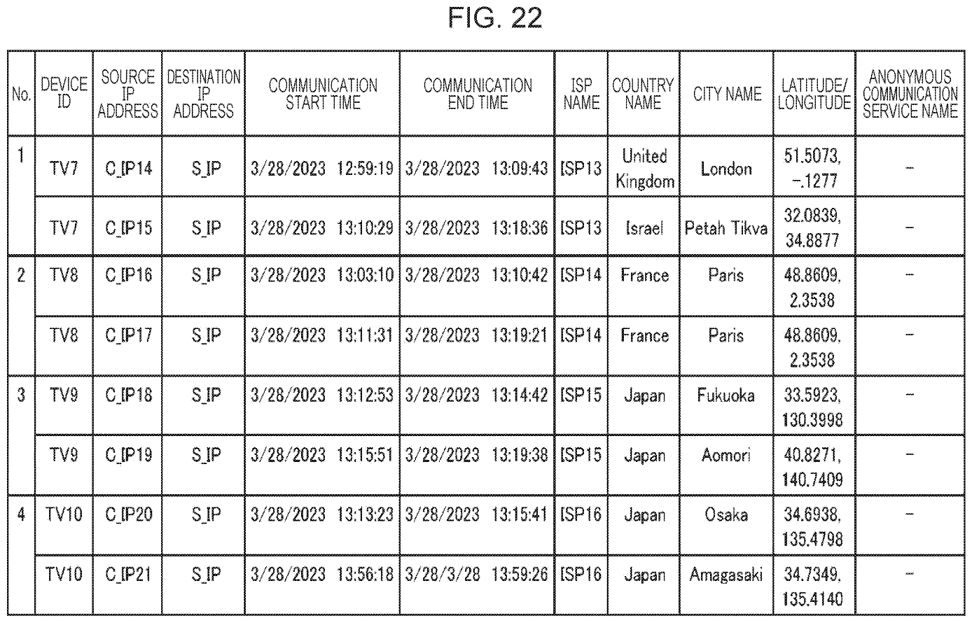

FIG. 22 is a diagram illustrating an impersonation gray list in the second operation according to the present embodiment. Information regarding country names, city names, and latitude and longitude is added to the impersonation gray list of FIG. 6 used in the first operation.

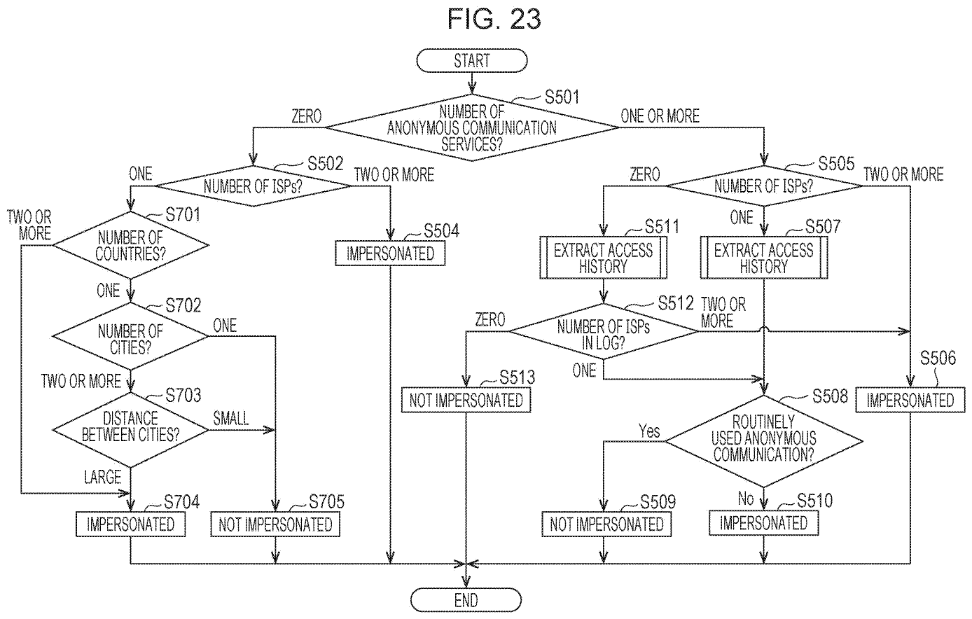

FIG. 23 is a diagram illustrating an example of impersonation determination processing in the second operation according to the present embodiment. A more detailed judgment procedure (step S701 to S705) based on country names and city names is added to step S503 of FIG. 14 used in the first operation.

Processing steps different from those in the first operation will be described with reference to FIGS. 22 and 23, and description of the same processing steps is omitted.

The unauthorized communication determiner 204 reads record No. 1 of the impersonation gray list of FIG. 22, and since there is no overlap between communications, proceeds to the impersonation determination processing of FIG. 23.

In step S501 of FIG. 23, the unauthorized communication determiner 204 counts the number of anonymous communication services included in record No. 1. Since both C_IP14 and C_IP15 store “-” as the anonymous communication service name, the number of anonymous communication service names included in record No. 1 is zero. The unauthorized communication determiner 204, therefore, proceeds to step S502, and checks the number of ISPs included in record No. 1.

C_IP14 and C_IP15 both store ISP13, and the number of ISPs is one. The unauthorized communication determiner 204, therefore, proceeds to step S701, and counts the number of countries. Since C_IP14 stores “United Kingdom” and C_IP15 stores “Israel”, the number of countries is two.

This condition means that a home appliance having a device ID “TV7” is accessing from United Kingdom and Israel at substantially the same time, and it is clear that at least one of the communications is likely to be unauthorized access involving impersonation. The unauthorized communication determiner 204, therefore, judges that impersonation is involved (step S704), and ends the processing.

In this case, it is difficult to determine which communication is unauthorized access involving impersonation, and in step S307 of FIG. 12, the unauthorized communication determiner 204 adds C_IP14/S_IP and C_IP15/S_IP, which are combinations of a source IP address and a destination IP address, to the block list (S307).

Record No. 1 is judged in the first operation as a record that does not involve impersonation, but can be judged to involve impersonation in the second operation, whose determination accuracy is increased by adding the number of countries as a judgment condition.

Next, the unauthorized communication determiner 204 reads record No. 2 and, since there is no overlap between communications, proceeds to the impersonation determination processing of FIG. 23. In step S501 of FIG. 23, the unauthorized communication determiner 204 counts the number of anonymous communication services included in record No. 2.

Since both C_IP16 and C_IP17 store “-” as the anonymous communication service name, the number of anonymous communication services included in record No. 2 is zero. The unauthorized communication determiner 204, therefore, proceeds to step S502, and checks the number of ISPs included in record No. 2.

Since both C_IP16 and C_IP17 store ISP14, the number of ISPs is one. The unauthorized communication determiner 204, therefore, proceeds to step S701, and counts the number of countries.

Since both C_IP16 and C_IP17 store “France”, the number of countries is one. The unauthorized communication determiner 204, therefore, proceeds to step S702, and counts the number of cities.

Since both C_IP16 and C_IP17 store Paris, the number of cities is one.

This condition means that these two source IP addresses are likely to correspond to the same user. The unauthorized communication determiner 204, therefore, judges that impersonation is not involved (step S705), and ends the processing.

Next, the unauthorized communication determiner 204 reads record No. 3, and since there is not overlap between communications, proceeds to the impersonation determination processing of FIG. 23. In step S501 of FIG. 23, the unauthorized communication determiner 204 counts the number of anonymous communication services include in record No. 3. Since both C_IP18 and C_IP19 store “-” as the anonymous communication service name, the number of anonymous communication services included in record No. 3 is zero. The unauthorized communication determiner 204, therefore, proceeds to step S502, and checks the number of ISPs included in record No. 3.

Since both C_IP18 and C_IP19 store ISP15, the number of ISPs is one. The unauthorized communication determiner 204, therefore, proceeds to step S701, and counts the number of countries.

Since both C_IP18 and C_IP19 store “Japan”, the number of countries is one. The unauthorized communication determiner 204, therefore, proceeds to step S702, and counts the number of cities.

Since C_IP18 stores “Fukuoka” and C_IP19 stores “Aomori”, the number of cities is two.

In step S703, the unauthorized communication determiner 204 checks whether a distance between the cities is large or small. Specifically, a linear distance is calculated as 1218.7285 km by the spherical law of cosines using the information regarding latitude and longitude included in the record. If the calculated linear distance exceeds a threshold, the unauthorized communication determiner 204 determines that the distance is large.

The threshold may be determined as, for example, 240 km, which can be covered by a car traveling at 80 km/h in three hours, while assuming that a home appliance is transported by car, or may be determined while assuming another scene. The threshold is just an example, and is not limited to this.

Although the distance between the cities is calculated by the spherical law of cosines, the latitude and longitude may be mapped in a vector space, or another method may be used, instead.

This condition means that a home appliance having a device ID “TV9” is accessing from Fukuoka and Aomori, which are separated by a linear distance of approximately 1,219 km, at substantially the same time, and the unauthorized communication determiner 204 determines that the distance is large since the distance exceeds 240 km. It is clear that at least one of the communications is likely to be unauthorized access involving impersonation. The unauthorized communication determiner 204, therefore, judges that impersonation is involved (step S704), and ends the processing.

In this case, it is difficult to determine which communication is unauthorized access involving impersonation, and in step S307 of FIG. 12, the unauthorized communication determiner 204 adds C_IP18/S_IP and C_IP19/S_IP, which are combinations of a source IP address and a destination IP address, to the block list (S307).

Record No. 3 is judged in the first operation as a record that does not involve impersonation and in which access is made from the same country, but can be judged to involve impersonation in the second operation, which compares the two entries of the record in more detail also on the basis of the number of cities and the distance as judgment conditions.

Next, the unauthorized communication determiner 204 reads record No. 4, and since there is no overlap between communications, the unauthorized communication determiner 204 proceeds to the impersonation determination processing of FIG. 23.

In step S501 of FIG. 23, the unauthorized communication determiner 204 counts the number of anonymous communication services included in record No. 4. Since both C_IP20 and C_IP21 store “-” as the anonymous communication service name, the number of anonymous communication services included in record No. 4 is zero. The unauthorized communication determiner 204, therefore, proceeds to step S502, and checks the number of ISPs included in record No. 4.

Since both C_IP20 and C_IP21 store ISP16, the number of ISPs is one. The unauthorized communication determiner 204, therefore, proceeds to step S701, and counts the number of countries.

Since both C_IP20 and C_IP21 store “Japan”, the number of countries is one. The unauthorized communication determiner 204, therefore, proceeds to step S702, and counts the number of cities.

Since C_IP20 stores “Osaka” and C_IP21 stores “Amagasaki”, the number of cities is two. In step S703, the unauthorized communication determiner 204 checks whether a distance between the cities is large or small. Specifically, a linear distance is calculated as 7.562 km by the spherical law of cosines using the information regarding latitude and longitude included in the record. Since the linear distance falls below the threshold of 240 km, the unauthorized communication determiner 204 determines that the distance is small.

This condition means that a home appliance having a device ID “TV10” is accessing from Osaka and Amagasaki at substantially the same time. It is possible that one of the communications is unauthorized access involving impersonation, but it is also possible that TV10 that had been used in Osaka was transported to Amagasaki by car.

In this case, in the second operation, the unauthorized communication determiner 204 prioritizes suppression of false detections. The unauthorized communication determiner 204 judges that impersonation is not involved (step S705), and ends the processing.

In the case of a system and service specifications that prioritize detection of unauthorized access involving impersonation, the unauthorized communication determiner 204 may judge that impersonation is involved.

In order to further increase the detection accuracy, a communication start time and a communication end time may also be used as a judgment condition, and whether impersonation is involved may be judged also on the basis of whether a home appliance could be transported between two cities within a period between the times.

The detection accuracy may also be further increased by determining, as a judgment condition, whether a device ID indicates a home appliance that can be transported relatively easily, such as a small TV device or a mobile terminal, or a home appliance that is relatively hard to transport, such as a large refrigerator, a washing machine, or an air conditioner.

Although an example in which the more detailed judgment procedure based on country names and city names is added after step S502 has been described in the description of the second operation according to the present embodiment, the timing of the judgment procedure is not limited to this. For example, a similar judgment procedure may be performed if the result of step S505 indicates that the number of ISPs is one, instead. Specifically, the procedure of steps S701 to S703 may be performed immediately before step S509 to increase the detection accuracy.

### 1.5 Third Operation of Unauthorized Communication Detection System 1

In the first operation, which is the basic processing operation according to the present embodiment, when access is made from different IP addresses using the same device ID in a certain period of time, whether each of the plurality of communications is anonymous communication or non-anonymous communication is identified, and whether impersonation is involved is judged in consideration of the number and combinations of anonymous communications and non-anonymous communications.

In a third operation, the accuracy of the impersonation determination processing of FIG. 14 can be increased by adding a home appliance type that can be identified from a device ID as a judgment condition.

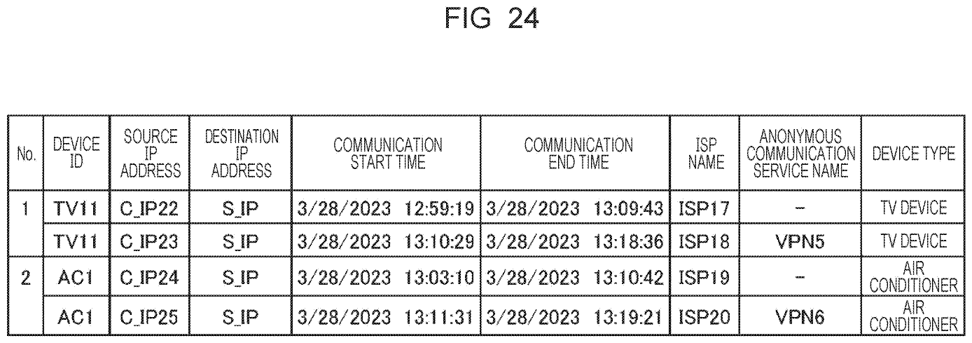

FIG. 24 is a diagram illustrating an impersonation gray list in the third operation according to the present embodiment. Information regarding device types is added to the impersonation gray list of FIG. 6 used in the first operation.

FIG. 47 illustrates a device type list in the third operation according to the present embodiment. In addition to device types and device IDs, information indicating presence or absence of a possibility that a corresponding device type uses anonymous communication is stored.

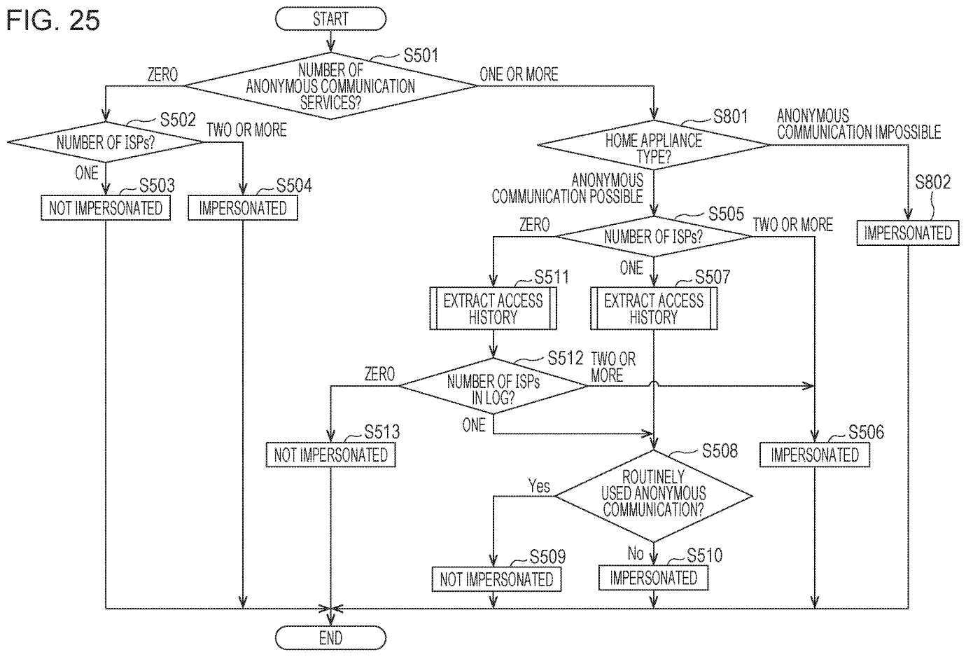

FIG. 25 is a diagram illustrating an example of impersonation determination processing in the third operation according to the present embodiment. If the number of anonymous communication services is one or more in step S501 of FIG. 14 used in the first operation, a more detailed determination procedure (step S801 and S802) is performed using a home appliance type.

Processing steps different from those in the first operation will be described with reference to FIGS. 24 and 25, and description of the same processing steps is omitted.

The unauthorized communication determiner 204 reads record No. 1 of the impersonation gray list of FIG. 24, and since there is no overlap between communications, proceeds to the impersonation determination processing of FIG. 25.

In step S501 of FIG. 25, the unauthorized communication determiner 204 counts the number of anonymous communication services included in record No. 1. Since C_IP22 stores “-” as the anonymous communication service name and C_IP23 stores “VPN5” as the anonymous communication service name, the number of anonymous communication service names included in record No. 1 is one. The unauthorized communication determiner 204, therefore, proceeds to step S801, and determines a home appliance type by checking a device ID included in record No. 1 and referring to the device type list of FIG. 47.

Since a device ID “TV11” indicates a TV device and it is possible to use an anonymous communication service such as a VPN, the unauthorized communication determiner 204 proceeds to the detailed judgment procedure in step S505 and later (description is omitted).

Next, the unauthorized communication determiner 204 reads record No. 2, and since there is no overlap between communications, the unauthorized communication determiner 204 proceeds to the impersonation determination processing of FIG. 25. In step S501 of FIG. 25, the unauthorized communication determiner 204 counts the number of anonymous communication services included in record No. 2.

Since C_IP24 stores “-” as the anonymous communication service name and C_IP25 stores “VPN6” as the anonymous communication service name, the number of anonymous communication services included in record No. 2 is one. The unauthorized communication determiner 204, therefore, proceeds to step S801, and determines a home appliance type by checking a device ID included in record No. 2 and referring to the device type list of FIG. 47.

A device ID “AC1” indicates an air conditioner, and it is not usually possible to use an anonymous communication service such as a VPN. The unauthorized communication determiner 204, therefore, judges that impersonation is involved (step S802), and ends the processing.

Although an air conditioner that is not illustrated in the overall configuration diagram of FIG. 2 is an example of the home appliance in the description of the third operation, the home appliance is not limited to this. Another home appliance such as a refrigerator or a washing machine may be used, instead.

### 1.6 Fourth Operation of Unauthorized Communication Detection System 1

In a fourth operation according to the present embodiment, the detection accuracy can be further increased by adding a home appliance state to the judgment conditions in the third operation including the home appliance type.

For example, this is a procedure that incorporates, as a determination criterion, a concept that when states of a TV device include “streaming playback”, “tuner playback”, and “recorded-program playback”, use of a VPN does not appear unnatural in the case of “streaming playback”, whereas use of a VPN while viewing a program of terrestrial, broadcasting satellite (BS), or communication satellite (CS) broadcasting is unnatural.

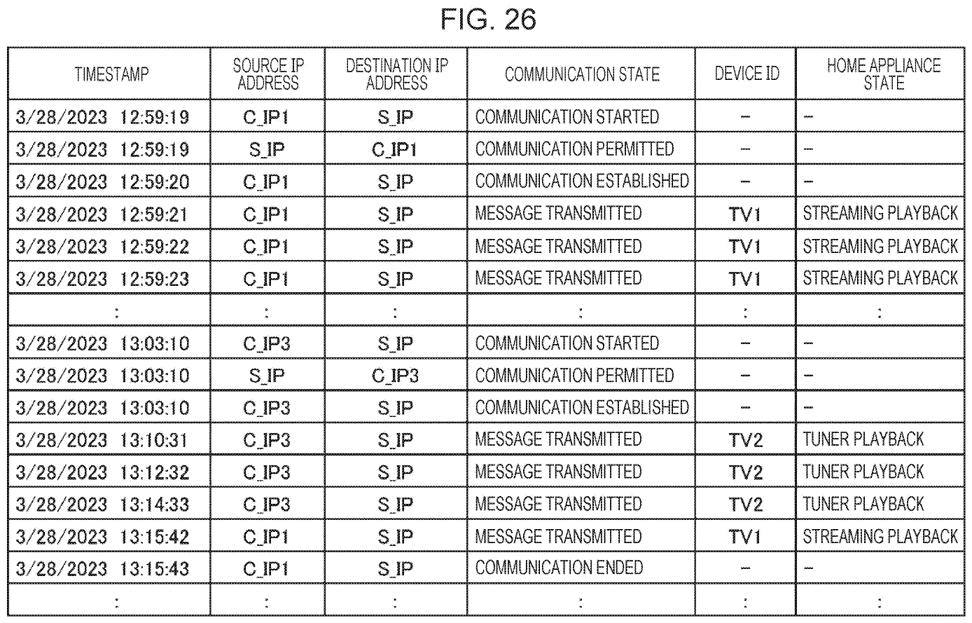

These home appliance states are included in communication data received from home appliances and held by the communication log holder 205 as a communication log illustrated in FIG. 26.

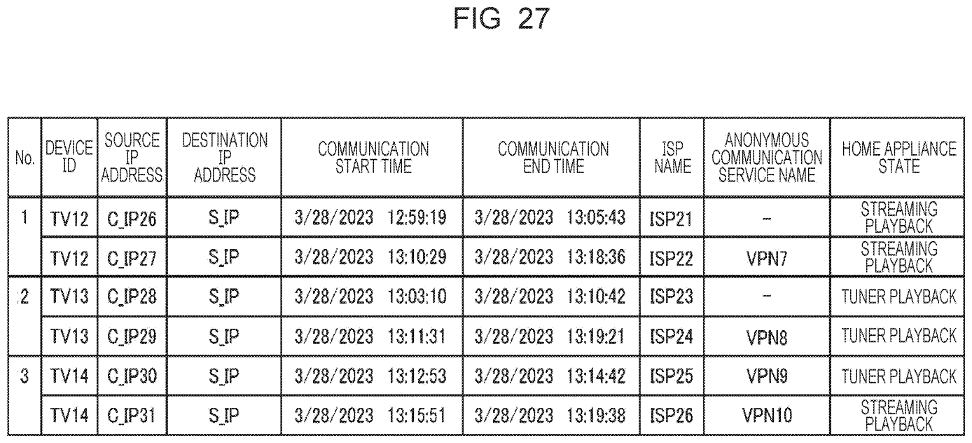

FIG. 27 is a diagram illustrating an impersonation gray list in the fourth operation according to the present embodiment. Information regarding home appliance states is added to the impersonation gray list of FIG. 6 used in the first operation.

FIG. 48 illustrates a device type list in the fourth operation according to the present embodiment. In addition to device types and device IDs, home appliance states and information indicating presence or absence of a possibility that a corresponding home appliance type uses anonymous communication are stored.

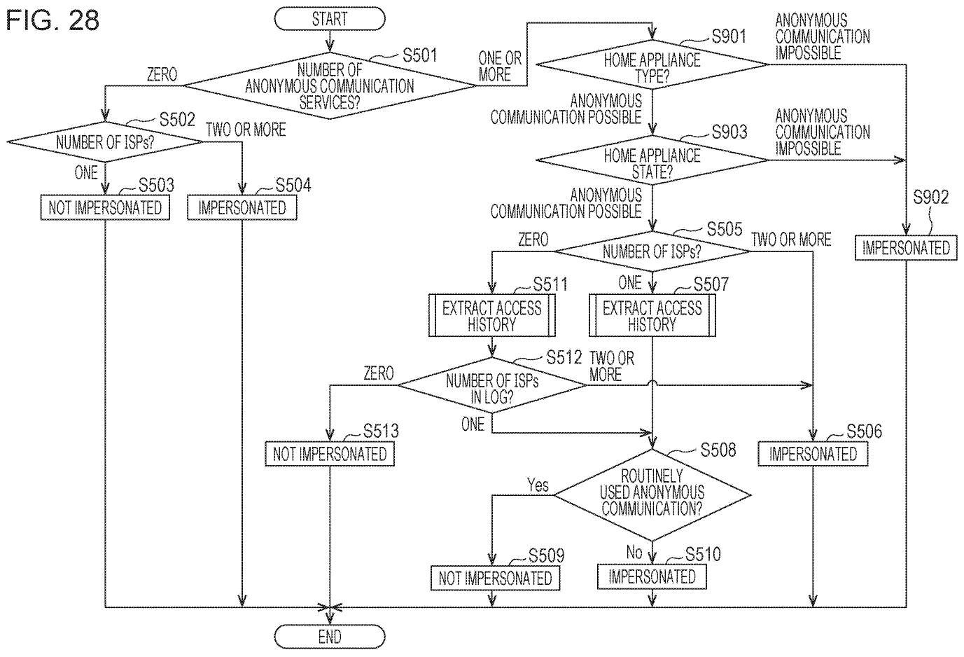

FIG. 28 is a diagram illustrating an example of impersonation determination processing in the fourth operation according to the present embodiment. If the number of anonymous communication services is one or more in step S501 of FIG. 14 used in the first operation, a more detailed determination procedure (step S901 to S903) is performed using the home appliance type and the home appliance state.

Processing steps different from those in the first operation will be described with reference to FIGS. 27 and 28, and description of the same processing steps is omitted.

The unauthorized communication determiner 204 reads record No. 1 of the impersonation gray list of FIG. 27 and, since there is no overlap between communications, proceeds to the impersonation determination processing of FIG. 28.

In step S501 of FIG. 28, the unauthorized communication determiner 204 counts the number of anonymous communication services included in record No. 1. Since C_IP26 stores “-” as the anonymous communication service name and C_IP27 stores “VPN7” as the anonymous communication service name, the number of anonymous communication service names included in record No. 1 is one. The unauthorized communication determiner 204, therefore, proceeds to step S901, and determines the home appliance type by checking a device ID included in record No. 1 and referring to the device type list of FIG. 48.

Since a device ID “TV12” indicates a TV device and it is possible to use an anonymous communication service such as a VPN, the unauthorized communication determiner 204 proceeds to step S903, and checks a home appliance state included in record No. 1. Both C_IP26 and C_IP27 store “streaming playback” as the home appliance state, which means that a video streaming service is being used via the Internet.

A conceivable case is that a video had been viewed using C_IP26, but VPN settings for viewing a video in another country were then made, and video viewing continued to be performed using C_IP27. Since it is possible to use an anonymous communication service in the case of “streaming playback” according to the device type list, the unauthorized communication determiner 204 proceeds to the detailed judgment procedure in step S505 and later (description is omitted).

Next, the unauthorized communication determiner 204 reads record No. 2 and, since there is no overlap between communications, proceeds to the impersonation determination processing of FIG. 28.

In step S501 of FIG. 28, the unauthorized communication determiner 204 counts the number of anonymous communication services included in record No. 2. Since C_IP28 stores “-” as the anonymous communication service name and C_IP29 stores “VPN8” as the anonymous communication service name, the number of anonymous communication services included in record No. 2 is one. The unauthorized communication determiner 204, therefore, proceeds to step S901, and determines the home appliance type by checking a device ID included in record No. 2 and referring to the device type list of FIG. 48.

Since a device ID “TV13” indicates a TV device and it is possible to use an anonymous communication service such as a VPN, the unauthorized communication determiner 204 proceeds to step S903, and checks a home appliance state included in record No. 2.

Both C_IP28 and C_IP29 store “tuner playback” as the home appliance state, which means that a program of terrestrial, BS, or CS broadcasting is being viewed.

Since it is not possible to use anonymous communication with “tuner playback” according to the device type list, the unauthorized communication determiner 204 judges that C_IP29 involves impersonation (step S902), and ends the processing.

In this case, by including, among the source IP addresses, only C_IP29 to the block list, it is possible to reduce a risk of blocking C_IP28, which is likely to correspond to an authorized user, from the home appliance server 31.

Next, the unauthorized communication determiner 204 reads record No. 3 and, since there is no overlap between communications, proceeds to the impersonation determination processing of FIG. 28.

In step S501 of FIG. 28, the unauthorized communication determiner 204 counts the number of anonymous communication services included in record No. 3. Since C_IP30 stores “VPN9” as the anonymous communication service name and C_IP31 stores “VPN10” as the anonymous communication service name, the number of anonymous communication services included in record No. 3 is two. The unauthorized communication determiner 204, therefore, proceeds to step S901, and determines the home appliance type by checking a device ID included in record No. 3 and referring to the device type list of FIG. 48.

Since a device ID “TV14” indicates a TV device and it is possible to use an anonymous communication service such as a VPN, the unauthorized communication determiner 204 proceeds to step S903, and checks a home appliance state included in record No. 3.

C_IP30 stores “tuner playback” as the home appliance state, which means that a program of terrestrial, BS, or CS broadcasting is being viewed, and it is not possible to use anonymous communication with “tuner playback” according to the device type list.

C_IP31, on the other hand, stores “streaming playback” as the home appliance sate, and it is possible to use anonymous communication with “streaming playback” according to the device type list.

The unauthorized communication determiner 204 judges that C_IP30 involves impersonation in consideration of these conditions (step S902), and ends the processing.

In this case, by including, among the source IP addresses, only C_IP30 to the block list, it is possible to reduce a risk of blocking C_IP31, which is likely to correspond to an authorized user, from the home appliance server 31.

Although “streaming playback” and “tuner playback” are examples of the home appliance state in the description of the fourth operation, the home appliance sate is not limited to these. The home appliance state may be another state such as “power off”, “recording”, “recorded-program viewing”, or “standby”, instead.

Although a TV device is an example of the home appliance type, the home appliance type is not limited to this. The home appliance type may be another home appliance that can use an anonymous communication service, instead.

In the first operation, which is the basic processing operation, if it is judged in the impersonation determination processing of FIG. 14 that impersonation is involved (step S504, S506, or S510), it is difficult to identify communication from an authorized user even if such communication is included. Since all the plurality of source IP addresses is added to the block list, access from the authorized user is also blocked.

In the fourth operation, on the other hand, the home appliance type and the home appliance state are also added as judgment conditions, and it is possible to increase a possibility of being able to identify a source IP address corresponding to impersonation among a plurality of source IP addresses.

### 1.7 Advantageous Effects of First Embodiment

In the present embodiment, when access is made from different IP addresses using the same device ID in a certain period of time, whether each of a plurality of communications is anonymous communication or non-anonymous communication is identified. By collectively taking into consideration the number and combinations of anonymous communications and non-anonymous communications, country names and city names associated with source IP addresses, the home appliance type, and the home appliance state, it becomes possible to recognize that, even in cases that would normally be erroneously detected as impersonation of a device ID, an IP address of a legitimate home appliance has changed in a normal use case, thereby making it possible to minimize false detections.

### Second Embodiment

In the first embodiment of the present disclosure, all home appliances accessing via the Internet 10 are individually handled.

Here, as a second embodiment of the present disclosure, a configuration in which the detection accuracy of impersonation can be further increased by grouping home appliances accessing via the Internet 10 in units of houses and making a judgment based on comparison of states with other home appliances located in the same house will be described.

### 2. Details of Second Embodiment

Here, an unauthorized communication detection system 2 in the present disclosure will be described hereinafter as the second embodiment of the present disclosure with reference to the drawings. Components having the same functions as in the first embodiment of the present disclosure are given the same reference numerals, and detailed description thereof is omitted.

### 2.1 Overall Configuration of Unauthorized Communication Detection System 2

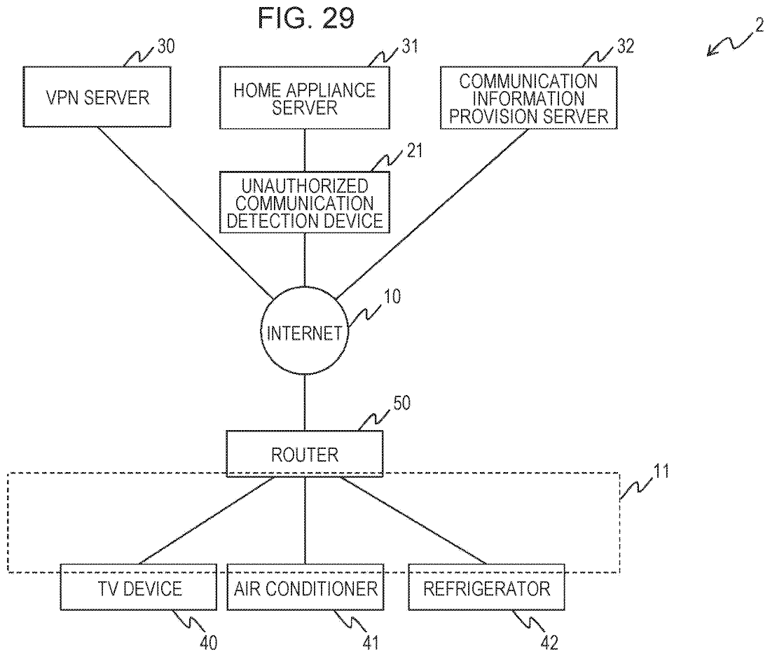

FIG. 29 is a diagram illustrating network configuration of the unauthorized communication detection system 2 in the present disclosure. The unauthorized communication detection system 2 includes the Internet 10, a home network 11, an unauthorized communication detection device 21, a VPN server 30, a home appliance server 31, a communication information provision server 32, a TV device 40, an air conditioner 41, a refrigerator 42, and a router 50. The second embodiment is different from the first embodiment of the present disclosure in that the home network 11 including the home appliances is illustrated in detail.

The router 50 is provided at a boundary between the home network 11 and the Internet 10. The TV device 40, the air conditioner 41, and the refrigerator 42 are home appliances having a network function, and are connected to the home appliance server 31 via the home network 11 and the Internet 10.

The TV device 40, the air conditioner 41, and the refrigerator 42 hold device IDs “TV1”, “AC1”, and “FR1”, respectively, in storages thereof, and communicate with the home appliance server 31 while including the device IDs thereof in communication data.

The TV device 40, the air conditioner 41, and the refrigerator 42 are located in the same house, and coordinate information obtained thereby using a global positioning system (GPS) function or the like has the same values.

Although the unauthorized communication detection system 2 includes the TV device 40, the air conditioner 41, and the refrigerator 42 as the home appliances connected to the home network 11 in the present embodiment, other home appliances may be included, instead.

### 2.2 Configuration of Unauthorized Communication Detection Device 21

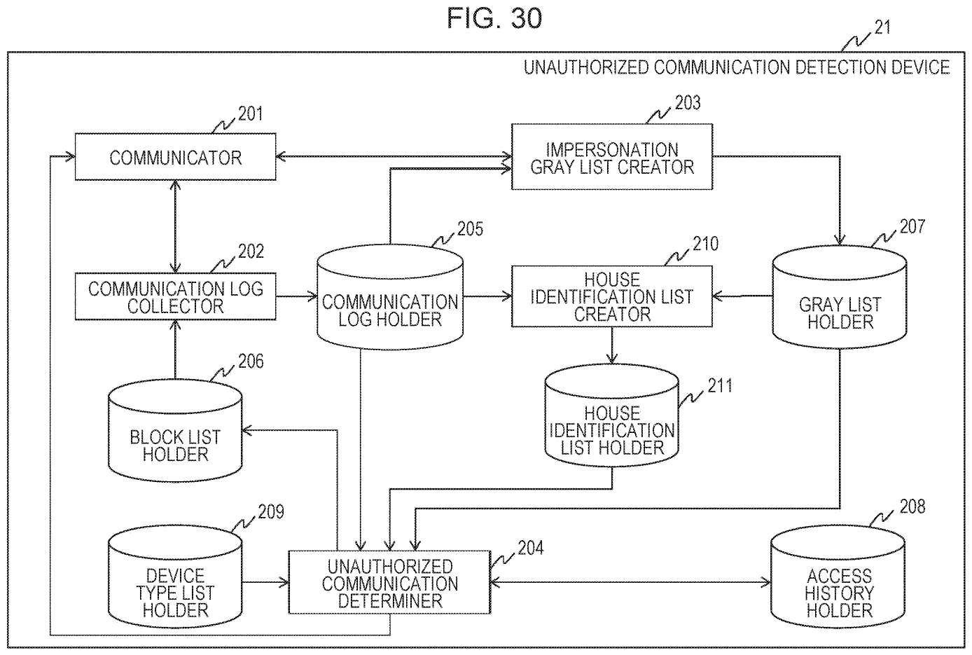

FIG. 30 is a block diagram illustrating configuration of the unauthorized communication detection device 21. Components having the same functions as in the first embodiment are given the same reference numerals, and detailed description thereof is omitted.

The unauthorized communication detection device 21 includes a communicator 201, a communication log collector 202, an impersonation gray list creator 203, an unauthorized communication determiner 204, a communication log holder 205, a block list holder 206, a gray list holder 207, an access history holder 208, a device type list holder 209, a house identification list creator 210, and a house identification list holder 211.

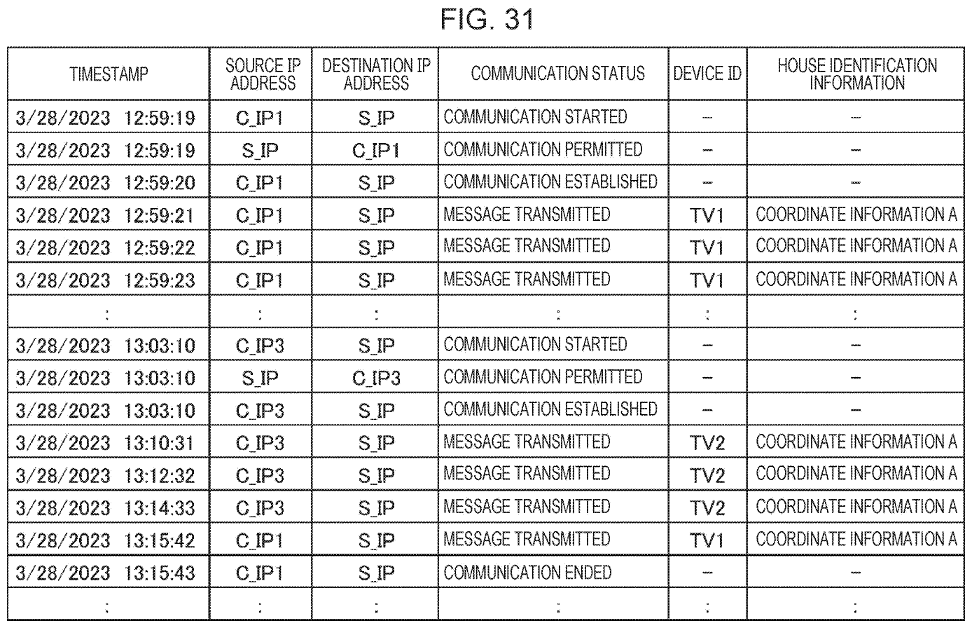

The communication log holder 205 holds a log of all packets received by the communicator 201. FIG. 31 is a diagram illustrating an example of a communication log. The communication log is basically the same as that in the first embodiment illustrated in FIG. 4, but coordinate information obtained by source home appliances using the GPS or the like is also stored as house identification information.

The communication log of FIG. 31 is an example, and the house identification information may include information other than coordinate information. For example, the information may be input and set by a user for home appliances, or information indicating features of a house may be obtained by source home appliances from other devices connected to the same home network using a protocol such as ECHONET Lite (registered trademark) and stored as house identification information.

Specific examples of the obtaining of the information indicating features of a house include, for example, obtaining of a cumulative amount of generated power from a fuel cell (not illustrated), obtaining of a cumulative amount of power from a power meter (not illustrated), obtaining of cumulative water flow volume from a water flow meter (not illustrated), and obtaining of cumulative gas consumption from a gas meter (not illustrated). Home appliances with the same amount of use in the same time period can be determined as being located in the same house.

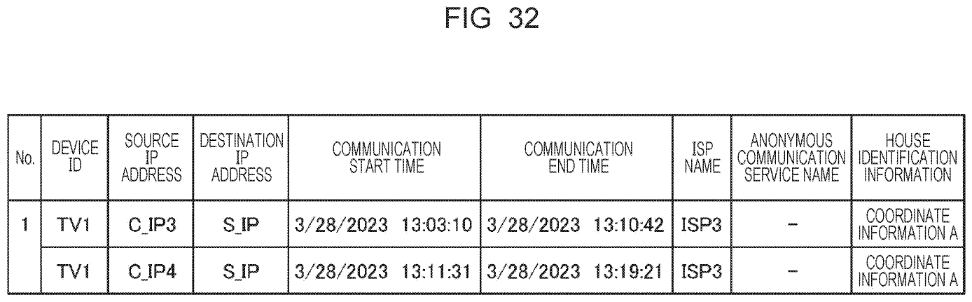

The gray list holder 207 holds an impersonation gray list obtained by compiling a device ID and communication information regarding communications from a plurality of source IP addresses into a list. FIG. 32 is a diagram illustrating an example of the impersonation gray list. The impersonation gray list is basically the same as that in the first embodiment illustrated in FIG. 6, but the house identification information is also stored.

The house identification list creator 210 creates a house identification list by reading the impersonation gray list from the gray list holder 207, reading a communication log from the communication log holder 205 using the house identification information stored in records as a key, and extracting entries of the communication log from home appliances with the same house identification information in the same time period, and saves the house identification list to the house identification list holder 211.

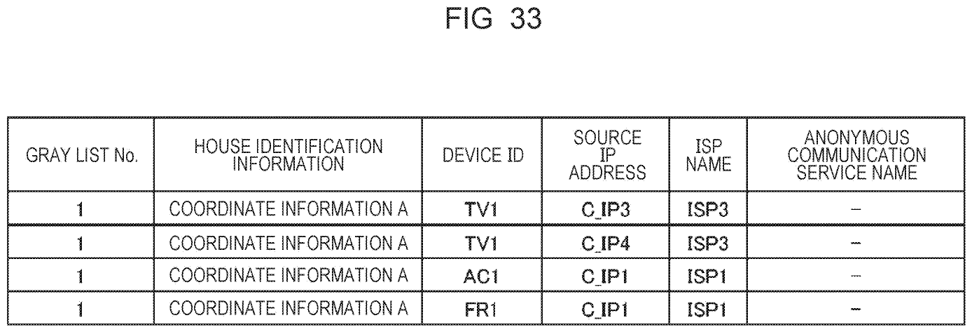

The house identification list holder 211 holds a house identification list with which home appliances can be identified in units of houses. FIG. 33 is a diagram illustrating an example of the house identification list. The house identification list of FIG. 33 stores gray list numbers associated with record numbers of the gray list, house identification information, device IDs, source IP addresses, ISP names, and anonymous communication service names.

Operation of the unauthorized communication detection device 21 and the unauthorized communication detection system 2 configured as above will be described hereinafter.

### 2.3 Operation of Unauthorized Communication Detection System 2

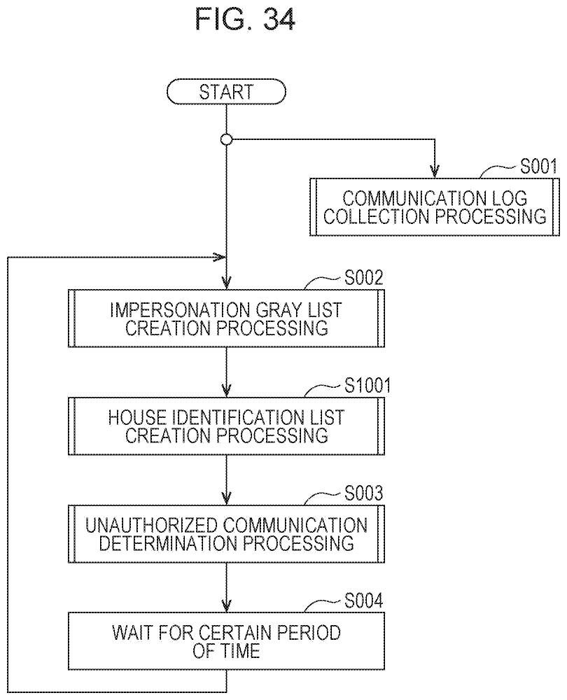

FIG. 34 is a flowchart illustrating the operation of the unauthorized communication detection system 2 according to the present embodiment. The operation of the unauthorized communication detection system 2 includes communication log collection processing, impersonation gray list creation processing, house identification list creation processing, and unauthorized communication determination processing.

First, the communication log collection processing starts as the unauthorized communication detection device 21 is activated (step S001). This processing is performed asynchronously from subsequent processing, and continues until the unauthorized communication detection device 21 is stopped (shut down).

Next, the unauthorized communication detection device 21 performs the impersonation gray list creation processing (step S002). The unauthorized communication detection device 21 then performs the house identification list creation processing (step S1001) and the unauthorized communication determination processing (step S003). The unauthorized communication detection device 21 waits for a certain period of time (step S004), and returns to step S002. That is, the processing in steps S002 to S004 is repeated at certain time intervals until the unauthorized communication detection device 21 is stopped (shut down).

### 2.3.1 Operation During House Identification List Creation Processing

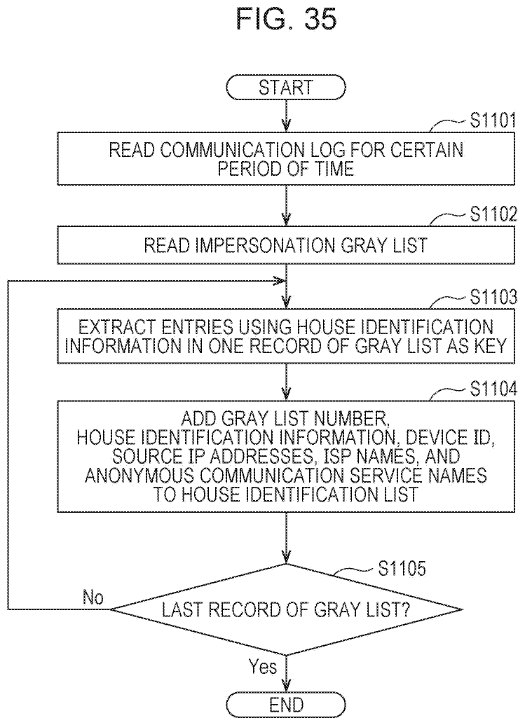

FIG. 35 is a flowchart illustrating an example of the house identification list creation processing performed by the unauthorized communication detection system 2.

In step S1101, the house identification list creator 210 reads a communication log for a certain period of time from the communication log holder 205 at certain time intervals.

In step S1102, the house identification list creator 210 reads the impersonation gray list from the gray list holder 207.

In step S1103, the house identification list creator 210 extracts, from the communication log read in step S1101, entries using house identification information in one record of the gray list as a key.

In step S1104, the house identification list creator 210 adds, to the house identification list held by the house identification list holder 211, a record number of the currently read record of the impersonation gray list, house identification information extracted from the extracted entries, a device ID, source IP addresses, ISP names, and anonymous communication service names.

In step S1105, the house identification list creator 210 then checks whether the read record of the impersonation gray list is a last record, and if not (NO in S1105), returns to step S1103. If the read record is the last record (YES in S1105), the house identification list creator 210 ends the processing.

### 2.3.2 Operation During Unauthorized Communication Determination Processing

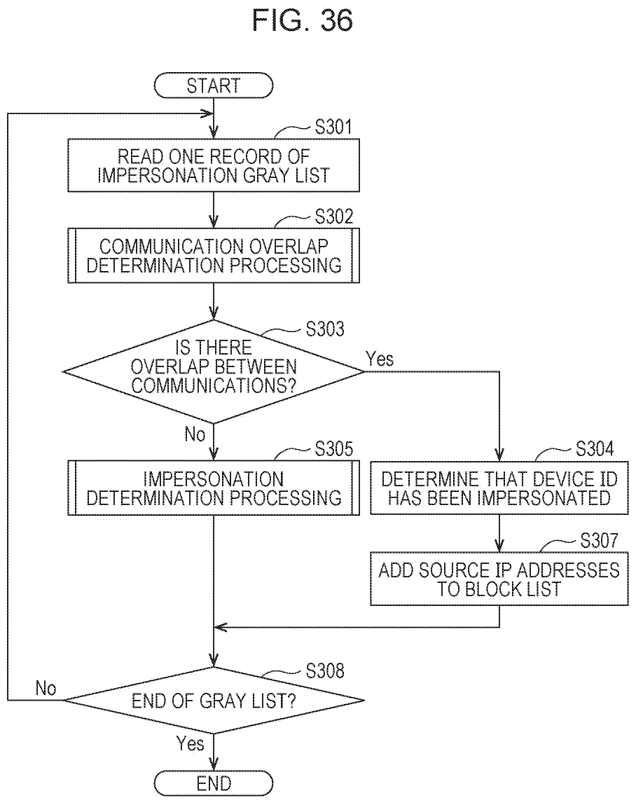

FIG. 36 is a flowchart illustrating an example of the unauthorized communication determination processing (step S003) according to the second embodiment. This processing is substantially the same as the processing of FIG. 12 according to the first embodiment, but in the second embodiment, operation during the impersonation determination processing in step S305 is different.

The difference is that the check of the impersonation determination result in step S306 of FIG. 12 is unnecessary and omitted because processing for adding source IP addresses to the block list is also performed in the impersonation determination processing, details of which will be described later.

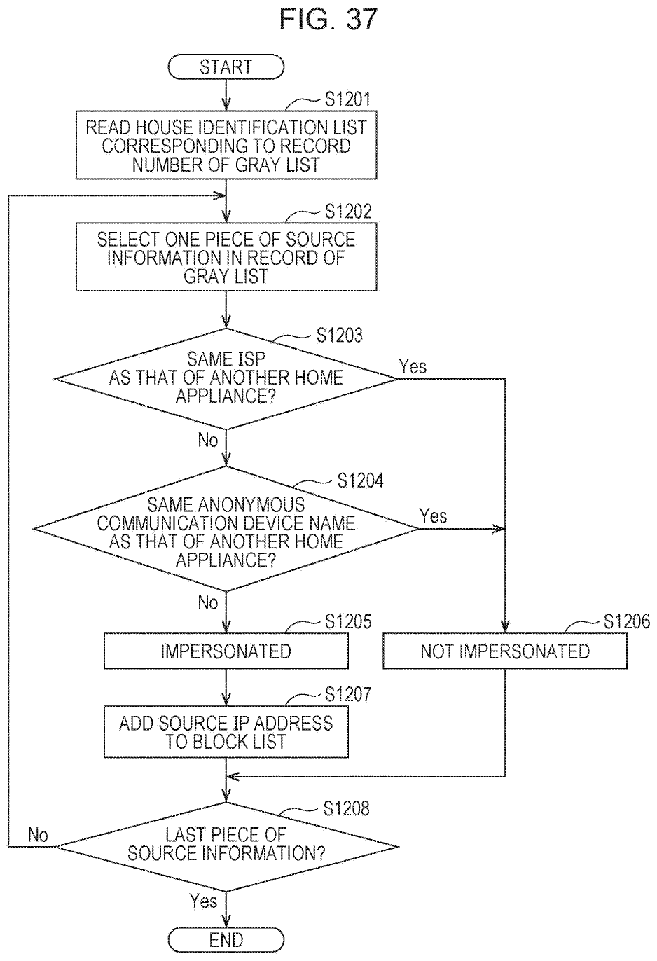

FIG. 37 is a flowchart illustrating an example of the impersonation determination processing (S305) performed by the unauthorized communication detection system 2.

In step S1201 of FIG. 37, the unauthorized communication determiner 204 reads, from the house identification list holder 211, a house identification list including the record number of the impersonation gray list read in S301. Next, in step S1202, the unauthorized communication determiner 204 selects one of a plurality of pieces of source information included in the record of the impersonation gray list read in step S301. In step S1203, the unauthorized communication determiner 204 identifies whether an ISP included in the selected piece of source information is the same as an ISP of another home appliance in the house identification list read in step S1201.

If the ISP is the same as that of another home appliance (YES in S1203), the unauthorized communication determiner 204 judges that a source IP address of the selected piece of source information does not involve impersonation (S1206), and checks whether the selected piece of source information is a last piece of source information in the record (step S1208).

If the selected piece of source information is the last piece of source information (YES in S1208), the unauthorized communication determiner 204 ends the processing. If the selected piece of source information is not the last piece of source information (NO in S1208), the unauthorized communication determiner 204 returns to step S1202.

If the ISP is not the same as that of another home appliance (NO in S1203), the unauthorized communication determiner 204 identifies, in step S1204, whether the home appliance is using the same anonymous communication service as the other home appliance. If the home appliance is using the same anonymous communication service as the other home appliance (YES in S1204), the unauthorized communication determiner 204 judges that the source IP address of the selected piece of source information does not involve impersonation (step S1206), and checks whether the selected piece of source information is the last piece of source information in the record (step S1208). If the selected piece of source information is the last piece of source information (YES in S1208), the unauthorized communication determiner 204 ends the processing. If the selected piece of source information is not the last piece of source information (NO in S1208), the unauthorized communication determiner 204 returns to step S1202.

If the home appliance is not using the same anonymous communication service as the other home appliance (NO in S1204), the unauthorized communication determiner 204 judges, in step S1205, that impersonation is involved, and adds a combination of the source IP address and a destination IP address of the piece of source information to the block list (step S1207).

The unauthorized communication determiner 204 then checks whether the piece of source information is the last piece of source information in the record (S1208). If the selected piece of source information is the last piece of source information (YES in S1208), the unauthorized communication determiner 204 ends the processing. If the selected piece of source information is not the last piece of source information (NO in S1208), the unauthorized communication determiner 204 returns to step S1202.

### 2.3.3 Specific Examples of Unauthorized Communication Determination Processing

FIGS. 32, 38, 40, 42, and 44 are diagrams illustrating first to fifth examples, respectively, of the impersonation gray list according to the second embodiment. FIGS. 33, 39, 41, 43, and 45 are diagrams illustrating first to fifth examples, respectively, of the house identification list according to the second embodiment.

Processing performed by the unauthorized communication determiner 204 will be specifically described hereinafter with reference to FIGS. 32 to 45.

First, a first specific example will be described with reference to FIGS. 32, 33, 36, and 37.

After reading a record of gray list No. 1 of the impersonation gray list of FIG. 32 in step S301 of the unauthorized communication determination processing in FIG. 36, the unauthorized communication determiner 204 makes the communication overlap determination (S302). This determination processing is the same as in the first embodiment, description of a detailed procedure thereof is omitted.

The unauthorized communication determiner 204 checks the communication overlap determination result and, since there is no overlap between communications (NO in S303), proceeds to the impersonation determination processing (S305).

In step S1201 of FIG. 37, the unauthorized communication determiner 204 reads entries of the house identification list associated with the read record of gray list No. 1 from the house identification list holder 211.

Specifically, as illustrated in FIG. 33, the unauthorized communication determiner 204 extracts entries of the list storing “1” as the gray list number. Since the house identification list of FIG. 33 is obtained by extracting, from among entries of the communication log indicating access in the same time period, entries storing “coordinate information A” as the house identification information, the house identification list of FIG. 33 also includes entries of the communication log corresponding to two source home appliances described in the impersonation gray list of FIG. 32. That is, one or both of home appliances indicated by the device ID “TV1” in FIG. 33 is an impersonated illegitimate home appliance, and “AC1” and “FR1” other than the two “TV1” entries are information indicating other home appliances located in the same house.

In step S1202, the unauthorized communication determiner 204 selects a first piece of source information of record No. 1 of the gray list, and compares ISP information included in the first piece of source information and ISP information in FIG. 33 regarding the other home appliances located in the same house.

Since “ISP3” in the gray list and “ISP1” of the other home appliances are different from each other (NO in S1203), the unauthorized communication determiner 204 proceeds to step S1204, and identifies whether the home appliance is using the same anonymous communication service as the other home appliances. Specifically, the unauthorized communication determiner 204 compares the anonymous communication service name “-” included in the first piece of source information of record No. 1 of the gray list and the anonymous communication service name “-” of the other home appliances located in the same house in FIG. 33. In this case, since none of the home appliances is using any anonymous communication service, the unauthorized communication determiner 204 determines that the home appliance is not using the same anonymous communication service (NO in S1204).

This condition indicates that ISPs are different from each other without using any anonymous communication service, that is, IP addresses of home routers are different from each other, and the unauthorized communication determiner 204 judges that the home appliance indicated by the first piece of source information of record No. 1 of the gray list is located in a different house, that is, impersonation is involved (step S1205), and adds C_IP3/S_IP, which is a combination of a source IP address and a destination IP address, to the block list (step S1207). Since the first piece of source information is not a last piece of source information of record No. 1 of the gray list (NO in S1208), the unauthorized communication determiner 204 returns to step S1202.

In step S1202, the unauthorized communication determiner 204 selects a second piece of source information of record No. 1 of the gray list, and compares ISP information included in the second piece of source information and ISP information in FIG. 33 regarding the other home appliances located in the same house. Since “ISP3” in the gray list and “ISP1” of the other home appliances are different from each other (NO in S1203), the unauthorized communication determiner 204 proceeds to step S1204, and identifies whether the home appliance is using the same anonymous communication service as the other home appliances.

Specifically, the unauthorized communication determiner 204 compares the anonymous communication service name “-” included in the second piece of source information of record No. 1 of the gray list and the anonymous communication service name “-” of the other home appliances located in the same house in FIG. 33. In this case, since none of the home appliances is using any anonymous communication service, the unauthorized communication determiner 204 determines that the home appliance is not using the same anonymous communication service (NO in S1204).

This condition indicates that ISPs are different from each other without using any anonymous communication service, that is, IP addresses of home routers are different from each other, and the unauthorized communication determiner 204 judges that the second source home appliance of record No. 1 of the gray list involves impersonation (step S1205), and adds C_IP4/S_IP, which is a combination of a source IP address and a destination IP address, to the block list (step S1207). Since the second piece of source information is the last piece of source information of record No. 1 of the gray list (YES in S1208), the unauthorized communication determiner 204 ends the processing.

The first specific example is a record that would be judged in the first embodiment as not involving impersonation, but in the second embodiment, where the detection accuracy of impersonation is increased by making a judgment based on comparison of states with other home appliances located in the same house, it can be judged that impersonation is involved.

Next, a second specific example will be described with reference to FIGS. 36, 37, 38, and 39.

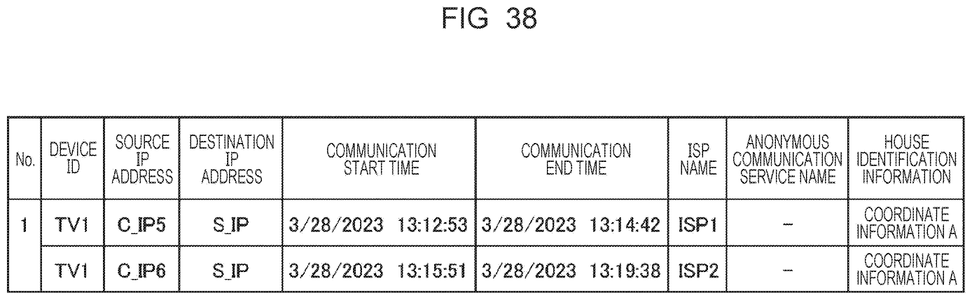

After reading a record of impersonation gray list No. 1 of FIG. 38 in step S301 of the unauthorized communication determination processing in FIG. 36, the unauthorized communication determiner 204 makes the communication overlap determination (S302). This determination processing is the same as in the first embodiment, description of a detailed procedure thereof is omitted.

In S303, the unauthorized communication determiner 204 checks the communication overlap determination result and, since there is no overlap between communications (NO in S303), proceeds to the impersonation determination processing (S305).

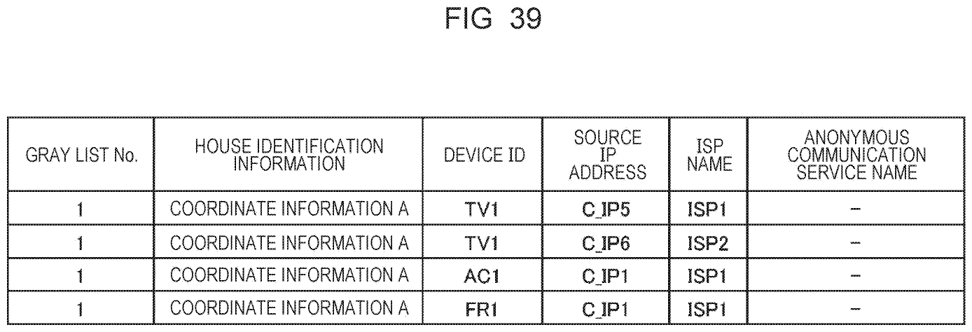

In step S1201 of FIG. 37, the unauthorized communication determiner 204 reads entries of the house identification list associated with the read record of gray list No. 1 of the gray list from the house identification list holder 211. Specifically, as illustrated in FIG. 39, the unauthorized communication determiner 204 extracts entries of the list storing “1” as the gray list number. Since the house identification list of FIG. 39 is obtained by extracting, from among entries of the communication log indicating access in the same time period, entries storing “coordinate information A” as the house identification information, the house identification list of FIG. 39 also includes entries of the communication log corresponding to two source home appliances described in the impersonation gray list of FIG. 38. That is, one or both of home appliances indicated by the device ID “TV1” in FIG. 39 is an impersonated illegitimate home appliance, and “AC1” and “FR1” other than the two “TV1” entries are information indicating other home appliances located in the same house.

In step S1202, the unauthorized communication determiner 204 selects a first piece of source information of record No. 1 of the gray list, and compares ISP information included in the first piece of source information and ISP information in FIG. 39 regarding the other home appliances located in the same house. Since “ISP1” in the gray list and “ISP1” of the other home appliances are the same (YES in S1203), the unauthorized communication determiner 204 judges that the first source home appliance of record No. 1 of the gray list is located in the same house as the other home appliance, that is, impersonation is not involved (step S1206), and proceeds to step S1208. Since the first piece of source information is not a last piece of source information of record No. 1 of the gray list (NO in S1208), the unauthorized communication determiner 204 returns to step S1202.

In step S1202, the unauthorized communication determiner 204 selects a second piece of source information of record No. 1 of the gray list, and compares ISP information included in the second piece of source information and ISP information in FIG. 39 regarding the other home appliances located in the same house. Since “ISP2” in the gray list and “ISP1” of the other home appliances are different from each other (NO in S1203), the unauthorized communication determiner 204 proceeds to step S1204, and identifies whether the home appliance is using the same anonymous communication service as the other home appliances.

Specifically, the unauthorized communication determiner 204 compares the anonymous communication service name “-” included in the second piece of source information of record No. 1 of the gray list and the anonymous communication service name “-” of the other home appliances located in the same house in FIG. 39. In this case, since none of the home appliances is using any anonymous communication service, the unauthorized communication determiner 204 determines that the home appliance is not using the same anonymous communication service (NO in S1204).

This condition indicates that ISPs are different from each other without using any anonymous communication service, that is, IP addresses of home routers are different from each other, and the unauthorized communication determiner 204 judges that the second source home appliance of record No. 1 of the gray list involves impersonation (step S1205), and adds C_IP6/S_IP, which is a combination of a source IP address and a destination IP address, to the block list (step S1207). Since the second piece of source information is the last piece of source information of record No. 1 of the gray list (YES in S1208), the unauthorized communication determiner 204 ends the processing.

The second specific example is a record that would be judged in the first embodiment as involving impersonation, and the source IP addresses of both C_IP5 and C_IP6 are added to the block list. In the second embodiment, where the detection accuracy of impersonation is increased by making a judgment based on comparison of states with other home appliances located in the same house, it can be judged that only C_IP6 involves impersonation, and a risk of blocking C_IP5 can be reduced.

Next, a third specific example will be described with reference to FIGS. 36, 37, 40, and 41.

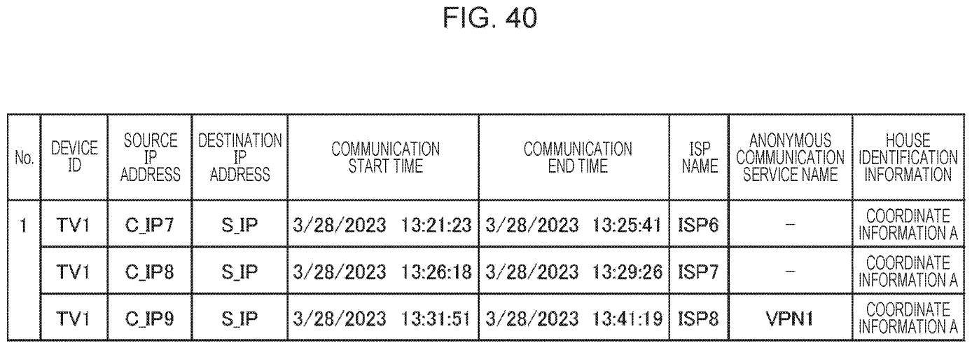

After reading a record of impersonation gray list No. 1 of FIG. 40 in step S301 of the unauthorized communication determination processing in FIG. 36, the unauthorized communication determiner 204 makes the communication overlap determination (S302). This determination processing is the same as in the first embodiment, description of a detailed procedure thereof is omitted.

In S303, the unauthorized communication determiner 204 checks the communication overlap determination result and, since there is no overlap between communications (NO in S303), proceeds to the impersonation determination processing (S305).

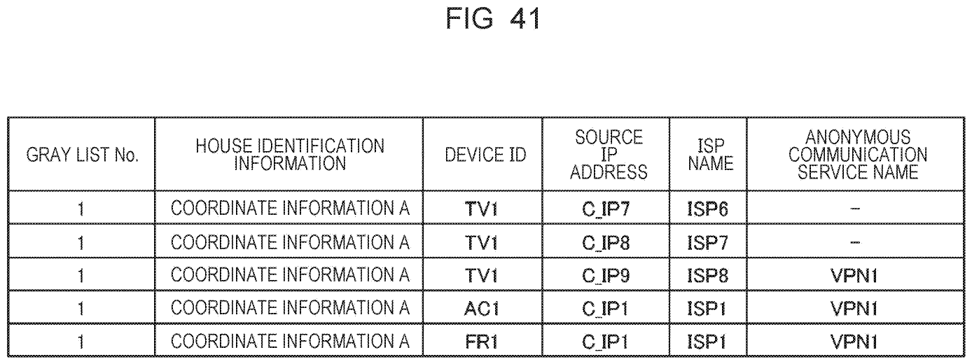

In step S1201 of FIG. 37, the unauthorized communication determiner 204 reads entries of the house identification list associated with the read record of gray list No. 1 of the gray list from the house identification list holder 211. Specifically, as illustrated in FIG. 41, the unauthorized communication determiner 204 extracts entries of the list storing “1” as the gray list number. Since the house identification list of FIG. 41 is obtained by extracting, from among entries of the communication log indicating access in the same time period, entries storing “coordinate information A” as the house identification information, the house identification list of FIG. 40 also includes entries of the communication log corresponding to three source home appliances described in the impersonation gray list of FIG. 40. That is, a subset or all of home appliances indicated by the device ID “TV1” in FIG. 41 is an impersonated illegitimate home appliance, and “AC1” and “FR1” other than the three “TV1” entries are information indicating other home appliances located in the same house.

In step S1202, the unauthorized communication determiner 204 selects a first piece of source information of record No. 1 of the gray list, and compares ISP information included in the first piece of source information and ISP information in FIG. 41 regarding the other home appliances located in the same house. Since “ISP6” in the gray list and “ISP1” of the other home appliances are different from each other (NO in S1203), the unauthorized communication determiner 204 proceeds to step S1204, and identifies whether the home appliance is using the same anonymous communication service as the other home appliances.

Specifically, the unauthorized communication determiner 204 compares the anonymous communication service name “-” included in the second piece of source information of record No. 1 of the gray list and the anonymous communication service name “VPN1” of the other home appliances located in the same house in FIG. 41. In this case, the unauthorized communication determiner 204 determines that the home appliance is not using the same anonymous communication service (NO in S1204).

This condition indicates that the other home appliances are using the anonymous communication service “VPN1”, that is, “VPN1” is set in a home router, and the unauthorized communication determiner 204 judges that the first source home appliance of record No. 1 of the gray list is located in a house different from one in which the other home appliances are located, that is, impersonation is involved (step S1205), and adds C_IP7/S_IP, which is a combination of a source IP address and a destination IP address, to the block list (step S1207). Since the first piece of source information is not a last piece of source information of record No. 1 of the gray list (No in S1208), the unauthorized communication determiner 204 returns to step S1202.

In step S1202, the unauthorized communication determiner 204 selects a second piece of source information of record No. 1 of the gray list, and compares ISP information included in the second piece of source information and ISP information in FIG. 41 regarding the other home appliances located in the same house. Since “ISP7” in the gray list and “ISP1” of the other home appliances are different from each other (NO in S1203), the unauthorized communication determiner 204 proceeds to step S1204, and identifies whether the home appliance is using the same anonymous communication service as the other home appliances.

Specifically, the unauthorized communication determiner 204 compares the anonymous communication service name “-” included in the second piece of source information of record No. 1 of the gray list and the anonymous communication service name “VPN1” of the other home appliances located in the same house in FIG. 41. In this case, the unauthorized communication determiner 204 determines that the home appliance is not using the same anonymous communication service (NO in S1204).

This condition indicates that the other home appliances are using the anonymous communication service “VPN1”, that is, “VPN1” is set in the home router, and the unauthorized communication determiner 204 judges that the second source home appliance of record No. 1 of the gray list is located in a different house, that is, impersonation is involved (step S1205), and adds C_IP8/S_IP, which is a combination of a source IP address and a destination IP address, to the block list (step S1207).

Since the second piece of source information is not the last piece of source information of record No. 1 of the gray list (NO in S1208), the unauthorized communication determiner 204 returns to step S1202.

In step S1202, the unauthorized communication determiner 204 selects a third piece of source information of record No. 1 of the gray list, and compares ISP information included in the third piece of source information and ISP information in FIG. 41 regarding the other home appliances located in the same house. Since “ISP8” in the gray list and “ISP1” of the other home appliances are different from each other (NO in S1203), the unauthorized communication determiner 204 proceeds to step S1204, and identifies whether the home appliance is using the same anonymous communication service as the other home appliances.

Specifically, the unauthorized communication determiner 204 compares the anonymous communication service name “VPN1” included in the third piece of source information of record No. 1 of the gray list and the anonymous communication service name “VPN1” of the other home appliances located in the same house in FIG. 41. In this case, the unauthorized communication determiner 204 determines that the home appliance is using the same anonymous communication service (YES in S1204).

This condition indicates that the other home appliances are using the anonymous communication service “VPN1”, that is, “VPN1” is set in the home router. Although a source IP address and an ISP of the third piece of source information of record No. 1 of the gray list are different, it is possible that the user had changed the VPN server before the home appliance performed communication, and the home appliance is likely to be located in the same house. The unauthorized communication determiner 204, therefore, judges that impersonation is not involved (step S1206), and proceeds to step S1208. Since the third piece of source information is the last piece of source information of record No. 1 of the gray list (YES in S1208), the unauthorized communication determiner 204 ends the processing.

The third specific example is a record that would be judged in the first embodiment as involving impersonation, and the source IP addresses of all of C_IP7, C_IP8, and C_IP9 are added to the block list. In the second embodiment, where the detection accuracy of impersonation is increased by making a judgment based on comparison of states with other home appliances located in the same house, it can be judged that only C_IP7 and C_IP8 involve impersonation, and a risk of blocking C_IP9 can be reduced.

Next, a fourth specific example will be described with reference to FIGS. 36, 37, 42, and 43.

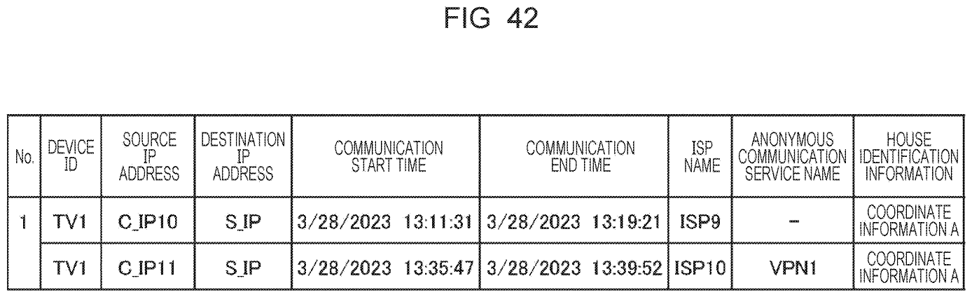

After reading a record of impersonation gray list No. 1 of FIG. 42 in step S301 of the unauthorized communication determination processing in FIG. 36, the unauthorized communication determiner 204 makes the communication overlap determination (S302). This determination processing is the same as in the first embodiment, description of a detailed procedure thereof is omitted.

In S303, the unauthorized communication determiner 204 checks the communication overlap determination result and, since there is no overlap between communications (NO in S303), proceeds to the impersonation determination processing (S305).

In step S1201 of FIG. 37, the unauthorized communication determiner 204 reads entries of the house identification list associated with the read record of gray list No. 1 of the gray list from the house identification list holder 211.

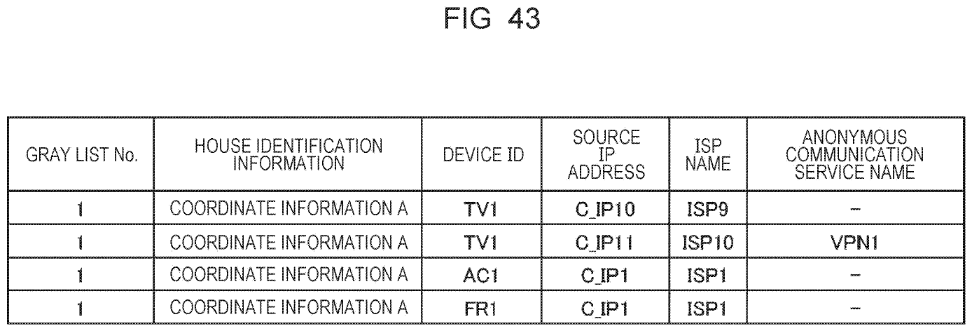

Specifically, as illustrated in FIG. 43, the unauthorized communication determiner 204 extracts entries of the list storing “1” as the gray list number. Since the house identification list of FIG. 43 is obtained by extracting, from among entries of the communication log indicating access in the same time period, entries storing “coordinate information A” as the house identification information, the house identification list of FIG. 43 also includes entries of the communication log corresponding to two source home appliances described in the impersonation gray list of FIG. 42. That is, one or both of home appliances indicated by the device ID “TV1” in FIG. 43 is an impersonated illegitimate home appliance, and “AC1” and “FR1” other than the three “TV1” entries are information indicating other home appliances located in the same house.

In step S1202, the unauthorized communication determiner 204 selects a first piece of source information of record No. 1 of the gray list, and compares ISP information included in the first piece of source information and ISP information in FIG. 43 regarding the other home appliances located in the same house. Since “ISP9” in the gray list and “ISP1” of the other home appliances are different from each other (NO in S1203), the unauthorized communication determiner 204 proceeds to step S1204, and identifies whether the home appliance is using the same anonymous communication service as the other home appliances.

Specifically, the unauthorized communication determiner 204 compares the anonymous communication service name “-” included in the second piece of source information of record No. 1 of the gray list and the anonymous communication service name “-” of the other home appliances located in the same house in FIG. 43. In this case, since none of the home appliances is using any anonymous communication service, the unauthorized communication determiner 204 determines that the home appliance is not using the same anonymous communication service (NO in S1204).

This condition indicates that ISPs are different from each other without using any anonymous communication service, that is, IP addresses of home routers are different from each other, and the unauthorized communication determiner 204 judges that the second source home appliance of record No. 1 of the gray list involves impersonation (step S1205), and adds C_IP10/S_IP, which is a combination of a source IP address and a destination IP address, to the block list (step S1207).

Since the first piece of source information is not a last piece of source information of record No. 1 of the gray list (NO in S1208), the unauthorized communication determiner 204 returns to step S1202.

In step S1202, the unauthorized communication determiner 204 selects a second piece of source information of record No. 1 of the gray list, and compares ISP information included in the second piece of source information and ISP information in FIG. 43 regarding the other home appliances located in the same house. Since “ISP10” in the gray list and “ISP1” of the other home appliances are different from each other (NO in S1203), the unauthorized communication determiner 204 proceeds to step S1204, and identifies whether the home appliance is using the same anonymous communication service as the other home appliances.

Specifically, the unauthorized communication determiner 204 compares the anonymous communication service name “VPN1” included in the second piece of source information of record No. 1 of the gray list and the anonymous communication service name “VPN1” of the other home appliances located in the same house in FIG. 43.

In this case, the unauthorized communication determiner 204 determines that the home appliance is using the same anonymous communication service (YES in S1204). This condition indicates that the other home appliances are using the anonymous communication service “VPN1”, that is, “VPN1” is set in the home router. Although a source IP address and an ISP of the second piece of source information of record No. 1 of the gray list are different, it is possible that the user had changed the VPN server before the home appliance performed communication, and the home appliance is likely to be located in the same house. The unauthorized communication determiner 204 judges that impersonation is not involved (step S1206), and proceeds to step S1208. Since the second piece of source information is the last piece of source information of record No. 1 of the gray list (YES in S1208), the unauthorized communication determiner 204 ends the processing.

The fourth specific example is a record that would be judged in the first embodiment as not involving impersonation, but in the second embodiment, where the detection accuracy of impersonation is increased by making a judgment based on comparison of states with other home appliances located in the same house, it can be judged that only C_IP10 involves impersonation.

Lastly, a fifth specific example will be described with reference to FIGS. 36, 37, 44, and 45.

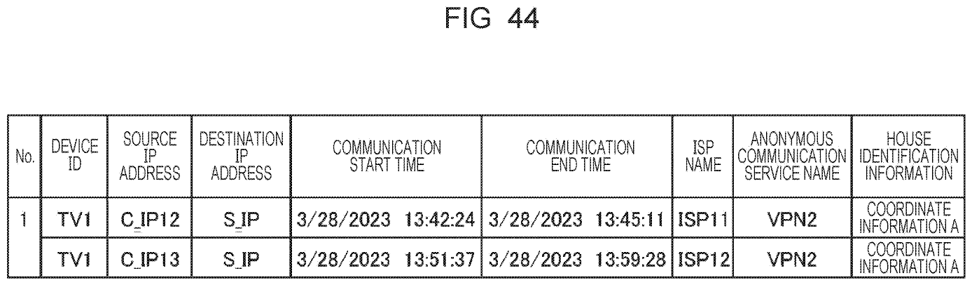

After reading a record of impersonation gray list No. 1 of FIG. 44 in step S301 of the unauthorized communication determination processing in FIG. 36, the unauthorized communication determiner 204 makes the communication overlap determination (S302). This determination processing is the same as in the first embodiment, description of a detailed procedure thereof is omitted.

In S303, the unauthorized communication determiner 204 checks the communication overlap determination result and, since there is no overlap between communications (NO in S303), proceeds to the impersonation determination processing (S305).

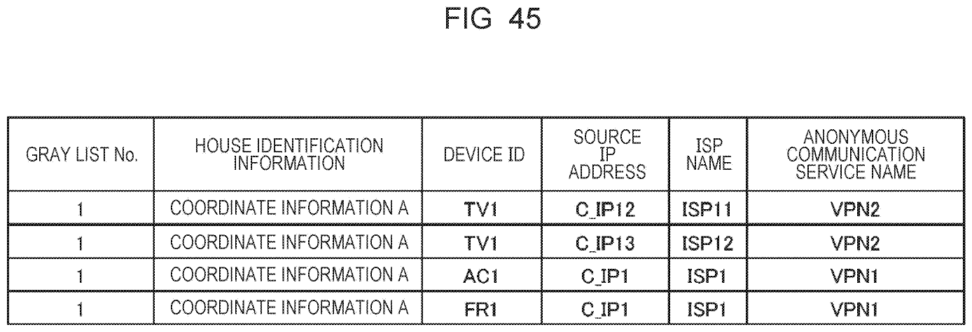

In step S1201 of FIG. 37, the unauthorized communication determiner 204 reads entries of the house identification list associated with the read record of gray list No. 1 of the gray list from the house identification list holder 211. Specifically, as illustrated in FIG. 45, the unauthorized communication determiner 204 extracts entries of the list storing “1” as the gray list number.

Since the house identification list of FIG. 45 is obtained by extracting, from among entries of the communication log indicating access in the same time period, entries storing “coordinate information A” as the house identification information, the house identification list of FIG. 45 also includes entries of the communication log corresponding to two source home appliances described in the impersonation gray list of FIG. 44. That is, one or both of home appliances indicated by the device ID “TV1” in FIG. 45 is an impersonated illegitimate home appliance, and “AC1” and “FR1” other than the three “TV1” entries are information indicating other home appliances located in the same house.

In step S1202, the unauthorized communication determiner 204 selects a first piece of source information of record No. 1 of the gray list, and compares ISP information included in the first piece of source information and ISP information in FIG. 45 regarding the other home appliances located in the same house. Since “ISP11” in the gray list and “ISP1” of the other home appliances are different from each other (NO in S1203), the unauthorized communication determiner 204 proceeds to step S1204, and identifies whether the home appliance is using the same anonymous communication service as the other home appliances.

Specifically, the unauthorized communication determiner 204 compares the anonymous communication service name “VPN2” included in the first piece of source information of record No. 1 of the gray list and the anonymous communication service name “VPN1” of the other home appliances located in the same house in FIG. 45. In this case, the unauthorized communication determiner 204 determines that the home appliance is not using the same anonymous communication service (NO in S1204).

This condition indicates that the other home appliances are using the anonymous communication service “VPN1”, that is, “VPN1” is set in the home router, and the unauthorized communication determiner 204 judges that the first source home appliance of record No. 1 of the gray list is located in a house different from one in which the other home appliances are located, that is, impersonation is involved (step S1205), and adds C_IP12/S_IP, which is a combination of a source IP address and a destination IP address, to the block list (step S1207). Since the first piece of source information is not a last record of record No. 1 of the gray list (NO in S1208), the unauthorized communication determiner 204 returns to step S1202.

In step S1202, the unauthorized communication determiner 204 selects a second piece of source information of record No. 1 of the gray list, and compares ISP information included in the second piece of source information and ISP information in FIG. 45 regarding the other home appliances located in the same house. Since “ISP12” in the gray list and “ISP1” of the other home appliances are different from each other (NO in S1203), the unauthorized communication determiner 204 proceeds to step S1204, and identifies whether the home appliance is using the same anonymous communication service as the other home appliances.

Specifically, the unauthorized communication determiner 204 compares the anonymous communication service name “VPN2” included in the second piece of source information of record No. 1 of the gray list and the anonymous communication service name “VPN1” of the other home appliances located in the same house in FIG. 45. In this case, the unauthorized communication determiner 204 determines that the home appliance is not using the same anonymous communication service (NO in S1204).

This condition indicates that the other home appliances are using the anonymous communication service “VPN1”, that is, “VPN1” is set in the home router, and the unauthorized communication determiner 204 judges that the second source home appliance of record No. 1 of the gray list is located in a house different from one in which the other home appliances are located, that is, impersonation is involved (step S1205), and adds C_IP13/S_IP, which is a combination of a source IP address and a destination IP address, to the block list (step S1207). Since the second piece of source information is the last record of record No. 1 of the gray list (YES in S1208), the unauthorized communication determiner 204 ends the processing.

The fifth specific example is a record that would be judged in the first embodiment as not involving impersonation, but in the second embodiment, where the detection accuracy of impersonation is increased by making a judgment based on comparison of states with other home appliances located in the same house, it can be judged that both C_IP12 and C_IP13 involve impersonation.

### 3. Other Modification

It is needless to say that the present disclosure is not limited to the embodiments described above, and the present disclosure also includes modes obtained by modifying the embodiments in various ways conceivable by those skilled in the art and modes constructed by combining components from different embodiments, insofar as the scope of the present disclosure is not deviated from. For example, the present disclosure also includes the following modifications.

### First Modification

Although whether access to the home appliance server 31 involves impersonation is judged in the first and second embodiments, a degree of seriousness of impersonation may be represented as a value (score), and whether to block access may be determined in accordance with the score, instead. As a result, access with a low degree of seriousness can be prevented from being blocked, and a risk of erroneous blocking of an authorized user due to false detection can be reduced.

### Second Modification

Although a combination of a source IP address and a destination IP address of access to the home appliance server 31 is added to the block list to block subsequent access if it is judged that the access involves impersonation in the first and second embodiments, the home appliance server 31 or a security operation center (SOC) or the like that is remotely monitoring the home appliance server 31 may just be notified of such a risk, instead.

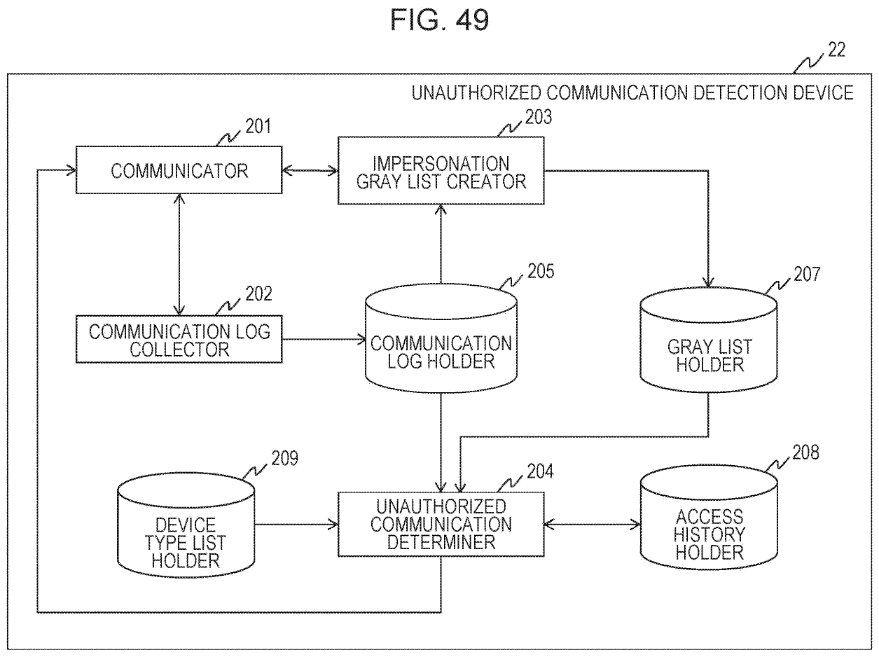

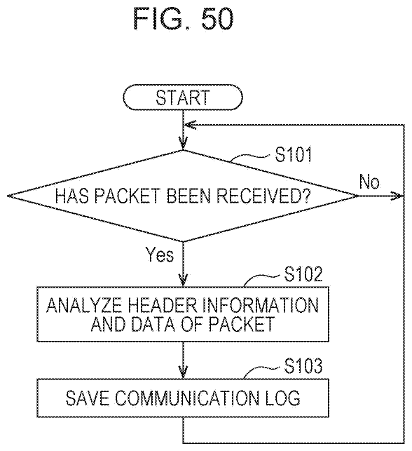

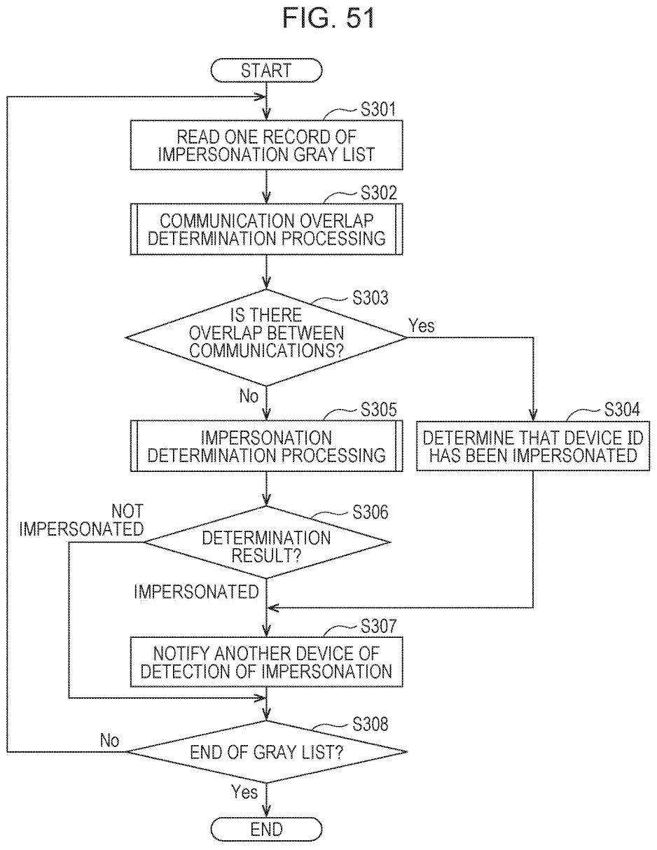

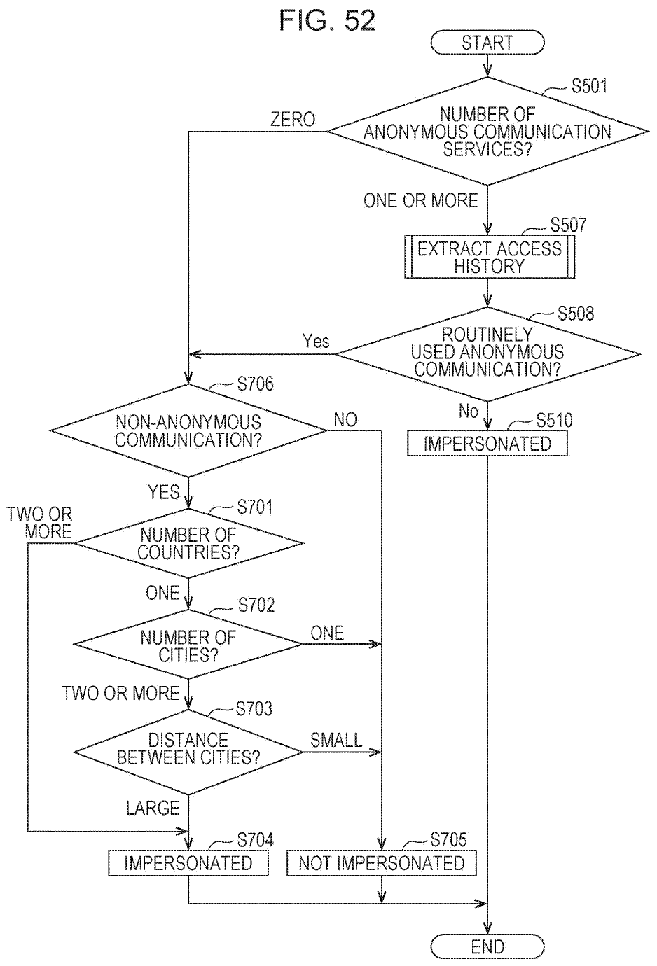

As illustrated in FIG. 49, configuration of an unauthorized communication detection device 22 used in this case can be obtained by omitting the block list holder 206 from the configuration of the unauthorized communication detection device 20 according to the first embodiment of the present disclosure (FIG. 3), and the communication log collection processing and the unauthorized communication determination processing follow flowcharts of FIGS. 50 and 51, respectively. Configuration and processing may also be similarly changed in other embodiments and modifications.

### Third Modification

Although, in the second operation of the impersonation determination processing according to the first embodiment, whether impersonation is involved is judged in accordance with the number of countries, the number of cities, a distance between cities, or the like when the number of anonymous communication services included in a record of the gray list is zero and the number of ISPs is one as illustrated in FIG. 23, the flow to be followed is not limited to this. For example, a flowchart of FIG. 52 may be used, instead.

In step S501 of FIG. 52, the unauthorized communication determiner 204 counts the number of anonymous communication services included in a read record. If the number of anonymous communication services is zero, the unauthorized communication determiner 204 proceeds to step S706, and checks whether the read record includes non-anonymous communication.

If the read record does not include non-anonymous communication, the unauthorized communication determiner 204 judges in step S705 that impersonation is not involved, and ends the processing. If the read record includes non-anonymous communication, the unauthorized communication determiner 204 proceeds to step S701, and counts the number of countries.

If the number of countries is two or more, the unauthorized communication determiner 204 judges in step S704 that impersonation is involved, and ends the processing. If the number of countries is one, the unauthorized communication determiner 204 proceeds to step S702, and counts the number of cities.

If the number of cities is one, the unauthorized communication determiner 204 judges in step S705 that impersonation is not involved, and ends the processing. If the number of cities is two or more, the unauthorized communication determiner 204 identifies in step S703 whether a distance between the cities is large.

Specifically, the unauthorized communication determiner 204 calculates the distance by the spherical law of cosines using information regarding latitude and longitude included in the record and determines whether the distance is large in comparison with a threshold. If the distance is small, the unauthorized communication determiner 204 judges in step S705 that impersonation is not involved, and ends the processing. If the distance is large, the unauthorized communication determiner 204 judges in step S704 that impersonation is involved, and ends the processing.

In step S501, the unauthorized communication determiner 204 counts the number of anonymous communication services included in the read record. If the number of anonymous communication services is one or more, the unauthorized communication determiner 204 proceeds to step S507, and extracts an access history of the device ID.

In step S508, the unauthorized communication determiner 204 identifies whether the anonymous communication service included in the record read from the impersonation gray list frequently appears in the access history extracted in step S507, that is, whether the anonymous communication service is routinely used from the device ID.

If the anonymous communication service is not routinely used, the unauthorized communication determiner 204 judges in step S510 that impersonation is involved, and ends the processing. If the anonymous communication service is routinely used, the unauthorized communication determiner 204 proceeds to step S706, and identifies whether the read record includes non-anonymous communication. If the read record does not include non-anonymous communication, the unauthorized communication determiner 204 judges in step S705 that impersonation is not involved, and ends the processing.

If the read record includes non-anonymous communication, the unauthorized communication determiner 204 proceeds to step S701, and counts the number of countries of non-anonymous communication. If the number of countries of non-anonymous communication is two or more, the unauthorized communication determiner 204 judges in step S704 that impersonation is involved, and ends the processing.

If the number of countries of non-anonymous communication is one, the unauthorized communication determiner 204 proceeds to step S702, and counts the number of cities of non-anonymous communication.

If the number of cities of non-anonymous communication is one, the unauthorized communication determiner 204 judges in step S705 that impersonation is not involved, and ends the processing.

If the number of cities of non-anonymous communication is two or more, the unauthorized communication determiner 204 identifies in step S703 whether a distance between the cities is large or small. Specifically, the unauthorized communication determiner 204 calculates the distance by the spherical law of cosines using information regarding latitude and longitude included in the record and determines whether the distance is large in comparison with a threshold.

If the distance is small, the unauthorized communication determiner 204 judges in step S705 that impersonation is not involved, and ends the processing.

If the distance is large, the unauthorized communication determiner 204 judges in step S704 that impersonation is involved, and ends the processing.

Configuration and processing may also be similarly changed in other embodiments and modifications.

### Fourth Modification

Although coordinate information obtained by source home appliances using the GPS or the like, information indicating features of houses obtained using the ECHONET Lite (registered trademark) protocol, or information input and set by a user for home appliances is stored as the house identification information in the second embodiment, the house identification information is not limited to these.

For example, each home appliance may have a function of returning a device ID, obtain device IDs of nearby home appliances by broadcast or multicast, and transmit the device IDs to the home appliance server and the house identification list creator 210 of the unauthorized communication detection device 21 may identify home appliances belonging to the same network and store the home appliances in the house identification list. Alternatively, since IP addresses of home appliances belonging to the same house are an IP address of the router 50, home appliances having the same IP address in a case where no anonymous communication service is used may be determined as being located in the same house and stored in the house identification list. Alternatively, the home appliance server may ask a user to input information indicating home appliances used in the same house, obtain the information, and create a house identification list. A combination of these may be employed.

### Fifth Modification

Although when there is a plurality of communications from different source IP addresses, the unauthorized communication detection device 20 or 21 determines that it is possible that the device ID has been impersonated and queries the communication information provision server 32 for the source IP addresses via the communicator 201 to obtain communication information in the first and second embodiments, obtaining means is not limited to this.

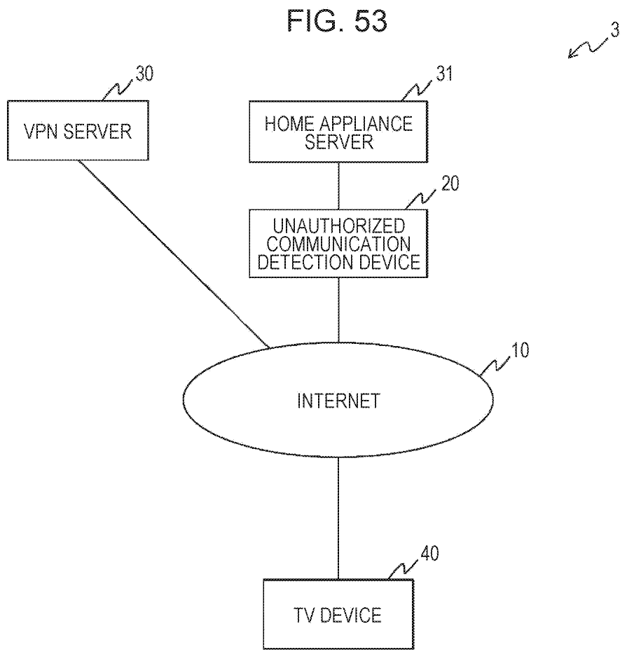

The unauthorized communication detection device may hold a communication information database in advance, or communication information may be obtained by another means. In this case, as illustrated in FIG. 53, configuration of an unauthorized communication detection system 3 is obtained by omitting the communication information provision server 32 from the configuration of the unauthorized communication detection system 1 (FIG. 2). Configuration and processing may also be similarly changed in other embodiments and modifications.

### Sixth Modification

Although the unauthorized communication detection device 20 or 21 is connected to the communication link (e.g., Ethernet) connecting the Internet 10 and the home appliance server 31 and is configured to relay the communication between home appliances on the Internet 10 and the home appliance server 31 and monitor unauthorized communication with the home appliance server 31 in the first and second embodiments described above, the unauthorized communication detection device 20 or 21 may be incorporated into the home appliance server 31, instead.

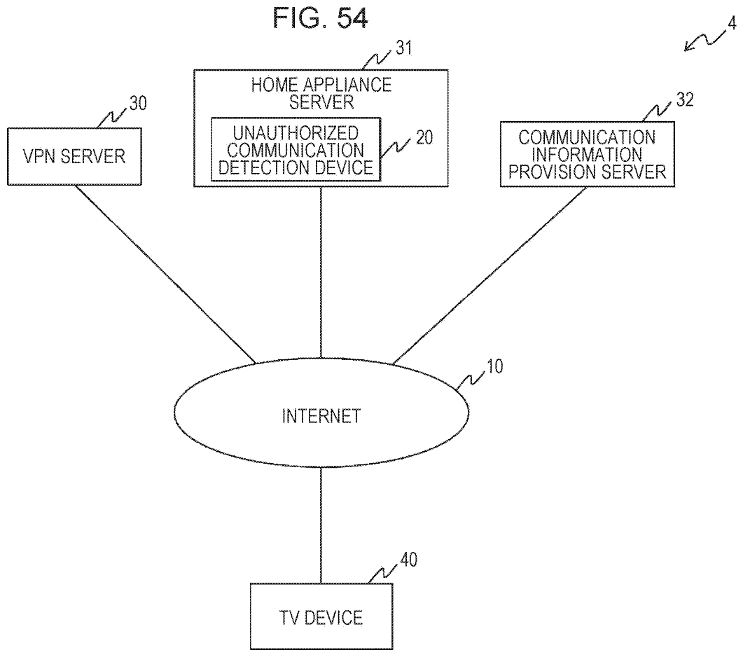

In this case, an unauthorized communication detection system 4 has a configuration illustrated in FIG. 54. Configuration and processing may also be similarly changed in other embodiments and modifications.

### Seventh Modification

Although the unauthorized communication detection device 20 or 21 is connected to the communication link (e.g., Ethernet) connecting the Internet 10 and the home appliance server 31 and is configured to relay the communication between home appliances on the Internet 10 and the home appliance server 31 and monitor unauthorized communication with the home appliance server 31 in the first and second embodiments described above, the unauthorized communication detection device 20 or 21 may be connected to the same network as the home appliance server 31, and monitor unauthorized communication by obtaining a communication log from the home appliance server 31, instead.

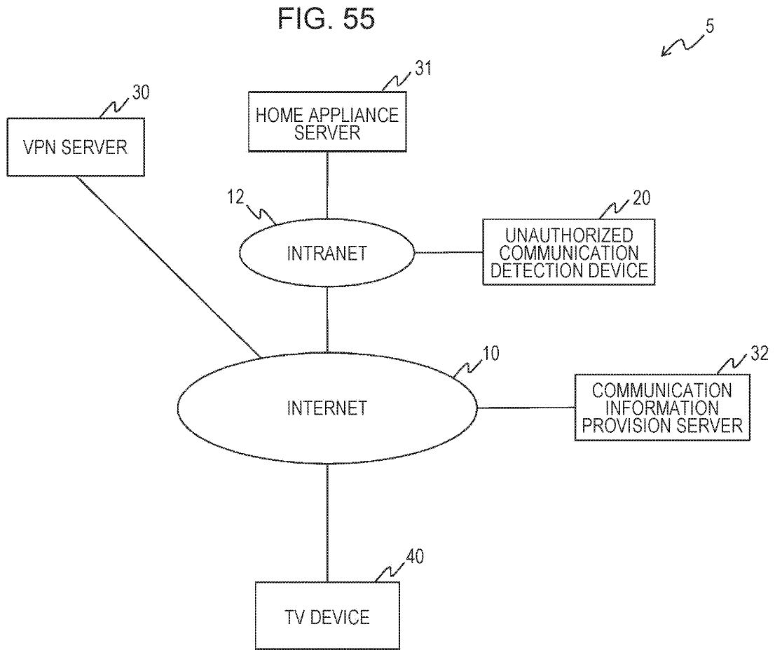

In this case, an unauthorized communication detection system 5 has a configuration illustrated in FIG. 55. Configuration and processing may also be similarly changed in other embodiments and modifications.

### Eighth Modification

Although the communication log collector 202 saves communication packets to the communication log holder 205 as a communication log in the first and second embodiments, the communication log is not limited to this.

A communication log saved by the home appliance server 31 thereto may be used, instead. Alternatively, a communication log saved by the home appliance server 31 to an external log saving server may be used. Alternatively, a communication log obtained by an external log server from the home appliance server at certain time intervals may be used. Another communication log may be used.

### Ninth Modification

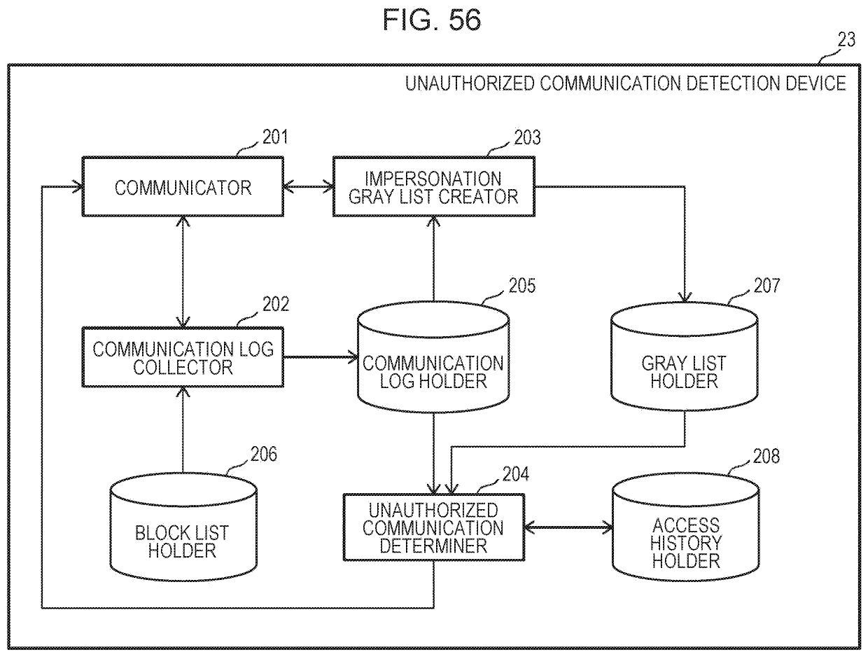

Although the unauthorized communication detection device 20 includes the device type list holder 209 in the first embodiment, an unauthorized communication detection device 23 need not include the device type list holder 209 as illustrated in FIG. 56, insofar as the first and second operations of the impersonation determination processing are performed.

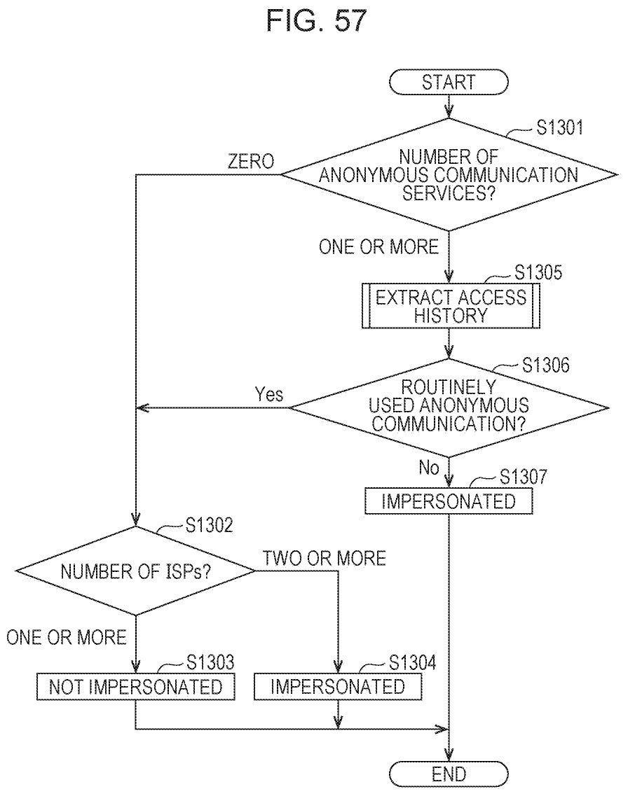

An example of the impersonation determination processing performed when the unauthorized communication detection device 23 does not include the device type list holder 209 will be described hereinafter with reference to FIG. 57.

In step S1301 of FIG. 57, the unauthorized communication detection device 23 counts the number of anonymous communication services included in a read record. Specifically, the unauthorized communication detection device 23 counts types of anonymous communication service names stored in the “anonymous communication service name” column of the record. At this time, the same anonymous communication service name is counted as one.

If the number of anonymous communication services is zero, the unauthorized communication detection device 23 proceeds to step S1302, and counts the number of ISPs of non-anonymous communication included in the read record. Specifically, the unauthorized communication detection device 23 counts types of ISP names stored in the “ISP name” column of the record. At this time, the same ISP name is counted as one.

If the number of ISPs is one or less, the unauthorized communication detection device 23 proceeds to step S1303. The unauthorized communication detection device 23 judges that impersonation is not involved, and ends the processing. If the number of ISPs is two or more, the unauthorized communication detection device 23 proceeds to step S1304. The unauthorized communication detection device 23 judges that impersonation is involved, and ends the processing.

Even if the number of ISPs is two or more, in the case of source IP addresses whose ISPs are MVNOs, the communication information provision server 32 returns ISP names of MNOs depending on the timing of a query. Even if the number of ISPs is two or more, therefore, a more detailed judgment may be made by, for example, judging that impersonation is not involved in the case of a combination of an MNO and an MVNO.

If the number of anonymous communication services is one or more in step S1301, the unauthorized communication detection device 23 proceeds to step S1305. The unauthorized communication detection device 23 extracts an access history of the device ID and saves the access history to the access history holder 208.

In step S1306, the unauthorized communication detection device 23 identifies whether an anonymous communication service included in the record read from the impersonation gray list frequently appears in the access history extracted in step S507, that is whether the anonymous communication service is routinely used from the device ID.

For example, if access intervals are short, such as once in several days, and access has been made over a relatively long period of time such as at least several weeks, the unauthorized communication detection device 23 determines that the anonymous communication service is routinely used, and proceeds to step S1302. If the anonymous communication service is not routinely used, the unauthorized communication detection device 23 proceeds to step S1307. The unauthorized communication detection device 23 judges that impersonation is involved, and ends the processing.

Configuration and processing may also be changed in other embodiments and modifications.

### 4. Example of Notification

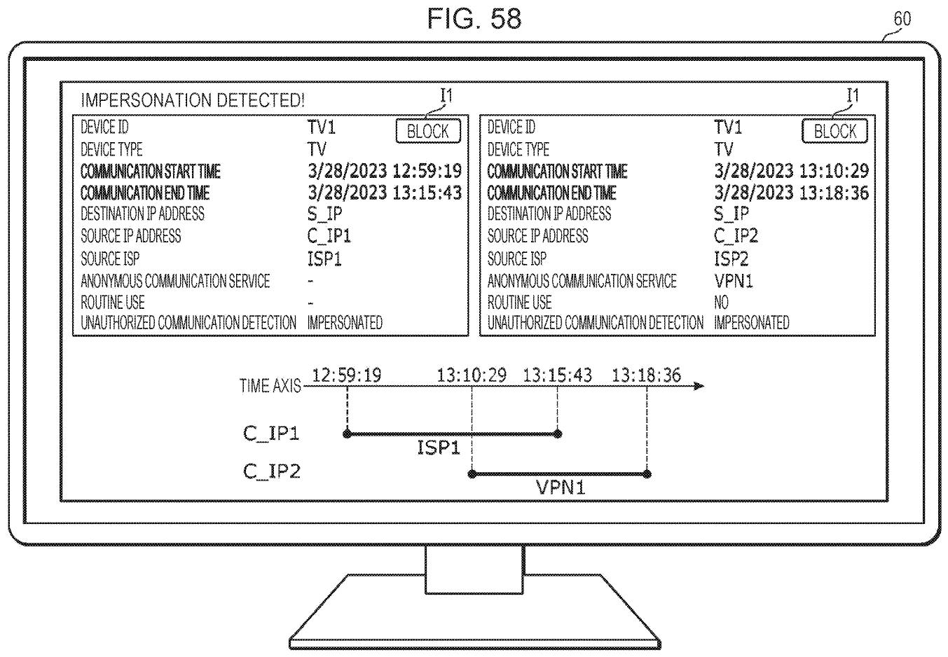

As described in the second modification, the unauthorized communication detection device 20, 21, 22, or 23 may simply notify the home appliance server 31 or an SOC or the like that is remotely monitoring the home appliance server 31 of a risk. An example in which the unauthorized communication detection device 20, 21, 22, or 23 notifies an operator at the SOC of a risk will be described hereinafter with reference to FIGS. 58, 59, and 60.

FIG. 58 illustrates an example of notification at a time when it has been determined as a result of the communication overlap determination processing that two or more communications temporally overlap and impersonation has been detected. As illustrated in FIG. 58, when impersonation is detected, for example, detection results (risks) are displayed on a display 60 used by the operator at the SOC. In the example illustrated in FIG. 58, the operator is notified that a communication corresponding to C_IP1/S_IP (hereinafter referred to as a “first communication”) involves impersonation and a communication corresponding to C_IP2/S_IP (hereinafter referred to as a “second communication”) also involves impersonation.

The operator can add C_IP1/S_IP of the first communication to the block list by, for example, selecting an icon I1 in an area where the detection result of the first communication is displayed. Similarly, the operator can add C_IP2/S_IP of the second communication to the block list by, for example, selecting an icon I1 in an area where the detection result of the second communication is displayed.

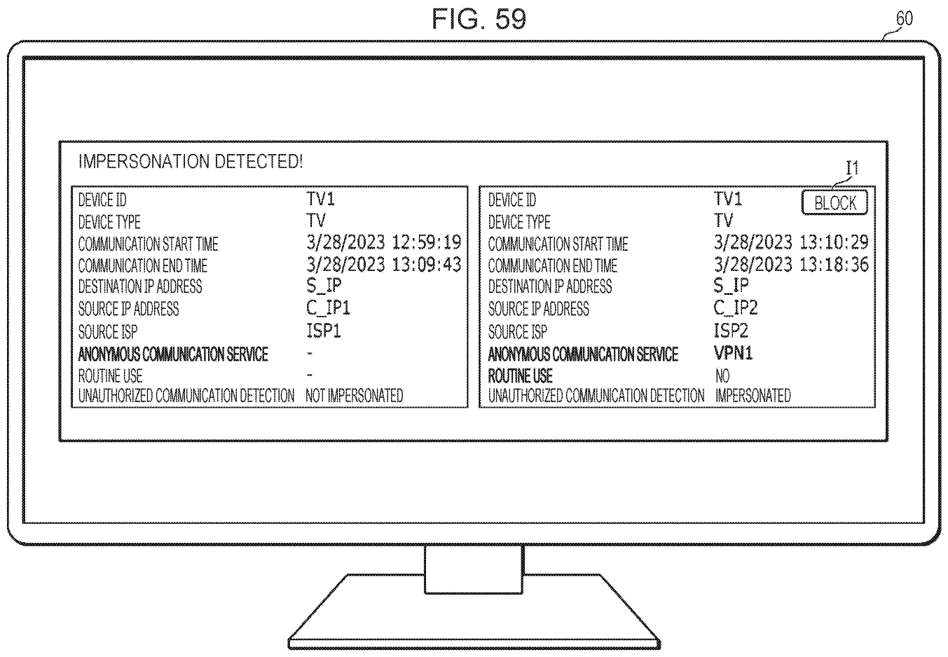

FIG. 59 illustrates an example of notification at a time when it has been determined as a result of the communication overlap determination processing that two or more communications do not temporally overlap but impersonation has been detected as a result of the impersonation determination processing. As illustrated in FIG. 59, when impersonation is detected, for example, detection results (risks) are displayed on the display 60 used by the operator at the SOC. In the example illustrated in FIG. 59, the operator is notified that a communication corresponding to C_IP1/S_IP (hereinafter referred to as a “third communication”) does not involve impersonation and a communication corresponding to C_IP2/S_IP (hereinafter referred to as a “fourth communication”) involves impersonation.

The operator can add C_IP2/S_IP of the fourth communication to the block list by, for example, selecting an icon I1 in an area where the detection result of the fourth communication is displayed.

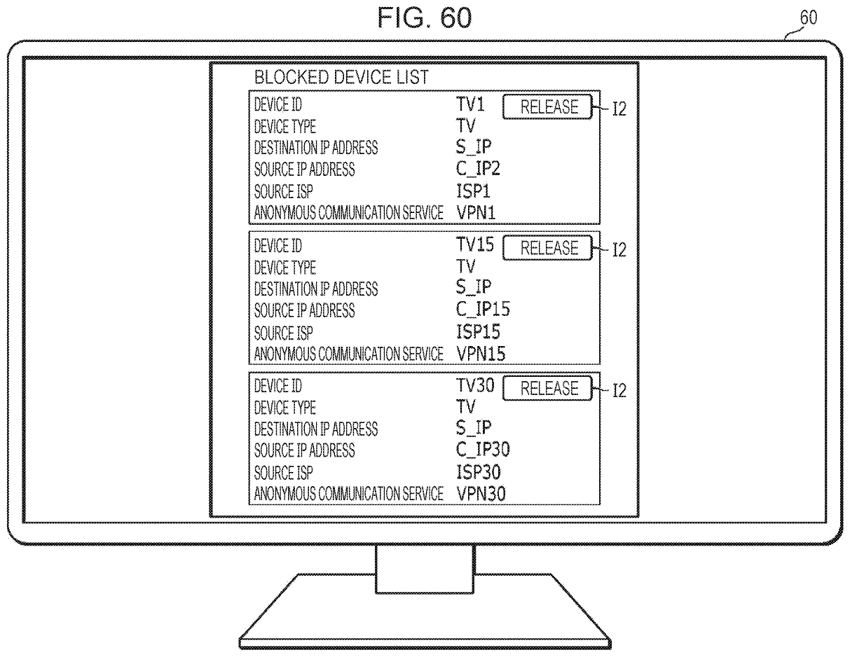

FIG. 60 illustrates an example in which the block list is displayed on the display 60 used by the operator of the SOC. In the example illustrated in FIG. 60, the block list includes a communication corresponding to C_IP2/S_IP (hereinafter referred to as a “fifth communication”), a communication corresponding to C_IP15/S_IP (hereinafter referred to as a “sixth communication”), and a communication corresponding to C_IP30/S_IP (hereinafter referred to as a “seventh communication”).

By selecting an icon I2 in a display area of the fifth communication, the sixth communication, or the seventh communication, the operator can exclude the selected communication from the block list, that is, release blocking of unauthorized communication.

### 5. Conclusion

As described above, an unauthorized communication detection method according to a first aspect is an unauthorized communication detection method performed by one or more processors. The unauthorized communication detection method includes detecting, in communication between the Internet and a server, two or more communications with a same device identifier from two or more different source Internet protocol addresses in a predetermined period of time, the device identifier uniquely identifying a device, determining presence or absence of one or more temporal overlaps between the two or more communications, and judging, if determining that there are one or more temporal overlaps, that at least one of the two or more communications is an unauthorized communication.

An unauthorized communication detection method according to a second aspect is the unauthorized communication detection method according to the first aspect, further including identifying, if determining that there is no temporal overlap, whether a communication type of each of the two or more communications is anonymous communication or non-anonymous communication from the two or more different source Internet protocol addresses, and judging, in accordance with a number and a combination of anonymous communications and non-anonymous communications, whether at least one of the two or more communications is an unauthorized communication.

An unauthorized communication detection method according to a third aspect is the unauthorized communication detection method according to the second aspect, further including judging, in accordance with a communication history of the device identifier, whether the anonymous communication among the two or more communications is an unauthorized communication. For example, in the unauthorized communication detection method, the communication history of the device identifier is checked. Processing for determining whether a communication determined as an anonymous communication is routinely used as communication of the device identifier is performed. If it is determined that the communication is routinely used, it is judged that the communication determined as an anonymous communication is not unauthorized communication.

An unauthorized communication detection method according to a fourth aspect is the unauthorized communication detection method according to the second or third aspect, further including identifying, if all of the two or more communications are non-anonymous communications, source countries and cities from the source Internet protocol addresses of the two or more communications, and judging, in accordance with presence or absence of a difference between the countries and a distance between the cities, whether at least one of the two or more communications is an unauthorized communication.

The unauthorized communication detection method according to the fourth aspect further includes obtaining, if the source cities of the two or more communications are different from each other, a differential time between a communication end time of the earlier communication and a communication start time of the later communication, and determining whether the two or more communications have occurred within a time in which the distance between the cities can be covered. The unauthorized communication detection method further includes judging, if determining that the two or more communications have occurred within the time in which the distance between the cities cannot be covered, that the two or more communications determined to have occurred within the time in which the distance between the cities cannot be covered are unauthorized communications.

The unauthorized communication detection method further includes determining, if determining that the two or more communications have occurred within the time in which the distance between the cities can be covered, whether the device identifier indicates a transportable home appliance type. The unauthorized communication detection method further includes judging, if determining that the device identifier does not indicate a transportable home appliance type, that the two or more communications determined to have occurred within the time in which the distance between the cities can be covered are unauthorized communications.

An unauthorized communication detection method according to a fifth aspect is the unauthorized communication detection method according to the fourth aspect, further including identifying, if all of the two or more communications are non-anonymous communications and a number of Internet service providers is one, source countries and cities from the source Internet protocol addresses of the two or more communications, and judging, in accordance with presence or absence of a difference between the countries and a distance between the cities, whether at least one of the two or more communications is an unauthorized communication.

An unauthorized communication detection method according to a sixth aspect is the unauthorized communication detection method according to any of the second to fifth aspects, further including determining, if the two or more communications include an anonymous communication, whether the device identifier indicates a home appliance type that can use anonymous communication, and judging, if determining that the device identifier does not indicate a home appliance type that can use anonymous communication, that the anonymous communication is an unauthorized communication.

An unauthorized communication detection method according to a seventh aspect is the unauthorized communication detection method according to the sixth aspect, further including identifying, if determining that the device identifier indicates a home appliance type that can use anonymous communication, a state of the device identifier and determining whether the state allows anonymous communication, and judging, if determining that the state of the device identifier does not allow anonymous communication, that the anonymous communication is an unauthorized communication.

An unauthorized communication detection method according to an eighth aspect is the unauthorized communication detection method according to any of the first to seventh aspects, further including blocking, if judging that at least one of the two or more communications is an unauthorized communication, the two or more communications.

An unauthorized communication detection method according to a ninth aspect is the unauthorized communication detection method according to the eighth aspect, in which the blocking includes adding a combination of the source Internet protocol address and a destination Internet protocol address of the unauthorized communication to a block list.

An unauthorized communication detection method according to a tenth aspect is the unauthorized communication detection method according to the eighth aspect, further including checking whether a predetermined period of time has elapsed since the blocking of the two or more communications, and if the predetermined period of time has elapsed, releasing the blocking of the two or more communications.

An unauthorized communication detection method according to an eleventh aspect is the unauthorized communication detection method according to any of the first to tenth aspects, further including notifying, if judging that at least one of the two or more communications is an unauthorized communication, the server or another device that it has been judged that at least one of the two or more communications is an unauthorized communication.

An unauthorized communication detection method according to a twelfth aspect is the unauthorized communication detection method according to the second aspect, further including evaluating, if judging that at least one of the two or more communications is an unauthorized communication, a degree of danger in accordance with a condition of the unauthorized communication, and determining a value of a score indicating the degree of danger.

The unauthorized communication detection method according to the twelfth aspect further includes checking a communication history of the device identifier and determining whether communication determined as anonymous communication is routinely used as communication with the device identifier. The unauthorized communication detection method further includes judging, if determining that the communication is not routinely used, judging that the communication determined as anonymous communication has a high risk of being an unauthorized communication, and setting a large value to the score.

The unauthorized communication detection method according to the twelfth aspect further includes identifying, if all of the two or more communications are non-anonymous communications and the number of Internet service providers is one, source countries and cities from the source Internet protocol addresses of the two or more communications. The unauthorized communication detection method further includes judging, in accordance with presence or absence of a difference between the counties and a distance between the cities, whether at least one of the two or more communications is an unauthorized communication, and determining the value of the score.

The unauthorized communication detection method according to the twelfth aspect further includes obtaining, if the source cities of the two or more communications are different from each other, a differential time between a communication end time of the earlier communication and a communication start time of the later communication, and determining whether the two or more communications have occurred within a time in which the distance between the cities can be covered. The unauthorized communication detection method further includes judging, if determining that the two or more communications have occurred within the time in which the distance between the cities cannot be covered, that the two or more communications determined to have occurred within the time in which the distance between the cities cannot be covered has a high risk of including an unauthorized communication, and setting a large value to the score.

The unauthorized communication detection method further includes determining, if determining that the two or more communications have occurred within the time in which the distance between the cities can be covered, whether the device identifier indicates a transportable home appliance type. The unauthorized communication detection method further includes judging, if determining that the device identifier does not indicate a transportable home appliance type, that the two or more communications determined to have occurred within the time in which the distance between the cities can be covered has a high risk of including an unauthorized communication and setting a large value to the score.

The unauthorized communication detection method according to the twelfth aspect further includes determining, if the two or more communications include one or more anonymous communications, whether the device identifier indicates a home appliance type that can use anonymous communication. The unauthorized communication detection method further includes judging, if determining that the device identifier does not indicate a home appliance type that can use anonymous communication, that there is a high risk that at least one of the two or more communications is an unauthorized communication, and setting a large value to the score.

The unauthorized communication detection method according to the twelfth aspect further includes identifying, if determining that the device identifier indicates a home appliance type that can use anonymous communication, a state of the device identifier and determining whether the state allows anonymous communication. The unauthorized communication detection method further include judging, if determining that the device identifier does not indicate a state that allows anonymous communication, that there is a high risk that at least one of the two or more communications is an unauthorized communication, and setting a large value to the score.

An unauthorized communication detection method according to a thirteenth aspect is the unauthorized communication detection method according to the twelfth aspect, further including blocking, if the value of the score exceeds a threshold, the two or more communications.

An unauthorized communication detection method according to a fourteenth aspect is the unauthorized communication detection method according to the thirteenth aspect, further including checking whether a predetermined period of time has elapsed since the blocking of the two or more communications, and if the predetermined period of time has elapsed, releasing the blocking of the two or more communications.

An unauthorized communication detection method according to a fifteenth aspect is the unauthorized communication detection method according to any of the twelfth to fourteenth aspects, further including notifying, if the score exceeds a threshold, the server or another device that it has been judged that at least one of the two or more communications is an unauthorized communication.

An unauthorized communication detection method according to a sixteenth aspect is the unauthorized communication detection method according to the first aspect, further including obtaining, if determining that there is no temporal overlap, a first communication type indicating whether a communication type is anonymous communication or non-anonymous communication from the source Internet protocol address of each of the two or more communications, obtaining a second communication type indicating whether a communication type is anonymous communication or non-anonymous communication from a source Internet protocol address of another device having same house identification information as house identification information included in the two or more communications, and judging, if the first communication type and the second communication type do not match, that at least one of the two or more communications is an unauthorized communication.

An unauthorized communication detection method according to a seventeenth aspect is the unauthorized communication detection method according to the sixteenth aspect, in which the house identification information is any of information input to a home appliance by a user, physical position information obtained by the device, and information indicating a feature of a house obtained by the device from the other device using an ECHONET Lite (registered trademark) protocol.

An unauthorized communication detection method according to an eighteenth aspect is the unauthorized communication detection method according to the sixteenth or seventeenth aspect, further including blocking, if judging that at least one of the two or more communications is an unauthorized communication, the two or more communications.

An unauthorized communication detection method according to a nineteenth aspect is the unauthorized communication detection method according to the eighteenth aspect, further including checking whether a predetermined period of time has elapsed since the blocking of the two or more communications, and if the predetermined period of time has elapsed, releasing the blocking of the two or more communications.

An unauthorized communication detection method according to a twentieth aspect is the unauthorized communication detection method according to any of the sixteenth to nineteenth aspects, further including notifying, if judging that at least one of the two or more communications is an unauthorized communication, the server or another device that it has been judged that at least one of the two or more communications is an unauthorized communication.

An unauthorized communication detection method according to a twenty-first aspect is the unauthorized communication detection method according to any of the sixteenth to twentieth aspects, further including evaluating, if judging that at least one of the two or more communications is an unauthorized communication, a degree of danger in accordance with a condition of the unauthorized communication, and determining a value of a score indicating the degree of danger.

A program according to a twenty-second aspect causes one or more processors to execute the unauthorized communication detection method according to any of the first to twenty-first aspects.

An unauthorized communication detection device according to a twenty-third aspect includes one or more processors and a memory. The one or more processors perform a process including detecting, in communication between the Internet and a server, two or more communications with a same device identifier from two or more different source Internet protocol addresses in a predetermined period of time, the device identifier uniquely identifying a device, determining presence or absence of one or more temporal overlaps between the two or more communications, and judging, if determining that there are one or more temporal overlaps, that at least one of the two or more communications is an unauthorized communication.

The present disclosure can be used for a service and a system including a server on the Internet and devices connected to the server.

What is claimed is:

1. An unauthorized communication detection method performed by one or more processors, the unauthorized communication detection method comprising:
detecting, in communication between the Internet and a server, two or more communications with a same device identifier from two or more different source Internet protocol addresses in a predetermined period of time, the device identifier uniquely identifying a device;
determining presence or absence of one or more temporal overlaps between the two or more communications; and
judging, if determining that there are one or more temporal overlaps, that at least one of the two or more communications is an unauthorized communication.

2. The unauthorized communication detection method according to claim 1, further comprising:
identifying, if determining that there is no temporal overlap, whether a communication type of each of the two or more communications is anonymous communication or non-anonymous communication from the two or more different source Internet protocol addresses; and
judging, in accordance with a number and a combination of anonymous communications and non-anonymous communications, whether at least one of the two or more communications is an unauthorized communication.

3. The unauthorized communication detection method according to claim 2, further comprising:
judging, in accordance with a communication history of the device identifier, whether the anonymous communication among the two or more communications is an unauthorized communication.

4. The unauthorized communication detection method according to claim 2, further comprising:
identifying, if all of the two or more communications are non-anonymous communications, source countries and cities from the source Internet protocol addresses of the two or more communications; and
judging, in accordance with presence or absence of a difference between the countries and a distance between the cities, whether at least one of the two or more communications is an unauthorized communication.

5. The unauthorized communication detection method according to claim 2, further comprising:
identifying, if all of the two or more communications are non-anonymous communications and a number of Internet service providers is one, source countries and cities from the source Internet protocol addresses of the two or more communications; and
judging, in accordance with presence or absence of a difference between the countries and a distance between the cities, whether at least one of the two or more communications is an unauthorized communication.

6. The unauthorized communication detection method according to claim 2, further comprising:
determining, if the two or more communications include an anonymous communication, whether the device identifier indicates a home appliance type that can use anonymous communication; and
judging, if determining that the device identifier does not indicate a home appliance type that can use anonymous communication, that the anonymous communication is an unauthorized communication.

7. The unauthorized communication detection method according to claim 6, further comprising:
identifying, if determining that the device identifier indicates a home appliance type that can use anonymous communication, a state of the device identifier and determining whether the state allows anonymous communication; and
judging, if determining that the state of the device identifier does not allow anonymous communication, that the anonymous communication is an unauthorized communication.

8. The unauthorized communication detection method according to claim 1, further comprising:
blocking, if judging that at least one of the two or more communications is an unauthorized communication, the two or more communications.

9. The unauthorized communication detection method according to claim 8,
wherein the blocking includes adding a combination of the source Internet protocol address and a destination Internet protocol address of the unauthorized communication to a block list.

10. The unauthorized communication detection method according to claim 8, further comprising:
checking whether a predetermined period of time has elapsed since the blocking of the two or more communications, and if the predetermined period of time has elapsed, releasing the blocking of the two or more communications.

11. The unauthorized communication detection method according to claim 1, further comprising:
notifying, if judging that at least one of the two or more communications is an unauthorized communication, the server or another device that it has been judged that at least one of the two or more communications is an unauthorized communication.

12. The unauthorized communication detection method according to claim 2, further comprising:
evaluating, if judging that at least one of the two or more communications is an unauthorized communication, a degree of danger in accordance with a condition of the unauthorized communication; and
determining a value of a score indicating the degree of danger.

13. The unauthorized communication detection method according to claim 12, further comprising:
blocking, if the value of the score exceeds a threshold, the two or more communications.

14. The unauthorized communication detection method according to claim 13, further comprising:
checking whether a predetermined period of time has elapsed since the blocking of the two or more communications, and if the predetermined period of time has elapsed, releasing the blocking of the two or more communications.

15. The unauthorized communication detection method according to claim 12, further comprising:
notifying, if the score exceeds a threshold, the server or another device that it has been judged that at least one of the two or more communications is an unauthorized communication.

16. The unauthorized communication detection method according to claim 1, further comprising:
obtaining, if determining that there is no temporal overlap, a first communication type indicating whether a communication type is anonymous communication or non-anonymous communication from the source Internet protocol address of each of the two or more communications;
obtaining a second communication type indicating whether a communication type is anonymous communication or non-anonymous communication from a source Internet protocol address of another device having same house identification information as house identification information included in the two or more communications; and
judging, if the first communication type and the second communication type do not match, that at least one of the two or more communications is an unauthorized communication.

17. The unauthorized communication detection method according to claim 16,
wherein the house identification information is any of information input to a home appliance by a user, physical position information obtained by the device, and information indicating a feature of a house obtained by the device from the other device using an ECHONET Lite (registered trademark) protocol.

18. The unauthorized communication detection method according to claim 16, further comprising:
blocking, if judging that at least one of the two or more communications is an unauthorized communication, the two or more communications.

19. The unauthorized communication detection method according to claim 18, further comprising:
checking whether a predetermined period of time has elapsed since the blocking of the two or more communications, and if the predetermined period of time has elapsed, releasing the blocking of the two or more communications.

20. The unauthorized communication detection method according to claim 16, further comprising:
notifying, if judging that at least one of the two or more communications is an unauthorized communication, the server or another device that it has been judged that at least one of the two or more communications is an unauthorized communication.

21. The unauthorized communication detection method according to claim 16, further comprising:
evaluating, if judging that at least one of the two or more communications is an unauthorized communication, a degree of danger in accordance with a condition of the unauthorized communication; and
determining a value of a score indicating the degree of danger.

22. A non-transitory computer-readable recording medium storing a program causing one or more processors to execute the unauthorized communication detection method according to claim 1.

23. An unauthorized communication detection device comprising:
one or more processors; and
a memory,
wherein the one or more processors perform a process including:
detecting, in communication between the Internet and a server, two or more communications with a same device identifier from two or more different source Internet protocol addresses in a predetermined period of time, the device identifier uniquely identifying a device;
determining presence or absence of one or more temporal overlaps between the two or more communications; and
judging, if determining that there are one or more temporal overlaps, that at least one of the two or more communications is an unauthorized communication.
